(19) United States
(12) Patent Application Publication
(10) Pub. No.: US 2021/0006334 A1
(43) Pub. Date: Jan. 7, 2021

(54) COMMUNICATION DEVICE, COMMUNICATION METHOD AND COMMUNICATION PROGRAM

(71) Applicant: NIPPON TELEGRAPH AND TELEPHONE CORPORATION

(72) Inventor: Manabu YOSHINO, Musashino-shi, Tokyo (JP)

(73) Assignee: NIPPON TELEGRAPH AND TELEPHONE CORPORATION, Tokyo (JP)

(21) Appl. No.: 16/976,501

(22) PCT Filed: Feb. 21, 2019
(86) PCT No.: PCT/JP2019/006656

§ 371 Date: Aug. 28, 2020

(30) Foreign Application Priority Data
Mar. 2, 2018 (JP) 2018-038089

(51) Int. Cl. H04B 10/27; H04Q 11/00

(52) U.S. Cl. CPC H04B 10/27; H04Q 11/0005

(57) ABSTRACT

A communication apparatus includes: an execution unit configured to execute at least either switching of a path of a signal or transmission of the signal on the path; and an instruction unit, wherein the instruction unit includes a first interface configured to send a command to the execution unit, and the execution unit includes a second interface configured to receive the command, and executes at least one of the switching of the path, start of the transmission of the signal, or suspension of the transmission of the signal according to the command either immediately, or after a configured time period or a predetermined time period elapses.

### TECHNICAL FIELD

The present invention relates to a communication apparatus, a communication method, and a communication program.

### BACKGROUND ART

A passive optical network (PON) system is one example of a communication system including a communication apparatus. The PON system includes optical network units (ONUs) each installed in a subscriber's premise or the like, optical line terminals (OLTs) each being a communication apparatus installed in an office, and an optical distribution network (ODN). The ODN may connect a plurality of ONUs and a plurality of OLTs.

As for the communication apparatus, functional versatility, portability, and extensibility are enhanced by componentizing a function having low dependency on at least one of a conformance standard, a generation, a scheme, a system, a device type, and a manufacturing vendor of an apparatus and clarifying at least a part of input and output interfaces (IFs) such as an Application Programming Interface (API) of the function. This facilitates use of a common function and addition of a proprietary function between devices when at least one of the conformance standard, the generation, the scheme, the system, the device type, and the manufacturing vendor is different between the devices (for example, see NPL 1).

### CITATION LIST

### Non Patent Literature

NPL 1: “Welcome to Homepage of FASA”, [online], NTT Access Service Laboratories, [searched on Feb. 8, 2017], the Internet <URL: http://www.ansl.ntt.co.jp/j/FASA/index.html>

### SUMMARY OF THE INVENTION

### Technical Problem

When functions having low dependency on at least one of an apparatus conformance standard, a generation, a scheme, a system, a device type, and a manufacturer/vendor are componentized, the components are not necessarily located in one housing, and the components may be distributed and located in a plurality of housings. One component in a housing of an apparatus may be used as a component constituting another apparatus.

In such a componentized configuration, flexibility and prompt replacement, addition, and deletion of functions and components are desirable. From such a point of view, accommodation switch to, for example, a channel termination (CT) or the like, an optical subscriber unit (OSU) as a group of CTs or the like, an OLT, a switch (SW) inside or outside an OLT, or the like that terminates a wavelength, a core wire, a core, a mode, a code, a frequency, a (sub-)carrier, or the like, or a combination of those, which occurs due to replacement, addition, and deletion of a function or a component including hardware, software, a combination of thereof, or the like and accommodation switch of signals to a wavelength, a core wire, a core, a mode, a code, a frequency, a (sub-)carrier, or the like, or a combination of those being a path of signals is desired.

However, a requirement of a time length or the like required for replacement, addition, and deletion or switching/configuration for implementing such procedures, depends on a service level agreement (SLA). In addition, capability of a time length or the like required for replacement, addition, and deletion or switching/configuration for implementing such procedures depends on each individual component. There is no means to execute switching that handles such a variety of time lengths, or the like required for replacement, addition, and deletion or switching/configuration for implementing such procedures. In particular, when a component not supposed to satisfy a predetermined standard such as redundant switching is used, switching procedure prescribed in the standard may be inadequate to implement switching, and information of a user or information for management may not be thus transmitted to a predetermined destination. For example, regarding a pair of opposing apparatuses or components across a link or a pair of apparatuses or components in an active system and a reserve system, if one apparatus or component of the pair requires 30 milliseconds and the other requires 50 milliseconds, the following may occur. When one apparatus or component commands the other apparatus or component so that each apparatus or component carries out switching, both the apparatuses and components cannot synchronize switching. In addition, when the pair of apparatuses and components responds to each other to make a confirmation, one apparatus or component may retransmit a command or the switching procedure may end abnormally, because the other apparatus or component fails to receive a response that is supposed to be received within a time period that the other apparatus or component expects. This may lead to a situation in which a larger amount of information of a user or information for management than expected is lost, or switching fails to be implemented normally.

Under such circumstances as described above, the present invention has an object to provide a communication apparatus that can be configured with components each has different processing time periods, a communication method, and a communication program.

### Means for Solving the Problem

One aspect of the present invention is a communication apparatus including an execution unit configured to execute either switching of a path of a signal or transmission of the signal on the path; and an instruction unit, wherein the instruction unit includes a first interface configured to send a command to the execution unit, and the execution unit includes a second interface configured to receive the command, and executes the switching of the path, start of the transmission of the signal, or suspension of the transmission of the signal according to the command either immediately, or after a configured time period or a predetermined time period elapses.

One aspect of the present invention is the communication apparatus, wherein the execution unit sends to the instruction unit a response to the command when the execution unit receives the command or performs execution according to the command, and the instruction unit sends to the execution unit a next instance of the command after receiving the response to the command.

One aspect of the present invention is the communication apparatus, wherein the instruction unit sends time information as the command to the execution unit, and when the execution unit receives the time information, the execution unit executes the switching of the path, the start of the transmission of the signal, or the suspension of the transmission of the signal after a configured time period or a predetermined time period elapses.

One aspect of the present invention is the communication apparatus, wherein the instruction unit sends the command to the execution unit if the signal has not been transmitted for a predetermined period in a downstream part of the path.

One aspect of the present invention is the communication apparatus, wherein the instruction unit sends a command for the suspension of the transmission to the execution unit after a configured time period or a predetermined time period elapses from a suspension time being a time at which the transmission is suspended, and sends a command for the start of the transmission to the execution unit after a configured time period or a predetermined time period elapses from a start time being a time at which the transmission is started, the execution unit executes the switching of the path when the execution unit receives the command for the switching, and the execution unit suspends the transmission of the signal when the execution unit receives the command for the suspension, and starts the transmission of the signal when the execution unit receives the command for the start.

One aspect of the present invention is the communication apparatus, further including a substitute apparatus configured to perform an operation of the instruction unit instead of the instruction unit.

One aspect of the present invention is a communication method executed by a communication apparatus including an execution unit configured to execute either switching of a path of a signal or transmission of the signal on the path and an instruction unit, the communication method including: sending, by the instruction unit, a command to the execution unit; and receiving, by the execution unit, the command, and executing the switching of the path, start of the transmission of the signal, or suspension of the transmission of the signal according to the command either immediately, or after a configured time period or a predetermined time period elapses.

One aspect of the present invention is a communication program for causing a computer to operate as the communication apparatus.

### Effects of the Invention

According to the present invention, an apparatus can be configured with components that each has different processing time periods.

### BRIEF DESCRIPTION OF DRAWINGS

FIG. 1 is a diagram illustrating a configuration example of a communication apparatus.

FIG. 2 is a diagram illustrating control that handles a variety of time lengths or the like required for replacement, addition, and deletion or switching/configuration for implementing such procedures (switching command and response confirmation by a controller).

FIG. 3 is a diagram illustrating control that handles a variety of time lengths or the like required for replacement, addition, and deletion or switching/configuration for implementing such procedures (switching command and response confirmation by a substitute apparatus).

FIG. 4 is a diagram illustrating control that handles a variety of time lengths or the like required for replacement, addition, and deletion or switching/configuration for implementing such procedures (switching command based on time specification).

FIG. 5 is a diagram illustrating control that handles a variety of time lengths or the like required for replacement, addition, and deletion or switching/configuration for implementing such procedures (switching command based on time specification of a substitute apparatus).

FIG. 6 is a diagram illustrating control that handles a variety of time lengths or the like required for replacement, addition, and deletion or switching/configuration for implementing such procedures (switching command and response confirmation by a controller).

FIG. 7 is a diagram illustrating control that handles a variety of time lengths or the like required for replacement, addition, and deletion or switching/configuration for implementing such procedures (switching command and response confirmation by a substitute apparatus).

FIG. 8 is a diagram illustrating control that handles a variety of time lengths or the like required for replacement, addition, and deletion or switching/configuration for implementing such procedures (switching command based on time specification).

FIG. 9 is a diagram illustrating control that handles a variety of time lengths or the like required for replacement, addition, and deletion or switching/configuration for implementing such procedures (switching command based on time specification of a substitute apparatus).

FIG. 10 is a graph showing a relationship between response latency (time accuracy) and buffering time.

FIG. 11 is a table showing comparison of controls.

FIG. 12 is a diagram illustrating the first example of architecture of the communication apparatus.

FIG. 13 is a diagram illustrating the third example of architecture of the communication apparatus.

FIG. 14 is a diagram illustrating the fifth example of architecture of the communication apparatus.

FIG. 15 is a diagram illustrating a configuration example of a communication system.

FIG. 16 is a diagram illustrating an example of a configuration of an optical access system.

FIG. 17 is a table showing major functions of an access system and examples of targets to be converted into FASA applications.

FIG. 18 is a table showing major functions of an access system and examples of targets to be converted into FASA applications.

FIG. 19 is a diagram illustrating a flow of signaling/information between function units corresponding to functions in the communication apparatus.

FIG. 20 is a diagram illustrating a flow of signaling/information between function units in the communication apparatus.

### DESCRIPTION OF EMBODIMENTS

Embodiments of the present invention will be described in detail with reference to the drawings.

### Embodiment 1

A communication apparatus is, for example, a communication apparatus that executes communication with another communication apparatus by using signals such as optical signals transmitted via a communication network such as an optical fiber network such as an ODN such as a PON. The communication apparatus is, for example, an OLT. The communication apparatus is, for example, an OSU. The communication apparatus may be, for example, a combination of an OLT, which does or does not include an SW for switching optical signals, and another SW. The communication apparatus may, for example, combine components such as a general-purpose Pizza-Box or SFP OLT and a white box switch (WBS), and centrally control those components using a remote controller. The communication apparatus may be, for example, a combination of an OLT and an ONU. The communication apparatus may include a plurality of devices. Alternatively, the communication apparatus may be another communication apparatus such as an ONU, a multiplexer (MUX), a demultiplexer (DMUX), and an SW.

The communication apparatus includes, for example, componentized functions or components. Each function or component is, for example, a hardware component, and is for example, a CT, an OSU, OLT, a switch unit (SW), an optical switch unit (optical SW), a buffer for preventing loss of frames or the like at the time of switching or the like, a delay circuit for preventing processing such as back pressure and arrival of frames, or a switching function therefor. For example, each function or component may be a software component associated with those components or related to functions included in the components, may be middleware or software such as basic functions, may be a plurality of hardware components, may be a plurality of software components, or may be a combination of a hardware component and a software component.

The communication apparatus may include a plurality of constituent elements. Those constituent elements may be provided in a single apparatus, or may be provided in separate apparatuses.

The communication apparatus may be one virtual apparatus including a plurality of apparatuses. The virtual apparatus may include an operation system (OpS), an operation support system (OSS), a network element (NE)-OpS that controls an NE, an NE controller, an element management system (EMS), such as the NE-OpS, that is a configuration management system of an OLT, and the like (the OpS, the OSS, the NE-OpS, the NE controller, and the EMS may be hereinafter referred to as an “OpS or the like”, or one of those may be used to represent all of them).

Next, examples of operation and the like will be illustrated on the assumption that the communication apparatus is an OLT of a PON conforming to ITU-T recommendations, such as a time and wavelength division multiplexing (TWDM)-PON system such as a Next Generation-PON2 (NG-PON2), in one example. Although the TWDM-PON is taken as an example above, the PON may be a 10 Gigabit capable (XG)-PON, a Gigabit capable (G)-PON, and a broadband (B) PON respectively conforming to G.987, G.984, and G.983 series other than the TWDM-PON conforming to G.989 series of the ITU-T recommendations, or a 10G E-PON and a Gigabit Ethernet (trade name) (GE)-PON respectively conforming to IEEE 802.3av, IEEE 1904.1, and the like, and IEEE 802.3ah. When the PON conforms to IEEE, the same applies if the transmission convergence (TC) layer and the physical medium dependent (PMD) layer are interpreted as their corresponding layers in the standard.

The communication apparatus includes hardware, software, components of a combination of those, or componentized functions. For example, the communication apparatus includes a software component, such as an application (for example, a flexible access system architecture (FASA) (new access system architecture) application) that is implemented using an input/output interface (for example, a FASA application API), which is a generalized resultant of a function or the like that is different from one service to another or from one communication carrier to another, and an platform constituent element (for example, a FASA platform) of an access network apparatus that provides the generalized input/output interface in the software component and that provides functions that do not require modifications depending on a service or a requirement due to a reason of being standardized, for example. Here, the use of such a generalized input/output interface facilitates addition and replacement of a function, and flexible and prompt provision of services of various requirements. Note that an application is herein also referred to as an “App”.

Communication between components is performed via a middleware unit 120 (described later), for example. However, a proprietary transfer path or means of a communication apparatus 1 may be used, or standardized means such as OpenFlow, Netconf/YANG, and Simple Network Management Protocol (SNMP) may be used.

Communication between components may be performed via any path of internal wiring, a back board, an operation administration and maintenance (OAM) unit, a main signal line, dedicated wiring, an OpS or the like, a controller, and a control (Cont) board (control panel), for example. If communication between components is directly terminated to input the communication, encapsulation in the OAM unit or the main signal may be adopted. Communication between components may be terminated at any point, and input may be performed via a path such as internal wiring, a back board, an OAM unit, a main signal line, dedicated wiring, an OpS or the like, a controller, or a control board. When the OAM unit or the main signal line is used, it is desirable to adopt encapsulation in the OAM unit or the main signal. When the main signal line is used as a medium, it is desirable to carry out distribution at the OSU or the SW at another point. The same applies hereinafter.

An entity that performs replacement, addition, and deletion or switching/configuration for implementing such procedures is software, hardware, a combination thereof, a component, a part of an apparatus, or an apparatus. The following description illustrates an example in which the above operation is performed by an apparatus constituting a network. The same applies even when the apparatus illustrated in the following example is replaced by software, hardware, a combination thereof, a component, or a part of an apparatus.

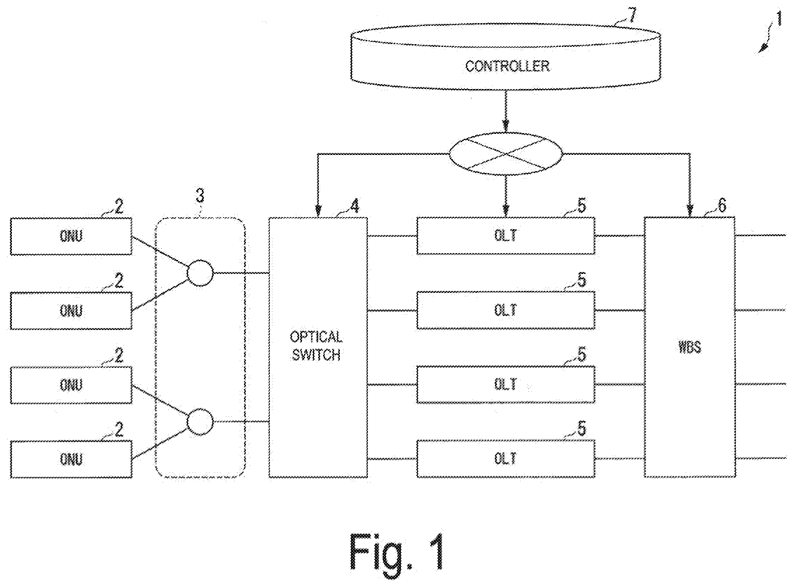

FIG. 1 is a diagram illustrating a configuration example of the communication apparatus 1. For example, the configuration example is illustrated with ONUs 2 (transmission execution units), an optical distribution network 3, an optical switch 4 (an execution unit configured to execute switching), OLTs 5 (execution units configured to execute transmission), a WBS 6 that distributes signals to the OLTs 5 (an execution unit configured to execute transmission), and a controller 7 (an instruction unit), which are illustrated in FIG. 1. Each OLT 5 may be an OSU. In terms of flexibility and prompt replacement and addition of functions/components, the configuration assumes hitless forced switching that allows replacement of operating components, and adopts order of buffering of uplink signals in the ONUs 2 and downlink signals in the WBS 6, awaiting transmission until uplink and downlink signals being sent are completely transmitted, switching of the optical switch 4, and re-outputting in the ONUs 2 and the WBS 6.

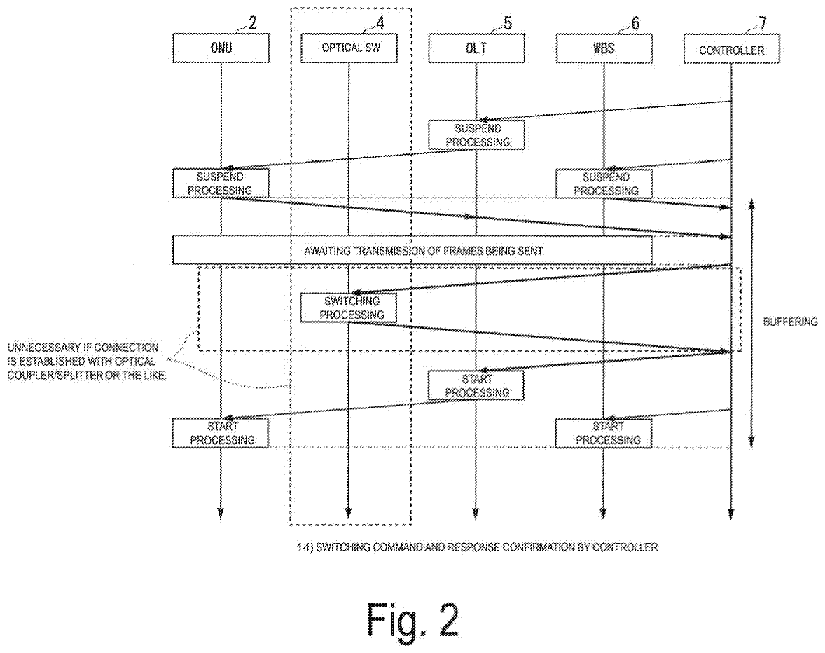

FIG. 2 to FIG. 9 each illustrate control that handles a variety of time lengths or the like required for replacement, addition, and deletion or switching/configuration for implementing such procedures of the present application. FIG. 2 to FIG. 9 are illustrated in time order from top to bottom, and blocks, diagonal arrows, vertical arrows denote processing, control, buffering time, respectively.

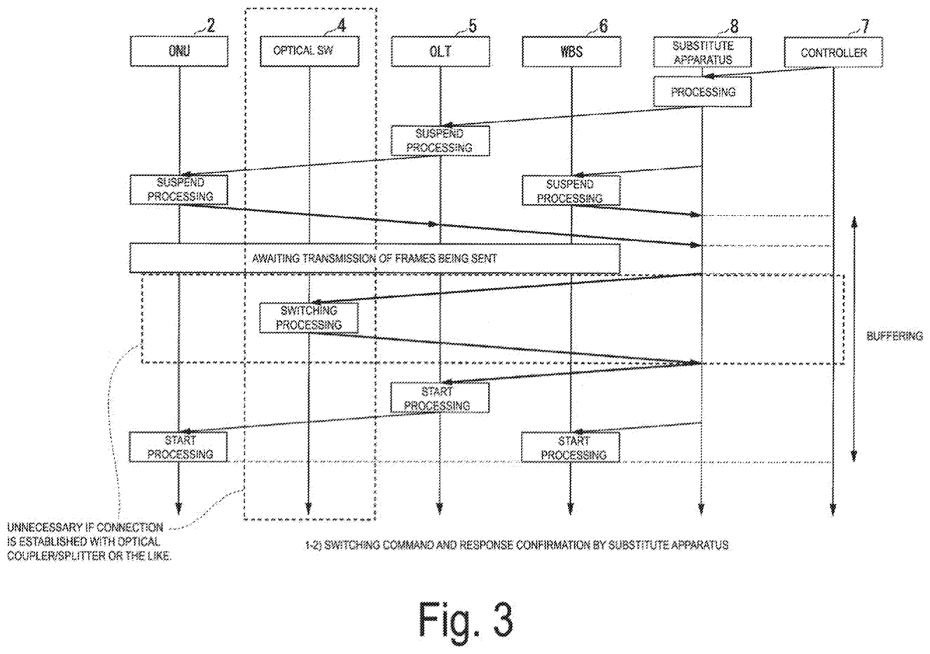

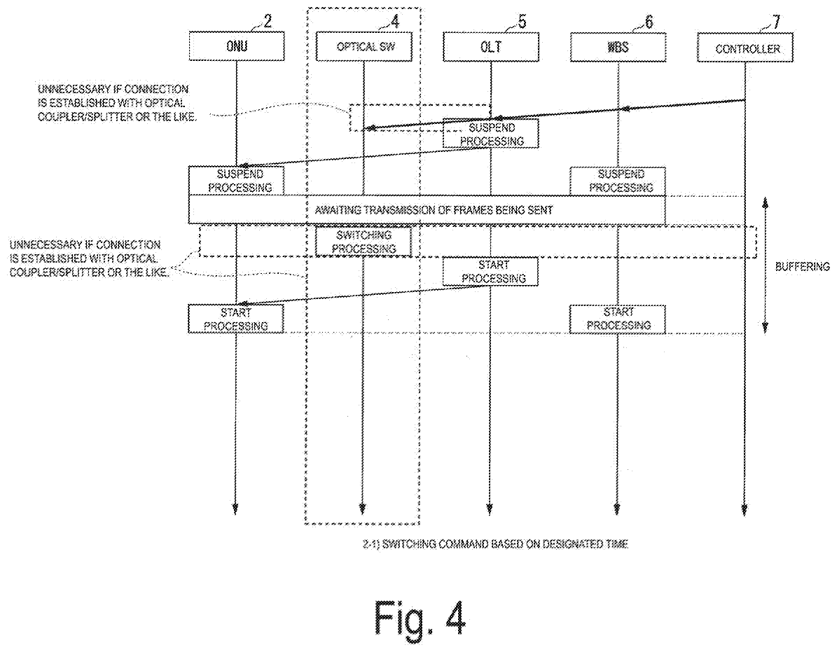

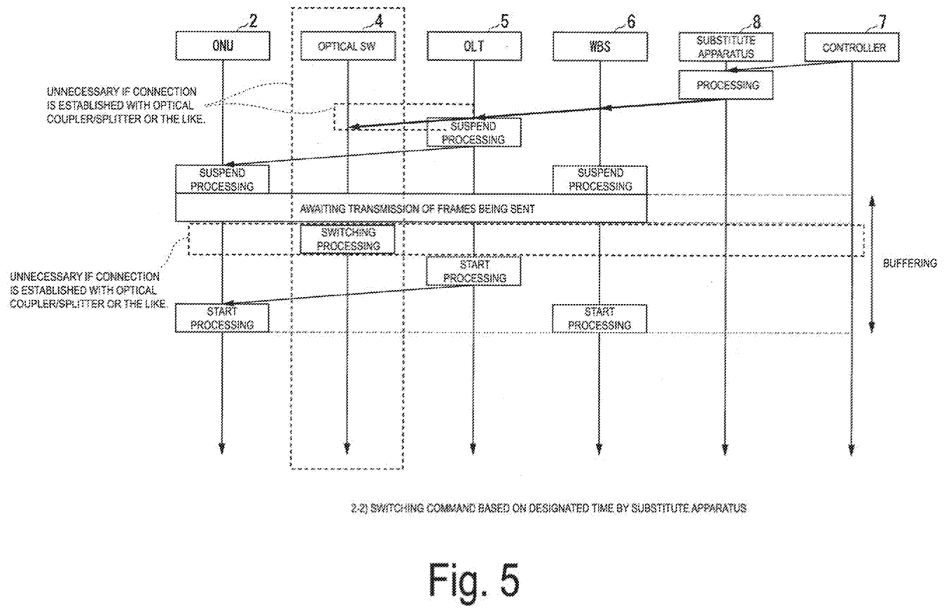

1-1) illustrated in FIG. 2 and 1-2) illustrated in FIG. 3 define a control interface based on response confirmation, and 2-1) illustrated in FIG. 4 and 2-2) illustrated in FIG. 5 define a control interface based on time specification. Such control interfaces handle differences in time lengths for switching/configuration or the like, which are different from one component/apparatus to another and have different values to be applied depending on an SLA.

One issue of switching control based on response confirmation from the EMS is that it is significantly affected by communication time between the EMS and a component. In view of this, in proposal 1, the controller 7 or a substitute apparatus 8 executes control at such a short distance that communication time can be ignored. In proposal 2, the controller 7 or the substitute apparatus 8 executes switching based on time specification.

1-2) and 2-2) include the substitute apparatus 8 that performs control on behalf of the controller 7. When the substitute apparatus 8 substitutes the controller 7, scalability of the controller 7 can be secured.

Deployment at a shorter distance from a component or an apparatus than the controller 7, particularly at such a short distance that response latency can be ignored, reduces influence from response latency.

In 1-1) and 1-2), a time period for buffering information such as frames to be switched varies depending on response latency between the controller 7 or the substitute apparatus 8 that serves as a control entity (which may be hereinafter referred to as an “instruction unit”) being an entity that performs control and an apparatus or a component (which may be hereinafter referred to as an “execution unit”) that serves as a switching entity being an entity that receives control from the control entity and performs switching. Regarding response latency, propagation latency between the control entity and a component is herein described as being substantially dominant. However, if conversion time in a signal format, time required for processing in an apparatus or a component, or the like cannot be ignored, it is desirable that those be included.

1-1) and 1-2) can be executed with a communication apparatus including an execution unit that executes switching of paths of signals, an execution unit that executes transmission of the signals on the paths, and an instruction unit. The execution unit that executes switching of paths of signals includes a second interface configured to directly or indirectly acquire a switching command, and executes switching of the paths according to the switching command. The execution unit that executes transmission of the signals on the paths includes a third interface configured to directly or indirectly acquire a transmission command, and starts or suspends transmission of the signals according to the transmission command. The instruction unit includes a first interface configured to directly or indirectly send the switching command to the execution unit that executes switching and directly or indirectly send the transmission command to the execution unit that executes transmission. In the communication apparatus, when the execution unit that executes switching acquires a switching command, the execution unit directly or indirectly sends a response to the switching command to the instruction unit, and executes switching of the paths. When the execution unit that executes transmission acquires a transmission suspension command, the execution unit directly or indirectly sends a response to the suspension command to the instruction unit, and suspends transmission. When the instruction unit acquires the response to the switching command and acquires the response to the suspension command, the instruction unit directly or indirectly sends a transmission start command to the execution unit that executes transmission.

In other words, to implement 1-1) and 1-2), the communication apparatus 1 includes an interface to input control output from the control entity to the switching entity, and to input response output from the switching entity to the control entity. The control entity receives the response from the switching entity, and subsequently controls the switching entity. If the response from the switching entity is not output after completion of processing but is output before switching or during switching, time obtained by subtracting an amount corresponding to response latency such as propagation latency from the switching entity to the control entity from a time period taken from output of the response to switching, or an amount corresponding to response latency such as propagation latency from the switching entity to the control entity is subtracted from a time period taken from output of the response to switching, so that processing of the next switching entity is not started before processing of the switching entity. The control entity subsequently outputs control at or after the time obtained by subtracting an amount corresponding to response latency such as propagation latency from the control entity to the next switching entity. In this case, buffering for an amount corresponding to the response latency is reduced. Here, if a response from the switching entity and time of processing completion vanes, 2-1) illustrated in FIG. 4 and 2-2) illustrated in FIG. 5 to be described later handle in a similar manner to time accuracy of time specification. For example, from the point of view of avoiding loss of information such as frames to be switched, the maximum value of the variation may be used, or it is only required to be handled in a manner that processing completes after a time width in which loss of information such as frames to be switched is tolerable in a stochastic aspect or the like, for example, statistics obtained by applying variance multiplied by a predetermined coefficient to an average value, for example.

Note that, in the above, the response confirmation is output by the switching entity that has received control. However, a switching entity to be paired, for example, an opposing apparatus or component across a link, or a further apparatus or component of a corresponding apparatus or component, or an apparatus in the reserve system may output the response confirmation and input the output response confirmation to the control entity.

In 2-1) illustrated in FIG. 4 and 2-2) illustrated in FIG. 5, a time period for buffering information such as frames to be switched varies depending on time accuracy of time specification. Here, as the time accuracy, from the point of view of avoiding loss of information such as frames to be switched, the maximum value of the variation may be used, or a time width in which loss of information such as frames to be switched is tolerable in a stochastic aspect or the like, for example, statistics obtained by applying variance multiplied by a predetermined coefficient to an average value, for example, may be used. For example, the following may be used: Predicted processing latency, measured maximum processing latency, design maximum processing latency, calculated maximum processing latency (according to priority of processing or the like), measured latency (within a tolerable loss rate or the like), design latency (within a tolerable loss rate or the like), and calculated latency (within a tolerable loss rate or the like) (according to priority of processing or the like), for example.

In the communication apparatus described above, the instruction unit directly or indirectly sends time information as a transmission command to the execution unit that executes transmission or the execution unit that executes switching. When the execution unit that executes switching acquires the time information, the execution unit executes switching of paths after signal transmission is suspended. When the execution unit that executes transmission acquires the time information, the execution unit suspends signal transmission, and starts the signal transmission after time indicated by the time information elapses.

In other words, to implement 2-1) and 2-2), the communication apparatus 1 includes an interface to input time-specified control that is output from the control entity, to the switching entity. The control entity controls the switching entity in such a manner that a downstream part performs processing after information such as frames to be switched stored in an upstream part is released.

Note that if time synchronization is not established between a control entity and a switching entity or between a switching entity and another switching entity, a time difference between such entities is acquired, and the entities control, or receive control, by adding or subtracting the difference of time according to the difference to or from the time. If only the time of the control entity is ahead of that of the switching entity, control can be performed without subtracting a difference. However, if a command is given at time from which the difference is subtracted, switching is performed earlier. If only the time of the control entity is behind that of the switching entity, control is performed at time later than a difference and response latency, or a command is given at time to which time equal to or more than the difference is added. If time synchronization is not established between switching entities, a command is given at time obtained by adding difference time to the late entity, a command is given at time obtained by subtracting difference time from the advancing entity, or a command is given so that the time is the sum of time added to the late entity and time subtracted from the advancing entity. If there is a time difference between the control entity and the switching entity, a combination of the above is used.

Regarding detection of the difference time, detection ma be performed within a range of time that falls within predetermined values in which time difference satisfies restriction of buffering time or the like according to clock accuracy of an apparatus or a component from switching time, or difference at the time of switching may be calculated based on a plurality of times of measurements.

For the measurement, time stamp option of Ping (in milliseconds), received time of FreeBSD packets (in microseconds), received time of Linux (trade name) (in nanoseconds), Network Time Protocol (NTP) (in milliseconds), IEEE 1588 Precision Time Protocol (PTP) (in nanoseconds), or a dual-ended Ethernet Loss Measurement function (ETH-LM) by a Continuity Check Message (CCM) may be used.

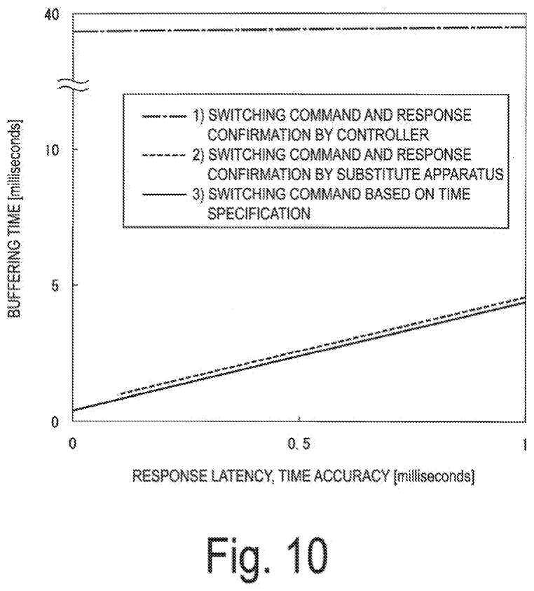

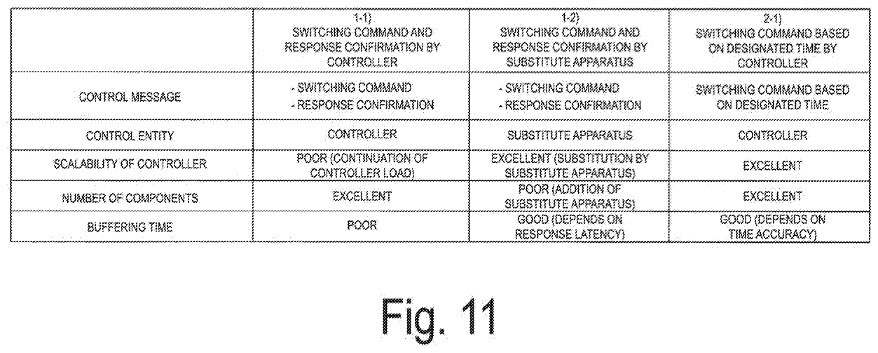

In one example, buffering time corresponding to response latency between the substitute apparatus 8 and a component of 1-2) illustrated in FIG. 3 and buffering time corresponding to time accuracy of time specification of 2-1) illustrated in FIG. 4 are shown in FIG. 10. Here, processing, awaiting transmission of frames being sent, response latency between components, and response latency between the controller 7 and a component, are 0.1 milliseconds, 0.1 milliseconds, 0.1 milliseconds, and 10 milliseconds, respectively, and response latency between the substitute apparatus 8 and a component is 0.1 milliseconds or more. Comparison between 1-1) illustrated in FIG. 2, 1-2) illustrated in FIG. 3, and 2-1) illustrated in FIG. 4 based on the above premise is shown in FIG. 11. As shown in FIG. 10, according to the premise used herein, 2-1) achieves the minimum buffering time, and as shown in FIG. 11, in terms of scalability and buffering time, 2-1) using an interface based on time specification is desirable when time accuracy is 0.2 milliseconds or less.

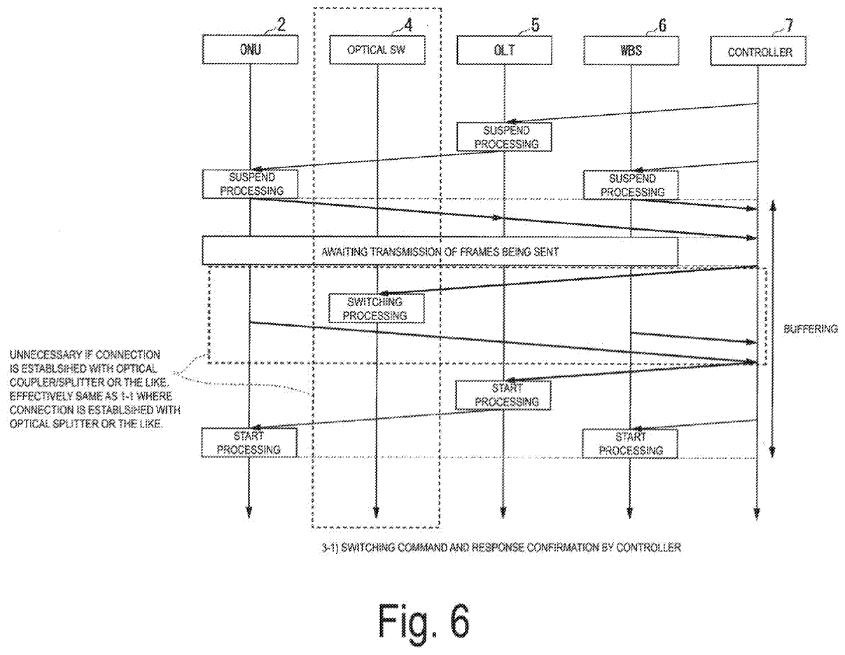

1-1), 1-2), 2-1), and 2-2) illustrated in FIG. 2 to FIG. 5 may be 3-1), 3-2), 4-1), and 4-2) illustrated in FIG. 6 to FIG. 9 in which a part or all of processing of a part or all of switching entities is simulated.

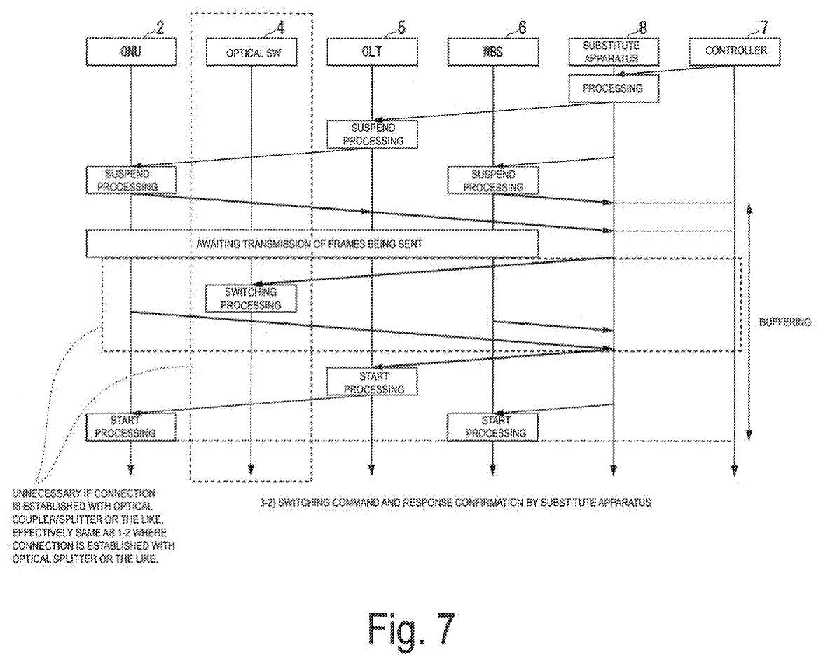

In 3-1) illustrated in FIG. 6 and 3-2) illustrated in FIG. 7, instead of the configuration that the switching entity performs response confirmation, confirmation of the no continuity of information such as frames in the downstream part for a predetermined observation period is used instead of response confirmation. The predetermined observation period may be, for example, unit time of one or a plurality of observations in a downstream apparatus, may be time required for continuity of the switching entity, may be time obtained by adding propagation time to reach a downstream component or apparatus to be observed to time required for continuity of the switching entity, or may be time obtained by adding unit time of one or a plurality of observations in a downstream apparatus to the time mentioned immediately before. In 3-1) and 3-2), only the optical SW 4 does not perform response confirmation, and uses no continuity of the ONU 2 and the WBS 6 instead. Here, in a similar manner to the optical SW 4, the ONU 2 and the WBS 6 may also use no continuity of a downstream apparatus or component instead.

In the communication apparatus described above, when the execution unit that executes transmission acquires a transmission suspension command, the execution unit directly or indirectly sends a response to the suspension command to the instruction unit. When the execution unit that executes switching acquires a switching command, the execution unit executes switching of paths. When the instruction unit acquires the response to the suspension command and no signal has been transmitted for a predetermined period, the instruction unit directly or indirectly sends a transmission start command to the execution unit that executes transmission.

In other words, to implement 3-1) and 3-2), the communication apparatus 1 includes an interface configured to input control that is output from the control entity to the switching entity, and configured to output that there is no continuity of a downstream apparatus of the switching entity instead of a response of the switching entity and input the output to the control entity. The control entity receives the information of no continuity of a downstream apparatus of the switching entity instead of a response of the switching entity, and subsequently controls the switching entity. The description herein illustrates a case where only the optical SW 4 applies to 3-1) and 3-2). However, all of the switching entities may apply to 3-1) and 3-2).

Note that, when the information of no continuity is used instead, the information of no continuity of a switching entity to be paired, for example, an opposing apparatus or component across a link, or a further apparatus or component of a corresponding apparatus or component, and the information of continuity of an apparatus or a component in the reserve system may be output and input to the output control entity.

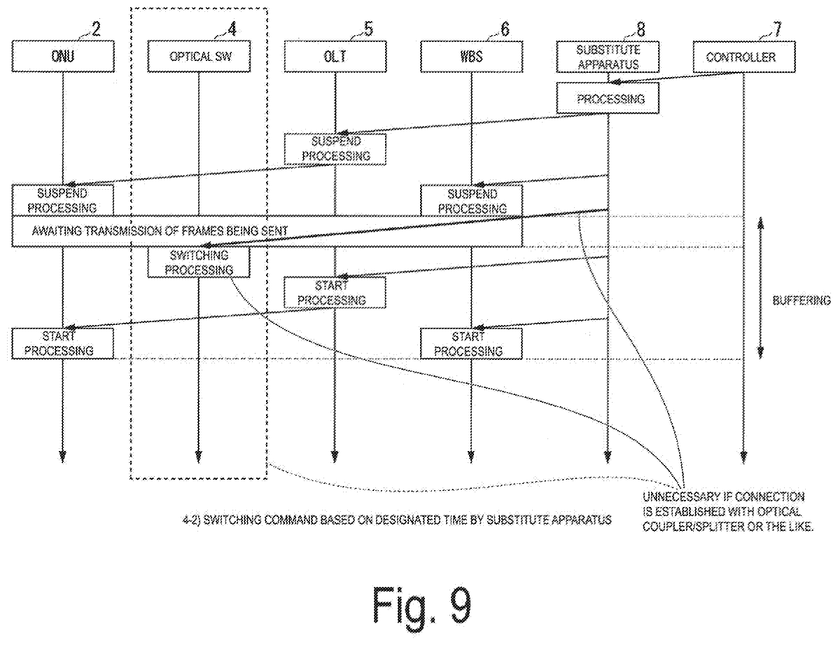

In 4-1) illustrated in FIG. 8 and 4-2) illustrated in FIG. 9, instead of specifying time, when processing is performed in predetermined time from reception of control input, an adjustment is made by outputting control output from the control entity at time obtained by subtracting predetermined time and response latency from the desired time so that processing is performed at the desired time, of which processing is used instead of time specification. Alternatively, instead of time specification, an adjustment is made by delaying execution of control to time obtained by subtracting response latency and predetermined time from the desired time in the switching entity. Alternatively, instead of time specification, delay is caused by time obtained by subtracting predetermined time and response latency from the desired time in a path from the control entity to the switching entity, and input to the switching entity is performed. Alternatively, instead of time specification, an adjustment is made by causing a delay by proportionally dividing time obtained by subtracting predetermined time and response latency from the desired time by any two or more of the control entity, the switching entity, and paths. FIG. 2 to FIG. 9 illustrate an example in which the control entity makes such an adjustment.

In the communication apparatus described above, the instruction unit adjusts suspension time being time at which transmission is suspended and start time at which transmission is started, so that signals can be transmitted in paths. Then a transmission suspension command is directly or indirectly sent to the execution unit that executes transmission at the suspension time, and a transmission start command is directly or indirectly sent to the execution unit that executes transmission at the start time. When the execution unit that executes switching acquires a switching command, the execution unit executes switching of paths. When the execution unit that executes transmission acquires the suspension command, the execution unit suspends signal transmission, and when the execution unit acquires the start command, the execution unit starts signal transmission.

In other words, to implement 4-1) and 4-2), the communication apparatus 1 includes an interface that can be configured to acquire predetermined time, and delay control by time obtained by subtracting predetermined time and response latency from the desired time.

The description of FIG. 2 to FIG. 9 has been given on the following premise: In an example in which the optical SW as illustrated in communication system configurations (1-1) to (32-2) to be described later is provided between the ONU and the OLT, at least information such as frames to be switched is received for the WBS and both the OLTs before switching and after switching, and transmission suspension processing (suspension of sending and holding of queues caused thereby) and transmission start processing (start of sending and releasing of queues caused thereby) in the downlink direction are executed. The OLT continues to transmit at least information such as frames to be switched that its own apparatus received to the downstream part, and gives a command of suspension processing and start processing in the uplink direction to the ONU. The ONU continues to transmit at least information such as frames to be switched in the downlink direction, and executes at least transmission suspension processing in the uplink direction to be switched, storing of queues caused thereby, start processing, and releasing of queues caused thereby, in accordance with the command of the OLT. The optical SW executes switching processing, and commands 1+1 switching in the downlink direction and M:N switching in the uplink direction, collectively commands suspension and start times in (2-1) and (2-2), and separately commands suspension and start in (4-1) and (4-2).

Note that the OLT after being switched presupposes a transmittable state even before switching. However, if functionality necessary for start processing becomes available at the time point of start processing in FIG. 2 to FIG. 9, the state may be a low energy consuming state such as power off and sleep until the time point.

In (1-1 and 1-2), a response is performed after execution. However, similar processing is possible even at the time of reception or after a predetermined time period has elapsed from the reception by adding time from reception to completion of execution if the response is performed at the time of reception, or time from the time after a predetermined time period has elapsed to completion of execution if the response is performed after a predetermined time period has elapsed.

In (1-1 and 1-2) and (3-1 and 3-2), if time from suspension processing to acquisition of a response or its substitute is long and at least information such as frames to be switched is released, time corresponding to “awaiting transmission of frames being sent” of the figures is included in the time from suspension processing to acquisition of a response or its substitute, and time need not be separately set aside. In the predetermined observation period of (3-1 and 3-2), for example, if intervals of pieces of information such as frames to be switched such as a health check or longer is adopted, there is information such as frames to be switched that is supposed to have continuity, and for example, if the sum of retained time in a mid-way apparatus and propagation time or longer is adopted, at least information such as frames to be switched, if any, is supposed to have continuity. Both the cases are thus desirable because they eliminate detection of errors.

The time specification of (2-1 and 2-2) is illustrated by taking an example of simultaneously specifying both suspension and start. However, if those are specified individually, those may be simultaneously specified, or may be sequentially specified as in (4-1 and 4-2). Simultaneous specification produces a greater effect of reducing a load of the controller or the like and traffic of commands.

If one of them is specified and the other is set at predetermined time with respect to it in (2-1 and 2-2), it is only required that the predetermined time be time at which or after start processing may be performed. However, buffering time is prolonged. In (4-1 and 4-2), if start execution is later than predetermined time after suspension execution, the same applies in that it is only required that the time later than the predetermined time is time at which or after start processing may be performed.

In order that the WBS implements M:N switching in both the uplink and downlink directions in which at least information such as frames to be switched is received with respect to the WBS and one OLT before switching or after switching, it is only required that switching processing be executed at time the same as switching processing of the optical SW in time series in FIGS. 2 to 9. In order that switching processing is performed at time approximately the same as the optical SW, 1-1 adopts the following configuration: The controller sends switching processing to the optical SW. The controller then sends a command to the WBS. The WBS sends a response to the controller after switching processing of the WBS. The response reaches the controller earlier than the switching processing of the optical switch.

In order that switching processing is performed at time approximately the same as the optical SW, 1-2 adopts the following configuration: the substitute apparatus sends switching processing to the optical SW. A command is then sent to the substitute apparatus or the WBS. The WBS sends a response to the substitute apparatus after switching processing of the WBS. The response reaches the substitute apparatus earlier than the switching processing of the optical switch. In order that switching processing is performed at time approximately the same as the optical SW, 2-1 adopts the following configuration: switching time at time immediately after “awaiting transmission of frames being sent” of the figures is included in a command of the WBS from the controller. In order that switching processing is performed at time approximately the same as the optical SW, 2-2 adopts the following configuration: switching time at time immediately after “awaiting transmission of frames being sent” of the figures is included in a command of the WBS from the substitute apparatus. In order that switching processing is performed at time approximately the same as the optical SW, 3-1 adopts the following configuration: The controller sends switching processing to the optical SW. The controller then sends a command to the WBS. The WBS sends a response to the controller after switching processing of the WBS. The response reaches the controller at time approximately the same as an observation result of the WBS used instead of a response of the optical switch. In order that switching processing is performed at time approximately the same as the optical SW, 3-2 adopts the following configuration: The substitute apparatus sends switching processing to the optical SW. A command is then sent to the substitute apparatus or the WBS. The WBS sends a response to the substitute apparatus after switching processing of the WBS. The response reaches the substitute apparatus at time approximately the same as an observation result of the WBS used instead of a response of the optical switch. In order that switching processing is performed at time approximately the same as the optical SW, 4-1 adopts the following configuration: The controller gives a command of switching at time immediately after “awaiting transmission of frames being sent” of the figures to the WBS. The WBS performs switching after predetermined time has elapsed from the command. In order that switching processing is performed at time approximately the same as the optical SW, 2-2 adopts the following configuration: The substitute apparatus gives a command of switching at time immediately after “awaiting transmission of frames being sent” of the figures to the WBS. The WBS performs switching after predetermined time has elapsed from the command.

It is only required that “execution of switching” of the figures be executed between suspension of sending and start of sending even if it is not the same as switching processing of the optical SW in time series, as long as suspension of sending of at least information such as frames to be switched and storing of queues are continued until transmission start. These apply the same for other apparatuses as well when similar processing is performed. In a case of such 1+1 switching, although the controller or the substitute apparatus gives a command of switching processing and the WBS needs to execute it, there is an effect of reducing at least a part of used bandwidth in paths in the downlink direction from the WBS to the optical SW.

To adopt 1+1 switching in both the uplink and downlink directions, an optical coupler/splitter or the like such as an optical coupler/splitter such as an optical coupler and an optical splitter and a multiplexer/demultiplexer such as a WDM coupler allowing continuity of a wavelength of a corresponding ONU or OLT is used as the optical switch, and processing to be described later is performed.

If the optical switch is not included, for example, instead of an optical SW, a plurality of paths are connected with an optical coupler/splitter or the like, or two or more of a wavelength, a core wire, a core, a mode, a code, a frequency, a (sub-)carrier, or the like and a combination of those are used. Here, as the optical coupler/splitter or the like used instead of the optical switch may be an optical coupler/splitter included in the optical distribution network 3, or another optical coupler/splitter may be separately provided. If one provided therewith is used, for example, when an L:K optical coupler/splitter or the like is used and the OLT side is L (≥2), it is only required that the OLT of the reserve system be connected to an L-side port.

When connection is established with an optical coupler/splitter or the like and switching is performed in one direction, transmission by a sender before the switching is suspended (suspension of sending and holding of queues caused thereby), and transmission by a sender after the switching is started (start of sending and releasing of queues caused thereby) after any one of response acquisition (1-1 and 1-2), elapse of time (2-1 and 2-2), acquisition of information instead of a response (3-1 and 3-2), and elapse of predetermined time after a command (4-1 and 4-2). Note that, here, if propagation time differs to the extent of causing superimposition of information such as frames to be switched from paths before switching and after switching and inversion of reaching order of information such as frames to be switched before and after switching, elapse of time corresponding to “awaiting transmission of frames being sent” of the figures is secured before transmission start to the extent of causing superimposition of information such as frames to be switched and inversion of reaching order of information such as frames to be switched. However, if switching is performed with both sending before switching and sending after switching being synchronized, transmission may be started immediately after suspension of transmission. If only the active system receives, it is only required that the apparatus after switching receive before at least information such as frames to be switched reaches the apparatus.

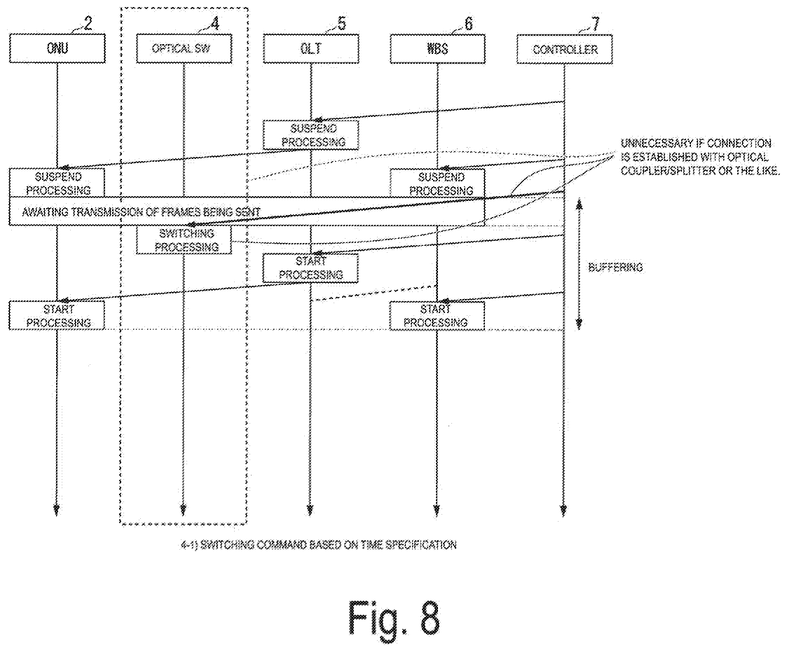

If connection is implemented with an optical coupler/splitter or the like and switching is performed with sending and receiving being synchronized in both the directions, the part enclosed by the broken line in FIG. 2 to FIG. 7 is deleted or switching processing and a command therefore are deleted in FIG. 8 to FIG. 9. In other words, transmission by a sender before the switching is suspended as supplemented (suspension of sending and holding of queues caused thereby), and time corresponding to “awaiting transmission of frames being sent” of the figures elapses after any one of response acquisition (1), elapse of time (2), acquisition of information instead of a response (3), and elapse of time after a command (4), and transmission by a sender after the switching is started (start of sending and releasing of queues caused thereby).

If an optical SW is not included, two or more of a wavelength, a core wire, a core, a mode, a code, a frequency, a (sub-)carrier, or the like and a combination of those are used, and switching is performed in one direction, transmission by a sender before the switching is suspended (suspension of sending and holding of queues caused thereby), and transmission by a sender after the switching is started (start of sending and releasing of queues caused thereby) is executed after any one of response acquisition (1-1 and 1-2), elapse of time (2-1 and 2-2), acquisition of information instead of a response (3-1 and 3-2), and elapse of predetermined time after a command (4-1 and 4-2). However, if switching is performed with both sending before switching and sending after switching being synchronized, transmission may be started immediately after transmission suspension. Note that, here, if propagation time differs to the extent of causing superimposition of information such as frames to be switched from paths before switching and after switching and inversion of reaching order of information such as frames to be switched, elapse of time corresponding to “awaiting transmission of frames being sent” of the figures is secured before transmission start to the extent of not causing superimposition of information such as frames to be switched in paths before switching and after switching and inversion of reaching order of information such as frames to be switched. Here, if the WBS allows flow to both the OLTs before switching and after switching, the OLT executes its own downlink transmission suspension and transmission start, the ONU receives one of before switching and after switching, or the WBS switches the OLTs communicating information such as frames to be switched before switching and after switching. The same applies hereinafter. Here, if two or more of a wavelength, a corewire, a core, a mode, a code, a frequency, a (sub-)carrier, or the like and a combination of those are included, switching may be executed between a plurality of ones including those. If switching is executed, switching is executed between suspension of sending and start of sending by the apparatus.

If an optical SW is not included, two or more of a wavelength, a core wire, a core, a mode, a code, a frequency, a (sub-)carrier, or the like and a combination of those are used, and switching is performed with both the directions being synchronized, transmission by a sender before the switching is suspended (suspension of sending and holding of queues caused thereby) is executed, time corresponding to “awaiting transmission of frames being sent” of the figures elapses after any one of response acquisition (1-1 and 1-2), elapse of time (2-1 and 2-2), acquisition of information instead of a response (3-1 and 3-2), and elapse of time after a command (4-1 and 4-2), and transmission of a sender after the switching is started (i.e., reception start).

The above description illustrates an example in which the ONU and the WBS are used for transmission suspension and transmission start, the optical SW is used for switching, and the OLT is used for relay of a command to the ONU. However, the ONU, the optical SW, the OLT, and the WBS may each execute suspension of transmission (suspension of sending and holding of queues caused thereby), switching, start of transmission (start of sending and releasing of queues caused thereby), transmission suspension may be suspension of sending without holding queues, and transmission start may be start of sending without releasing queues.

Even if the optical SW can execute transmission suspension and transmission start in addition to switching but uses only switching, the same processing as that described in FIG. 2 to FIG. 9 applies.

If apparatuses performing a plurality of transmission suspensions (suspension of sending and holding of queues caused thereby) and transmission starts (start of sending and releasing of queues caused thereby) overlap, it is only required that an upstream apparatus suspends sending, time corresponding to “awaiting transmission of frames being sent” of the figures elapse after any one of response acquisition (1-1 and 1-2), elapse of time (2-1 and 2-2), acquisition of information instead of a response (3-1 and 3-2), and elapse of predetermined time after a command (4-1 and 4-2), and a downstream apparatus performs suspension of sending. In other words, from the upstream part, suspension is sequentially performed with intervals of time corresponding to “awaiting transmission of frames being sent” of the figures. An apparatus that executes switching or an immediately preceding upstream apparatus of the apparatus suspends sending, and time corresponding to “awaiting transmission of frames being sent” of the figures elapse after any one of response acquisition (1-1 and 1-2), elapse of time (2-1 and 2-2), acquisition of information instead of a response (3-1 and 3-2), and elapse of predetermined time after a command (4-1 and 4-2): that is, switching is executed after information such as frames to be switched of the upstream apparatus of the apparatus that executes switching is released. Transmission start is sequentially started from the downstream part. Start time, however, may be set closer to or inversed with another to the extent of not causing superimposition of information such as frames to be switched and inversion of reaching order of information such as frames to be switched with the start time and propagation time being included. Note that an apparatus that cannot output in a path after switching at time after switching sequentially performs transmission suspension of downstream apparatuses after releasing information such as frames to be switched held in upstream apparatuses. In contrast, an apparatus that can output, in a path after switching, information such as frames to be switched of an apparatus holding information such as frames to be switched after switching may switch while holding information such as frames to be switched, and release information such as frames to be switched after transmission start. In consideration of loss of information such as frames to be switched, sending from the downstream part is preferably started. However, transmission may be started on the condition that, for example, downstream switching is executed after a downstream path is established. For example, the sending is performed from the downstream part as in the ONU, the optical SW, the OLT, and the WBS, or overflow of information such as frames to be switched can be prevented even when the order is out of sequence in a period without overflow of a buffer of each apparatus. The period without overflow is a period obtained by, for example, adding time obtained by dividing a buffer length in which the information such as frames to be switched is available by an input bandwidth to propagation time.

In order to prevent retaining of information such as frames to be switched, it is only required that an apparatus that executes transmission suspension and transmission start that do not involve storing and releasing of queues be located on the same side from the perspective of an apparatus that executes switching with the apparatus, and an apparatus that involves storing of queues and releasing of queues hold information such as frames to be switched.

If the optical SW can execute transmission suspension, switching, and transmission start, the ONU does not perform switching, paths between the optical SW and the WBS or apparatuses that configure the paths are set as a target instead of switching paths between the ONU and the WBS or apparatuses that configure the path, and switching is performed in one direction, transmission of a sender before the switching is suspended (suspension of sending and holding of queues caused thereby) is executed. Then, switching is performed after any one of response acquisition (1-1 and 1-2), elapse of time (2-1 and 2-2), acquisition of information instead of a response (3-1 and 3-2), and elapse of time after a command (4-1 and 4-2), and transmission of a sender after the switching (start of sending and releasing of queues caused thereby) is executed. Note that, here, if propagation time differs to the extent of causing superimposition of information such as frames to be switched and inversion of reaching order of information such as frames to be switched before and after switching, elapse of time corresponding to “awaiting transmission of frames being sent” of the figures is secured before transmission start to the extent of causing superimposition of information such as frames to be switched and inversion of reaching order of information such as frames to be switched.

Next, if the optical SW can execute transmission suspension, switching, and transmission start, the ONU does not perform switching, paths between the optical SW and the WBS or apparatuses that configure the paths are set as a target instead of switching paths between the ONU and the WBS or apparatuses that configure the paths, and switching is performed in both the directions, transmission by a sender before the switching is suspended (i.e., suspension of sending). Then, time corresponding to “awaiting transmission of frames being sent” of the figures elapses after any one of response acquisition (1-1 and 1-2), elapse of time (2-1 and 2-2), acquisition of information instead of a response (3-1 and 3-2), and elapse of time after a command (4-1 and 4-2), and transmission by a sender after the switching is started (i.e., reception start).

In the above and following description, switching with a switch and cross-connect and wavelength switching are mainly described. However, switching of communication states in an optical communication system may be, for example, switching of functions or components. It is only required that switching of functions or components be implemented by switching functions or components themselves, or switching paths of functions or components through which signals such as main signals and control signals or processing passes. The active system and the standby system to be switched may be a function and a function, a component and a component, or a function and a component, and the function or the component may be a path, a stub, or the like that does not perform processing required as a function or a component but only performs transparent transmission or transmission.

In the following example, for example, if a function or a component of each of the active system and the standby system or the active system and the standby system share the same information, communication of information between those sharing entities may be omitted.

Communication of state information and control information may occur between common signal lines, main signal lines, internal wirings, CTRLs (the Cont board or the controller 7), or a combination of those. The active system and the standby system may be the same. This applies for a switch, an optical switch, middleware, or a basic function unit that switches input and output between a plurality of functions or components, in particular.

The start point of switching may be any of the CTRL, the optical SW 4, the CT, the OSU, and the SW, and one example is a case where the function or the component is based on presence/absence of continuity, presence/absence of a response to a health check, self-diagnosis results, or the like.

Switching is performed at predetermined timing. The predetermined timing is, for example, time without frame continuity, time when there are no more frames being processed or to be processed in the active system, or the like so that no frames are lost during switching except a failure. In a case of failure switching, the predetermined timing is time when frames are not delivered to a destination not to be transferred, for example, the standby system has set a destination or setting of blocking output not to be transferred has enabled.

In the following example, a switching command is mainly illustrated as being output by the function or the component in one example. However, it may be output from an adjacent function or an adjacent component or another function or another component. In order that the timing is predetermined timing, the function or the component or another function or component may give a command in accordance with a command from the controller 7, a control unit, an application, a platform, an extended unit, a basic unit, middleware, a server, a proxy, or the like.

The state information or the command may be communicated between the active system, the standby system, and the component either individually or collectively.

At the time of switching, the active system may be caused to synchronize a clock of the standby system (for example, a relevant ONU/all ONUs/CTs/OSUs/OLTs), the active system may be caused to synchronize a clock of the standby system (for example, a relevant ONU/all ONUs/CTs/OSUs/OLTs) (it is desirable that a propagation latency difference be also corrected as a value obtained by adding or subtracting a difference), the standby system may be caused to synchronize a drifted clock of the active system (for example, a relevant ONU/all ONUs/CTs/OSUs/OLTs), or the standby system may be caused to synchronize a drifted clock of the active system (for example, a relevant ONU/all ONUs/CTs/OSUs/OLTs) (it is desirable that a propagation latency difference be also corrected as a value obtained by adding or subtracting a difference).

Transition to the initial state may be inhibited even if a warning due to a phase difference between the ONU and a signal exceeding a predetermined value is detected (inhibition judgment or inhibition command before, at the same time as, or after switching), detection of a warning may be inhibited even if a phase difference between the ONU and a signal exceeds a predetermined value (inhibition judgment or inhibition command before, at the same time as, or after switching), a phase difference between the ONU and a signal may change a predetermined value (change judgment or change command before, at the same time as, or after switching), or detection of a phase difference between the ONU and a signal may be inhibited (inhibition judgment or inhibition command before/at the same time as/after switching).

In the present example, the communication apparatus further includes applications such as the FASA applications or interfaces for software components in a platform such as the FASA platform.

### Embodiment 1-1

In Embodiment 1-1, a configuration of a communication apparatus that configures a communication system used in a TWDM-PON will be described. The communication apparatus described in Embodiment 1-1 is used as the communication apparatus 1 illustrated in FIG. 1. The first example to the sixth example will be described below as examples of architecture of the communication apparatus. The architecture of the communication apparatus that configures the communication system may be architecture other than the first example to the sixth example described below. For example, a software unit of the communication apparatus in the first example to the sixth example of architecture may be a hardware unit.

First Example of Architecture

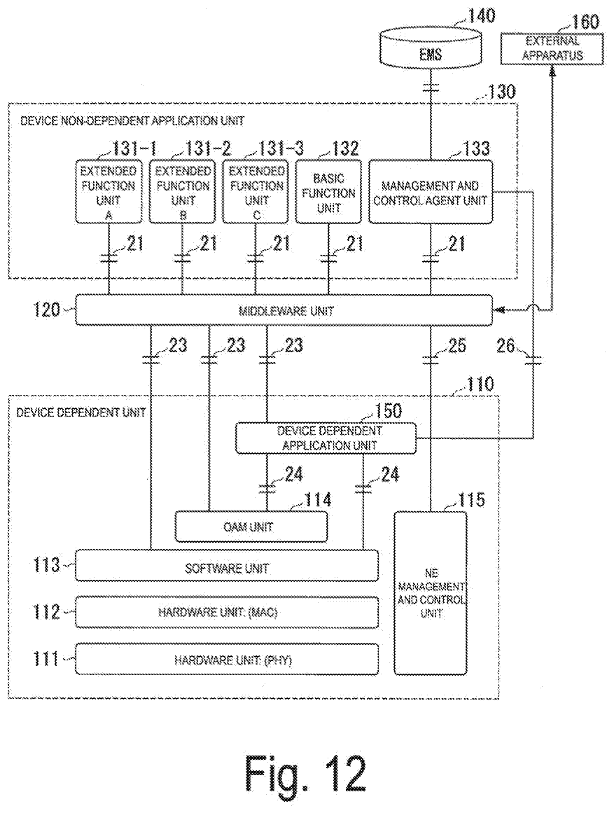

FIG. 12 is a diagram illustrating the first example of architecture of the communication apparatus. In the first example of architecture, the communication apparatus includes a non-general-purpose device dependent unit 110 whose operation is dependent on the device, a middleware unit 120 that reconciles a difference of hardware and software of the device dependent unit 110 and a device dependent application unit 150, a general-purpose device non-dependent application unit 130 whose operation is not dependent on the device, and a device dependent application unit 150. Thus, the device dependent unit 110 (vendor dependent unit) is a function unit that is dependent on a conformance standard of the device of the communication apparatus or a manufacturer/vendor of the device. In other words, the device dependent unit 110 has low compatibility with another communication device, and cannot be directly used in a newly manufactured communication device (device with a different conformance standard and manufacturer/vendor, in particular). The device dependent unit 110 executes one or more functions included in a network device.

The device non-dependent application unit 130 is a function unit that is not dependent on a conformance standard of the device of the communication apparatus, a scheme, a device type, a generation of the device, or a manufacturer/vendor of the device. In other words, the device non-dependent application unit 130 has high compatibility with another communication device, and can be directly used in a newly manufactured communication device (device with a different conformance standard and manufacturer/vendor, in particular). Specific examples of applications provided in the device non-dependent application unit 130 include an application that performs configuration processing in a network device, an application that performs configuration change processing, an application that performs algorithm processing, or the like

The middleware unit 120 and the device non-dependent application unit 130 are connected via device non-dependent APIs 21. Each device non-dependent API 21 is an input/output IF that is not dependent on the device.

The device dependent unit 110 includes, for example, a hardware unit 111 (PHY) that is dependent on a conformance standard or a device manufacturer/vendor of the device dependent unit 110, a hardware unit 112 (MAC), a software unit 113 and an OAM unit 114 that execute a driver that drives the hardware unit 111 (PHY) and the hardware unit 112 (MAC), firmware, or the like, and a device dependent application unit 150 that drives at least a part of the hardware unit 111 (PHY), the hardware unit 112 (MAC), and the software unit 113 of the device dependent unit 110. The hardware unit 111 (PHY), the hardware unit 112 (MAC), the software unit 113 and the OAM unit 114, and the middleware unit 120 are connected via device dependent APIs 23. Each device dependent API 23 is an input/output IF that is dependent on the device. The device dependent unit 110 further includes an NE management and control unit 115. The NE management and control unit 115 and the middleware unit 120 are connected via a device dependent API 25. The device dependent API 25 is an input/output IF that is dependent on the device.

The middleware unit 120 and the device dependent application unit 150 are connected via the device dependent APIs 23. The device dependent application unit 150 and the OAM unit 114, the software unit 113, the hardware unit 111 (PHY), and the hardware unit 112 (MAC) of the device dependent unit 110 are connected via device dependent APIs 24. The device dependent application unit 150 and a management and control agent unit 133 are connected via an API 26.

What kind of function is allotted to the device dependent unit 110 or the device non-dependent application unit 130 may be determined depending on a restriction that derives from processing for implementing the middleware unit 120 and the device non-dependent application unit 130, such as update frequency of a function and a degree of importance of an extended function in addition to a restriction that derives from processing capacity of software. In this manner, the communication apparatus allows the device non-dependent application unit 130 to facilitate flexible and prompt addition of an extended function unit (proprietary function unit), thus timely providing a communication service.

For example, by prioritizing a function that has high update frequency or a function that contributes to communication service differentiation such as dynamic bandwidth assignment (DBA) that enhances priority processing of main signals and use efficiency of a line, allotment to the device dependent unit 110 or the device non-dependent application unit 130 may be determined. Further, ones having a lower degree of difference regarding at least one of a conformance standard, a generation, a scheme, a system, a device type, and a manufacturer/vendor of the device to be used in common may be sequentially allotted to the device non-dependent application unit 130. Here, a predetermined function such as DBA is deployed in the device dependent unit or the device non-dependent application. However, depending on function deployment, both of those may be deployed in the device non-dependent application, or both of those may be deployed in the device dependent unit. An example of the case where both of those are deployed in the device non-dependent application is, for example, a case where a processing unit of a function such as DBA is included in an information processing unit such as a processor included in a powerless transceiver, an application or the like is included in an information processing unit at another position having powerful information processing capacity, such as an OSU, and inter-processor communication between apparatuses or inter-apparatus communication operates as middleware. The case where both of those are included in the device dependent unit is a case where functions such as DBA are each compiled as a part of firmware or the like in a similar manner to the above example, for example.

Even if it is not optimal for at least one of a conformance standard, a generation, a scheme, a system, a device type, and a manufacturer/vendor, a common IF may be used for executing the function to generalize any function of a conformance standard, a generation, a scheme, a system, a device type, and a manufacturer/vendor. The common IF may include an IF or a parameter that is not used in any of a conformance standard, a generation, a scheme, a system, a device type, and a manufacturer/vendor of the device dependent unit 110.

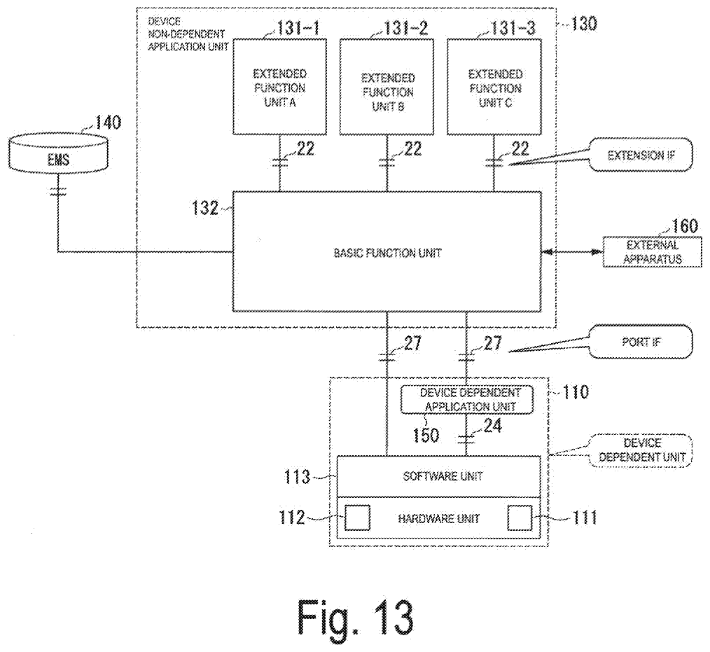

A conversion function unit that converts an IF, a parameter, or the like so as to be compatible with the device dependent unit 110 or a function unit that is automatically configured according to a deficient IF, parameter, or the like may be further included in at least one of the middleware unit 120 illustrated in FIG. 12, a driver of the device dependent unit 110 illustrated in FIG. 13 to be described later, and the device dependent application unit 150 (vendor dependent application unit) illustrated in FIG. 12 and FIG. 13 to be described later.

The device dependent unit 110 illustrated in FIG. 12 includes a hardware unit 111 (PHY), a hardware unit 112 (MAC), and a software unit 113. The hardware unit 111 (PHY) executes processing of a physical layer to that related to optical sending and receiving (physical sublayer processing). The hardware unit 112 (MAC) executes media access control (MAC) processing. The hardware unit 111 (PHY) and the hardware unit 112 (MAC) are dependent on a conformance standard and a manufacturer/vendor. The software unit 113 executes a device dependent driver, firmware, and an application, for example.

The hardware unit 111 (PHY) and the hardware unit 112 (MAC) of the device dependent unit 110 may include, other than those described above, a general-purpose server and a layer 2 SW, for example. The device dependent unit 110 need not include the hardware unit 112 (MAC). The device dependent unit 110 need not include a part of the hardware unit 111 (PHY). For example, the device dependent unit 110 may include only an optical function without including lower-level signal processing such as modulating and demodulating signal processing, forward error correction (FEC), coding and decoding processing, and encrypting processing. The device dependent unit 110 need not include a physical coding sublayer (PCS), which is a part that codes data. The device dependent unit 110 need not include a physical medium attachment (PMA) that serializes data and a PCS. The device dependent unit 110 need not include a PMD that connects to a physical medium. If the middleware unit 120 directly drives, controls, operates, or manages the hardware unit 111 (PHY) and the hardware unit 112 (MAC) of the device dependent unit 110 without using the software unit 113, the device dependent unit 110 need not include the software unit 113.

The device non-dependent application unit 130 includes, for example, extended function units 131-1 to 131-3 (an extended function A, an extended function B. and an extended function C in FIG. 12), a basic function unit 132, and a management and control agent unit 133. The management and control agent unit 133 communicates data from an EMS 140.

In FIG. 12, the EMS 140 and an external apparatus 160 connect to the device non-dependent application unit 130 via the middleware unit 120. However, the EMS 140 and the external apparatus 160 need not necessarily connect to the device non-dependent application unit 130 via the middleware unit 120. The EMS 140 and the external apparatus 160 may appropriately connect to the middleware unit 120 when necessary, or directly connect to the device non-dependent application unit 130. Further, although the expression “connect via the middleware unit 120” is used, the expression is an expression from the perspective of the device non-dependent application unit 130. In actuality, device non-dependent applications are connected with each other via the middleware unit 120 after connection with the hardware.

Regarding description common to the extended function units 131-1 to 131-3, apart of the reference signs is omitted, and the term “extended function unit 131” is hereinafter used. The EMS 140 is, for example, an OpS or the like.

Note that the device non-dependent application unit 130 need not include any one of the extended function unit 131, the basic function unit 132, and the management and control agent unit 133, the management and control agent unit 133 may be included in the basic function unit 132, the management and control agent unit 133 may be included in the basic function unit 132 and the middleware unit 120.

The device non-dependent application unit 130 may further include a configuration other than the extended function unit 131, the basic function unit 132, and the management and control agent unit 133. For example, if the extended function unit 131 is unnecessary, the device non-dependent application unit 130 need not include the extended function unit 131. The device non-dependent application unit 130 may include one or more extended function units 131.

It is preferable that the extended function unit 131 be able to be independently added, deleted, replaced, or changed without giving unnecessary influence to other functions. For example, the extended function unit 131 may be added, deleted, replaced, or changed as appropriate when, for example, the extended function unit 131 that executes a multicast service and power saving operation is needed to meet a requirement on the service.

The basic function unit 132 may be included in the device non-dependent application unit 130 as a part of the extended function unit 131, or may be substituted by a function unit of a lower level than the middleware unit 120. If the extended function unit 131 includes the basic function unit 132, the device non-dependent application unit 130 need not include the basic function unit 132. If the function unit of a lower level than the middleware unit 120 substitutes the basic function unit 132, the device non-dependent application unit 130 need not include the basic function unit 132. If the extended function unit 131 includes the basic function unit 132 and the function unit of a lower level than the middleware unit 120 substitutes the basic function unit 132, the device non-dependent application unit 130 need not include the basic function unit 132.

If the management and control agent unit 133 is automatically configured according to predetermined configuration without receiving communication from the EMS 140, the management and control agent unit 133 need not input and output to and from the EMS 140. Further, if the management and control agent unit 133 does not include a management configuration function and other device non-dependent application unit 130, basic function unit 132, and device dependent unit 110 include a management configuration function, the device non-dependent application unit 130 need not include the management and control agent unit 133.

The EMS 140 and the device non-dependent application unit 130 may directly input and output information to and from each other. The device dependent unit 110 may be substituted by the NE management and control unit 115 and the device dependent application unit 150 being a lower-level function unit of the NE management and control unit 115 (see FIG. 13 to be described later).

If the management and control agent unit 133 is automatically configured according to predetermined configuration, the management and control agent unit 133 need not input and output information to and from the EMS 140. Further, if the management and control agent unit 133 does not include a management configuration function and other device non-dependent application unit 130, basic function unit 132, and device dependent unit 110 include a management configuration function, the device non-dependent application unit 130 need not include the management and control agent unit 133. The EMS 140 and the device non-dependent application unit 130 may directly input and output information to and from each other.

The device dependent application unit 150 may input and output information via the middleware unit 120, may directly input and output information from the management and control agent unit 133, may input and output information to and from either one of the both, or may directly input and output to and from the EMS 140. If the device dependent application unit 150 does not receive communication from the EMS 140 and is automatically configured according to predetermined configuration, and management and control information can be acquired from the EMS 140 via the middleware unit 120, the device non-dependent application unit 130 need not include the management and control agent unit 133.

The device non-dependent application unit 130 inputs and outputs information to and from at least the hardware unit 111 (PHY) and the hardware unit 112 (MAC) or to and from the software unit 113 of the device dependent unit 110 via the middleware unit 120. The device non-dependent application units 130 input and output to and from each other via the middleware unit 120 as necessary. In particular, when the device non-dependent application unit 130 executes control or management according to information input and output to and from the EMS 140, the device non-dependent application unit 130 inputs and outputs information to and from the management and control agent unit 133 that receives communication from the EMS 140.

Examples of input and output between the device non-dependent application unit 130 and the device dependent unit 110 are as described below.

For example, a DBA application unit and a protection application unit input and output information to and from an embedded OAM engine of the TC layer. A dynamic wavelength and bandwidth assignment (DWBA) application and an ONU registration authentication application unit input and output information to and from a PLOAM engine of the TC layer. A power saving application unit inputs and outputs information to and from an OMCI and an L2 main signal processing function unit (layer 2 function (L2 function) unit). A multicast listener discover (MLD) proxy application unit inputs and outputs information to and from the L2 function unit. A low-speed monitor application (OMCI) inputs and outputs information to and from the OMCI. The OMCI and the L2 function unit activate an XG PON encapsulation method framer (XGEM framer) and encryption. Here, the DWBA and the DBA may be separate, integral, or a combination. For example, the management and control agent unit 133 is an application unit for a maintenance and operation function, and inputs and outputs information to and from the EMS 140 being an OpS or the like for the NE management and control unit 115.

Note that implementation of the device non-dependent application unit 130 may be assigned by order of priority. For example, the management and control agent unit 133 is assigned the first order of priority that is most prioritized. The second or lower order of priority is ordered, for example, the DBA application, the DWBA application, the power saving application, the ONU registration authentication application, the MLD proxy application, the protection application, and the low-speed monitor application (OMCI).

As an application of the extended function unit 131, an application for driving a function included in a part of a vendor, a scheme, a type, and a generation, or an application that drives a function included only in an apparatus of a part of a vendor, a scheme, a type, and a generation via the device non-dependent APIs 21 may be included.

The management and control agent unit 133 inputs and outputs to and from the EMS 140 and the middleware unit 120. The middleware unit 120 inputs and outputs NE management information and control information to and from the NE management and control unit 115.

The NE management and control unit 115 may directly send and receive NE management information and control information to and from the EMS 140 without using the middleware unit 120, or may send and receive NE management information and control information via the management and control agent unit 133.

The device dependent application unit 150 inputs and outputs NE management information and control information to and from the management and control agent unit 133. The device dependent application unit 150 may directly input and output information to and from the EMS 140 without using the management and control agent unit 133. The management and control agent unit 133 inputs and outputs information to and from the EMS 140, the middleware unit 120, and the device dependent application unit 150. The middleware unit 120 inputs and outputs NE management information and control information to and from the NE management and control unit 115.

The middleware unit 120 inputs and outputs information to and from the device non-dependent application unit 130 via the device non-dependent APIs 21. The middleware unit 120 inputs and outputs information to and from the OAM unit 114, the driver, the firmware, the hardware unit 111 (PHY), or the hardware unit 112 (MAC) of the device dependent unit 110 via the device dependent API 23. The middleware unit 120 outputs input information directly or in a predetermined format. For example, if an output destination is each unit of the device non-dependent application unit 130, the middleware unit 120 converts information to an input format of each unit of the device non-dependent APIs 21. If an output destination is the OAM unit 114, the driver, the firmware, the hardware unit 111 (PHY), or the hardware unit 112 (MAC) of the device dependent unit 110, the middleware unit 120 converts to formats of the device dependent APIs 23 of respective input formats or terminates and performs predetermined processing, and then sends information to the output destination.

It is desirable that, at the time of input, the middleware unit 120 delete input information unnecessary for respective input destinations, and if there is deficient information, collect and supplement via other device non-dependent APIs 21 and device dependent APIs 23. At the time of input to the middleware unit 120, broadcasting to a relevant application or the like may be performed by means of broadcast or multicast.

FIG. 12 exemplifies a single middleware unit 120 and a single device dependent unit 110. However, a plurality of middleware units 120 and a plurality of device dependent units 110 may be configured. If hardware of the device dependent unit 110 includes a plurality of processors, the middleware unit 120 may input and output by using inter-processor communication or the like across the processors or the hardware. An entity between the device non-dependent application units 130 or the device non-dependent application unit 130 may be deployed in user space of a single processor as an execution program such as a dynamic link library (DLL), or may be deployed in user spaces of a plurality of processors.

The device non-dependent application unit 130 may be deployed in kernel space with an input/output IF such as an API being secured, or may be deployed together with the middleware unit 120 having an IF that can be independently replaced with firmware or the like, or may be recompiled through embedding into firmware or the like. The user space and the kernel space may be freely combined for each individual device non-dependent application unit 130.

The device non-dependent application unit 130 that supports the same function may be able to be implemented in both the user space and the kernel space. In this case, for example, either of them may be selected by switching, processing may be performed by both of them operating in cooperation, or actual processing may be performed by only one of them. The same applies for software of the device dependent unit 110.

Desirably, the more high-speed processing is required as in the main signal processing, the DBA processing, and the low-layer signal processing, the more there is a trade-off with immediacy of extensibility and replacement. However, embedding into the kernel space or the firmware that is expected to perform high-speed processing with small overhead is desirable. In terms of restriction of a bus, speed, or the like due to inter-processor communication and influence over another program due to occupancy of a communication path or the like, it is desirable that a processor deploying the device dependent application unit 150 (see FIG. 13 to be described later) be also deployed in the user space, the kernel space, or the firmware of a processor that performs actual processing or its neighboring processor. Note that, to reduce capacity of the processor that performs actual processing or its neighboring processor, processing may be performed by a remote processor, although communication costs due to inter-processor communication are increased.

It is desirable that the device non-dependent APIs 21 be provided in advance in the middleware unit 120, in consideration of an extended function unit 131 to be added. However, the device non-dependent APIs 21 may be added or deleted as necessary so as to reduce modification of the device dependent APIs 23 and other device non-dependent application units 130.

Note that, in this example, a software-converted area is set to the basic function unit 132, the management and control agent unit 133, the extended function unit 131, and the middleware unit 120. However, the software-converted area may also be set to service adaptation (encryption, fragment processing, GEM framing/XGEM framing, FEC of the PHY adaptation, scrambling, synchronized block generation/extraction, GPON transmission convergences (GTC) framing, PHY framing, SP conversion, and a coding method. Implementation examples of software functions of architecture and examples of function deployment corresponding to the hardware unit will be described. The function deployment includes, for example, software functions in a network device or an external server. The same applies for other examples.

If the device dependent application unit 150 is unnecessary, the device dependent application unit 150 and the device dependent APIs 24 and API 26 need not be included. This configuration is referred to as the second example of architecture.

Omitting the device dependent application unit 150 complicates the middleware unit 120.

Third Example of Architecture

FIG. 13 is a diagram illustrating the third example of architecture of the communication apparatus. In FIG. 13, instead of the middleware unit 120 described in the first example of architecture illustrated in FIG. 12, the basic function unit 132 inputs and outputs to and from the hardware unit 111 (PHY), the hardware unit 112 (MAC), and the extended function unit 131. Other configuration such as the device non-dependent application unit 130 and the device dependent application unit 150 is similar to that of the first example of architecture.

Note that, in FIG. 13, the EMS 140 and the external apparatus 160 connect to the device non-dependent application unit 130 via the basic function unit 132. However, the EMS 140 and the external apparatus 160 need not necessarily connect to the device non-dependent application unit 130 via the basic function unit 132. The EMS 140 and the external apparatus 160 may appropriately connect to the middleware unit 120 when necessary, or directly connect to the device non-dependent application unit 130. Further, although the expression “connect via the middleware unit 120” is used, the expression is an expression from the perspective of the device non-dependent application unit 130. In actuality, device non-dependent applications are connected with each other via the middleware unit 120 after connection with the hardware.

In comparison with the first example of architecture, in the third example, the middleware unit 120 including the device dependent APIs 23 and 25 need not be created for each device that has at least one of a conformance standard, a generation, a scheme, a system, a device type, and a manufacturer/vendor being different. This produces an effect that, in the communication apparatus of the third example of architecture, a larger number of functions can be generalized and easily ported between devices and generations, testing of connectivity is facilitated, and functions of the device become robust.

The communication apparatus according to the third example of architecture includes a device dependent unit 110 and a device non-dependent application unit 130. The device dependent unit 110 includes a hardware unit 111 (PHY) and a hardware unit 112 (MAC) that are dependent on a conformance standard, a device manufacturer/vendor, or the like, a software unit 113 such as a driver that drives the hardware unit 111 (PHY) and the hardware unit 112 (MAC) or firmware, and a device dependent application unit 150 that drives at least a part of the device dependent unit 110. The driver or the like reconciles a difference of the device dependent unit 110.

The device non-dependent application unit 130 is a general-purpose device non-dependent application that executes processing that is not dependent on the device, and includes extended function units 131 and a basic function unit 132. The basic function unit 132 connects to the device dependent unit 110 via the driver that reconciles a difference between the hardware unit 111 (PHY) and the hardware unit 112 (MAC) and the device dependent software unit 113, via device non-dependent APIs 27 (port IFs), or via the device dependent application unit 150, and inputs and outputs data to and from the hardware unit 111 (PHY), the hardware unit 112 (MAC), and the device dependent software unit 113 of the device dependent unit 110.

The basic function unit 132 and the extended function unit 131 in the device non-dependent application unit 130 are connected via device non-dependent APIs 22 (extension IFs). The basic function unit 132 and the device dependent unit 110 are connected via device non-dependent APIs 27. Instead of the middleware unit 120, the basic function unit 132 in the device non-dependent application unit 130 inputs and outputs information to and from the hardware unit 111 (PHY), the hardware unit 112 (MAC), and the extended function unit 131. The basic function unit 132 and the device dependent application unit 150 in the device dependent unit 110 are connected via the device non-dependent APIs 27. The device dependent application unit 150 and other function units of the device dependent unit 110 are connected via a device dependent API 24. Regarding the basic function unit 132, instead of the middleware unit 120, the basic function unit 132 inputs and outputs to and from hardware and the extended function unit 131. The basic function unit 132 may include an entity corresponding to the management and control agent unit 133 (see FIG. 12) that receives communication from the EMS 140, or may include the management and control agent unit 133 as the extended function unit 131.

The device non-dependent application units 130 input and output to and from each other via the basic function unit 132 as necessary. The extended function unit 131 of the device non-dependent application unit 130 inputs and outputs information via the basic function unit 132 and the device non-dependent APIs 22 (extension IFs). The basic function unit 132 inputs and outputs information via the extended function unit 131 and the device non-dependent APIs 22, and inputs and outputs information to and from the OAM unit, the driver, the firmware the hardware unit 111 (PHY), and the hardware unit 112 (MAC) of the device dependent unit 110 via the driver of the device dependent unit 110 that reconciles a difference of the device non-dependent APIs 22 (port IFs) and the device dependent unit 110 or the device dependent application unit 150 and the device non-dependent APIs 27.

The basic function unit 132 inputs information directly or in a predetermined format, in a similar manner to the middleware unit 120 illustrated in FIG. 12. For example, with another device non-dependent application unit 130, the basic function unit 132 converts to respective formats of the device non-dependent APIs 22 of input formats, and with the device dependent OAM unit, the driver, the firmware, and the hardware unit, the basic function unit 132 converts to respective formats of the device non-dependent APIs 22 of input formats or terminates and performs predetermined processing, and then inputs information. It is desirable that, at the time of input, the basic function unit 132 delete input information unnecessary for respective input destinations, and if there is deficient information, collect and supplement via other device non-dependent APIs 22 and device non-dependent APIs 27. However, the basic function unit 132 may broadcast input to input destinations to a relevant application or the like by means of broadcast or multicast.

The device non-dependent application unit 130 includes, for example, extended function units 131-1 to 131-3 and a basic function unit 132. The device non-dependent application unit 130 need not include either the extended function unit 131 or the basic function unit 132. The device non-dependent application unit 130 may further include function units other than the extended function unit 131 and the basic function unit 132. For example, if the extended function unit 131 is unnecessary, the device non-dependent application unit 130 need not include the extended function unit 131.

It is preferable that the extended function unit 131 be able to be independently added or deleted without affecting other functions. For example, provided that the extended function unit 131 handles a multicast service and power saving operation to meet a requirement on the service, the extended function unit 131 may be added as appropriate when the extended function unit 131 is needed, may be deleted as appropriate when the function unit 131 is not needed, or may be replaced or changed according to a change.

A part of the basic function unit 132 may be substituted by the device dependent application unit 150. The device dependent application unit 150 directly inputs and outputs information from the basic function unit 132. However, the device dependent application unit 150 may input and output information to and from the EMS 140 without using the basic function unit 132 directly or after predetermined conversion.

In a similar manner to the first example of architecture illustrated in FIG. 12, it is desirable that the device non-dependent APIs 22 and 27 be provided in advance in the basic function unit 132, in consideration of an extended function unit 131 to be added later. However, as necessary, the device non-dependent APIs 22 and 27 may be added or deleted so as to reduce modification of the device non-dependent APIs 22, the device non-dependent APIs 27, other device non-dependent application unit 130, the device dependent application unit 150, or the device dependent API 24. If the device dependent application unit 150 is unnecessary, the device dependent application unit 150 and the device dependent API 24 need not be included. This configuration is referred to as the fourth example of architecture. Omitting the device dependent application unit 150 complicates the basic function unit 132.

Fifth Example of Architecture

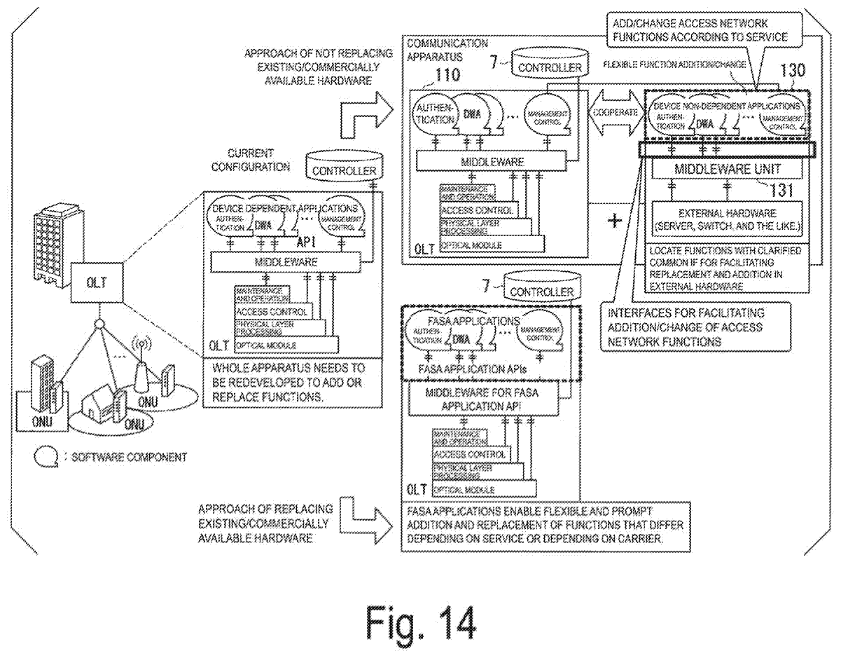

The upper right diagram of FIG. 14 is a diagram illustrating the fifth example of architecture. The lower right diagram of FIG. 14 corresponds to the first to fourth examples of architecture. The figure illustrates a case where the communication apparatus is an OLT. The fifth example of architecture is preferable for a case of approaching cloud migration of functions that prepares function addition/change according to a service by implementing functions of the OLT in an external hardware (cloud migration) and utilizing existing/commercially available OLT hardware.

In this example, the communication apparatus includes existing/commercially available hardware and external hardware. For example, the existing/commercially available hardware is a non-general-purpose device dependent unit 110 that is dependent on the device, and includes a middleware unit 121 that reconciles a difference of hardware and software in the external hardware and a general-purpose device non-dependent application unit 130 whose operation is not dependent on the device. Thus, device dependent units (vendor dependent units) of the middleware or lower in the figure are function units that are dependent on a conformance standard of the device of the communication apparatus or a manufacturer/vendor of the device. In a similar manner to the first example of architecture, the device non-dependent application unit 130 is a function unit that is not dependent on a conformance standard of the device of the communication apparatus or a manufacturer/vendor of the device.

The middleware unit 121 and the device non-dependent application unit 130 are connected via a device non-dependent API being an input/output IF that is not dependent on the device. For example, the software unit, the OAM, the hardware unit (PHY), and the hardware unit (MAC) of the device dependent unit 110 and the middleware unit 121 in the external hardware are connected via a device dependent API being an input/output IF that is dependent on the device and inter-device connection between the existing/commercially available hardware and the external hardware.

In a similar manner to the first example of architecture, this architecture allows the device non-dependent application unit 130 to facilitate flexible and prompt addition of an extended function unit (proprietary function unit), thus timely providing a communication service. Here, the device dependent unit 110 may be maintenance and operation, access control, physical layer processing, or an optical module illustrated in FIG. 14, which depends on a configuration of the device itself.

At least one of the middleware unit 121, the driver of the device dependent unit 110, and the device dependent application unit 150 (vendor dependent application unit) may further include a conversion function unit that converts an IF, a parameter, or the like so as to be compatible with the device dependent unit 110, or a function unit that is automatically configured according to a deficient IF, parameter, or the like.

The device dependent unit 110 includes a hardware unit and a software unit. The software unit executes a device dependent driver, firmware, and an application, for example.

The device dependent unit 110 need not include apart of a PMD that connects to a physical medium, a MAC, a PMA that serializes data, a PCS being a part that codes data, and a PHY. For example, only an optical function may be included without including lower-level signal processing such as modulating and demodulating signal processing, FEC, coding and decoding processing, and encrypting processing.

The device non-dependent application unit 130 is, for example, a management and control agent unit 133 that acquires data from the EMS, extended function units 131-1 to 131-3, and a basic function unit 132.

Regarding description common to the extended function units 131-1 to 131-3, a part of the reference signs is omitted, and the term “extended function unit 131” is hereinafter used. Note that the device non-dependent application unit 130 need not include any one of the management and control agent unit 133, the extended function unit 131, and the basic function unit 132.

The device non-dependent application unit 130 may further include a configuration other than the management and control agent unit 133, the extended function unit 131, and the basic function unit 132. For example, if the extended function unit 131 is unnecessary, the device non-dependent application unit 130 need not include the extended function unit 131.

The device non-dependent application unit 130 may include one or more extended function units 131.

It is preferable that the extended function unit 131 be able to be independently added, deleted, replaced, or changed without giving unnecessary influence to other functions. For example, the extended function unit 131 may be added, deleted, replaced, or changed as appropriate when, for example, the extended function unit 131 that executes a multicast service and power saving operation is needed to meet a requirement on the service.

The basic function unit 132 may be included in the device non-dependent application unit 130 as a part of the extended function unit 131, or may be substituted by a function unit of a lower level than the middleware unit 121. If the extended function unit 131 includes the basic function unit 132, the device non-dependent application unit 130 need not include the basic function unit 132. If the function unit of a lower level than the middleware unit 121 substitutes the basic function unit 132, the device non-dependent application unit 130 need not include the basic function unit 132. If the extended function unit 131 includes the basic function unit 132 and the function unit of a lower level than the middleware unit 120 substitutes the basic function unit 132, the device non-dependent application unit 130 need not include the basic function unit 132.

The management and control agent unit 133 need not input and output to and from the EMS 140 if the management and control agent unit 133 is automatically configured according to predetermined configuration without receiving communication from the EMS 140. Further, if the management and control agent unit 133 does not include a management configuration function and other device non-dependent application unit 130, basic function unit 132, and device dependent unit 110 include a management configuration function, the device non-dependent application unit 130 need not include the management and control agent unit 133.

The EMS 140 and the device non-dependent application unit 130 may directly input and output information to and from each other. The device dependent unit 110 need not include the NE management and control unit 115 and the IF of the NE management and control unit 115.

The basic function unit 132 may be included in the device non-dependent application unit 130 as a part of the extended function unit 131, or may be substituted by a function unit of a lower level than the middleware unit 120. If the extended function unit 131 includes the basic function unit 132, the function unit of a lower level than the middleware unit 120 substitutes the basic function unit 132, or a combination of those is adopted, the device non-dependent application unit 130 need not include the basic function unit 132. A part of the basic function unit 132 may be substituted by the device dependent application unit 150 being a lower-level function unit of the middleware unit 120.

The management and control agent unit 133 need not input and output information to and from the EMS 140 if the management and control agent unit 133 is automatically configured according to predetermined configuration. Further, if the management and control agent unit 133 does not include a management configuration function and other device non-dependent application unit 130, basic function unit 132, and device dependent unit 110 include a management configuration function, the device non-dependent application unit 130 need not include the management and control agent unit 133. The EMS 140 and the device non-dependent application unit 130 may directly input and output information to and from each other.

As an application of the extended function unit 131, an application for driving a function included in a part of a vendor, a scheme, a type, and a generation, or an application that drives a function included only in an apparatus of a part of a vendor, a scheme, a type, and a generation via the device non-dependent APIs 21 may be included.

The management and control agent unit 133 inputs and outputs to and from the EMS 140 and the middleware unit 120. The middleware unit 120 inputs and outputs NE management information and control information to and from the NE management and control unit 115. The NE management and control unit 115 may directly send and receive NE management information and control information to and from the EMS 140 without using the middleware unit 120, or may send and receive NE management information and control information via the management and control agent unit 133.

The middleware unit 120 inputs and outputs information to and from the device non-dependent application unit 130 via the device non-dependent APIs 21. The middleware unit 120 inputs and outputs information to and from the OAM unit 114, the driver, the firmware, the hardware unit 111 (PHY), or the hardware unit 112 (MAC) of the device dependent unit 110 via the device dependent APIs 23. The middleware unit 120 outputs input information directly or in a predetermined format. For example, if an output destination is each unit of the device non-dependent application unit 130, the middleware unit 120 converts information to an input format of each unit of the device non-dependent APIs 21. If an output destination is the OAM unit 114, the driver, the firmware, the hardware unit 111 (PHY), or the hardware unit 112 (MAC) of the device dependent unit 110, the middleware unit 120 converts to formats of the device dependent APIs 23 of respective input formats or terminates and performs predetermined processing, and then sends information to the output destination.

It is desirable that, at the time of input, the middleware unit 120 delete input information unnecessary for respective input destinations, and if there is deficient information, collect and supplement via other device non-dependent APIs 21 and device dependent APIs 23. At the time of input to the middleware unit 120, broadcasting to a relevant application or the like may be performed by means of broadcast or multicast.

The above description exemplifies a single middleware unit 120 and a single device dependent unit 110. However, a plurality of middleware units 120 and a plurality of device dependent units 110 may be configured. If hardware of the device dependent unit 110 includes a plurality of processors, the middleware unit 120 may input and output by using inter-processor communication or the like across the processors or the hardware. An entity between the device non-dependent application units 130 or the device non-dependent application unit 130 may be deployed in user space of a single processor as an execution program such as a DLL, or may be deployed in user spaces of a plurality of processors.

The device non-dependent application unit 130 may be deployed in kernel space with an input/output IF such as an API being secured, or may be deployed together with the middleware unit 120 having an IF that can be independently replaced with firmware or the like, or may be recompiled through embedding into firmware or the like. The user space and the kernel space may be freely combined for each individual device non-dependent application unit 130.

The device non-dependent application unit 130 that supports the same function may be able to be implemented in both the user space and the kernel space. In this case, for example, either of them may be selected by switching, processing may be performed by both of them operating in cooperation, or actual processing may be performed by only one of them. The same applies for software of the device dependent unit 110.

Desirably, the more high-speed processing is required as in the main signal processing, the DBA processing, and the low-layer signal processing, the more there is a trade-off with immediacy of extensibility and replacement. However, embedding into the kernel space or the firmware that is expected to perform high-speed processing with small overhead is desirable. In terms of restriction of a bus, speed, or the like due to inter-processor communication and influence over another program due to occupancy of a communication path or the like, it is desirable that a processor deploying the device dependent application unit 150 be also deployed in the user space, the kernel space, or the firmware of a processor that performs actual processing or its neighboring processor. Note that, to reduce capacity of the processor that performs actual processing or its neighboring processor, processing may be performed by a remote processor, although communication costs due to inter-processor communication are increased.

It is desirable that the device non-dependent APIs 21 be provided in advance in the middleware unit 120, in consideration of an extended function unit 131 to be added. However, the device non-dependent APIs 21 may be added or deleted as necessary so as to reduce modification of the device dependent APIs 23 and other device non-dependent application units 130.

Other configuration is similar to that of the first example of architecture.

Sixth Example of Architecture

The sixth example of architecture includes a hardware unit 111 (PHY) and a hardware unit 112 (MAC) that are dependent on a conformance standard or a device manufacturer/vendor as a device dependent unit 110, a software unit 113 such as a driver that drives the hardware unit 111 (PHY) and the hardware unit 112 (MAC) or firmware, and a device dependent application unit 150 that drives at least a part of the device dependent unit 110.

The device dependent application unit 150 and the device dependent unit 110 are connected via device dependent APIs 24. The device dependent application unit 150 may include an entity corresponding to the management and control agent unit 133 that receives communication from the EMS 140. The device dependent APIs 24 may be added or deleted as necessary so as to reduce modification of the device dependent application unit 150 and the device dependent APIs 24.

Note that the configuration of the communication apparatus illustrated in the first example to the sixth example of architecture of the communication apparatus is described supposing an OLT of a PON conforming to ITU-T recommendations such as a TWDM-PON. However, the configuration may be an ONU, may be either an OLT or an ONU of a PON conforming to ITU-T recommendations other than a TWDM-PON, and may be a PON conforming to IEEE standards such as a GE-PON and a 10G E-PON, and the same applies if the TC layer or the PMD layer is interpreted as their corresponding layers.

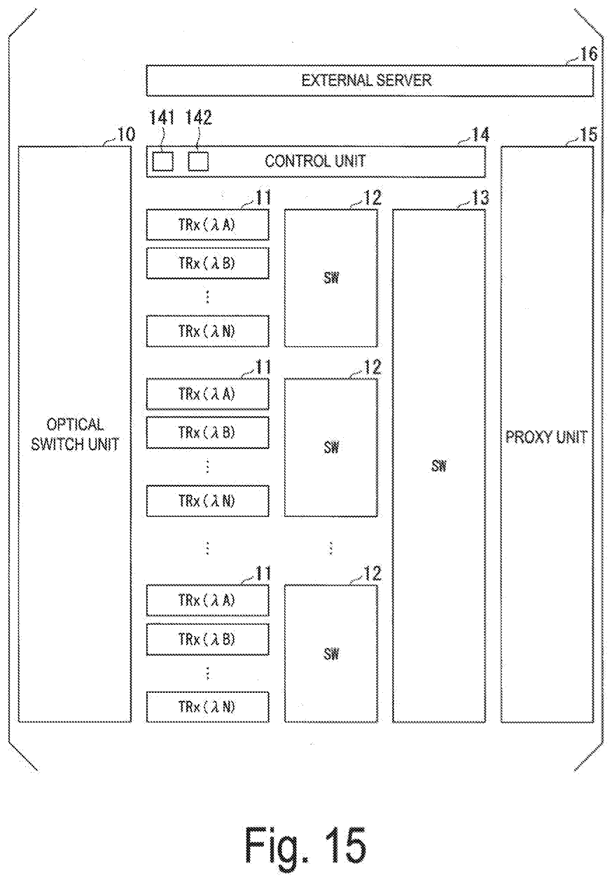

FIG. 15 is a diagram illustrating an example of a configuration of a virtual communication apparatus or communication system including a group of components or apparatuses. The communication apparatus illustrated in FIG. 15 includes at least a part of an optical switch unit (optical SW) 10 that switches input and output of sending and receiving units (transceivers (TRxs)) 11 of mainly the same wavelength (in the example described later, this may be the same frequency, mode, core, code, frequency, (sub-)carrier or the like, or a combination of those including a wavelength), TRxs 11, switch units (SWs) 12, a switch unit (SW) 13, a control unit 14, and a proxy unit 15. Note that the communication apparatus may include an external server 16.

FIG. 15 illustrates a configuration in which the TRxs 11 that send and receive (communicate) optical signals of different wavelengths (λA to λN) are connected to the same SW 12, but Embodiment 1-1 is not limited to this configuration. For example, in addition to the configuration in which the TRxs 11 that send and receive optical signals of different wavelengths (λA to λN) are connected to the same SW 12, the TRxs 11 that send and receive optical signals of the same wavelength may be connected to the same SW 12, a plurality of TRxs 11 of at least a part of wavelengths may be connected to the same SW 12, TRxs 11 of at least a part of wavelengths may have a variable wavelength, or a part or all of the TRxs 11 may be TRxs 11 that perform only sending or only reception.

The communication apparatus such as an OLT may include the TRxs 11 to the control unit 14, or may further include an external server 16 in addition to these. The OSU may be a TRx 11, or may include the SW 12 or the SW 13 in addition to this.

The communication apparatus may be a virtual apparatus including an EMS. As a configuration of adding a component to the EMS, a configuration such as the Open Network Operating System (ONOS) may be used. A component may be added to the EMS, a component may be added to a virtual OLT of the EMS, or a component may be added in parallel with a virtual OLT of the EMS.

The communication system of communication system configuration (1-1) includes an optical SW 10, TRxs 11, SWs 12, an SW 13, a control unit 14, a proxy unit 15, and an external server 16 (FIG. 15).

If the communication apparatus is an OLT, the OLT may include an optical SW 10, TRxs 11, SWs 12, an SW 13, and a control unit 14, or may include an optical SW 10, TRxs 11, SWs 12, an SW 13, a control unit 14, and an external server 16. The OSU may include an optical SW 10 and TRxs 11, may include an optical SW 10, TRxs 11, and SWs 12, or may include an optical SW 10, TRxs 11, and an SW 13.

The optical SW 10 is connected to an ODN and TRxs 11. The optical SW 10 performs autonomous control, is controlled by another constituent element included in the apparatus, an external OpS or the like (not illustrated), a controller (not illustrated), an external apparatus (not illustrated), or the like (the external OpS or the like (not illustrated), the controller (not illustrated), the external apparatus (not illustrated), or the like is hereinafter referred to as an “external apparatus or the like”), or is controlled by a command transferred via another constituent element included in the apparatus or an external apparatus or the like.

The optical SW 10 may switch input and output of the TRxs 11 of the same wavelength (in examples to be described later, this may be the same frequency, mode, core, code, frequency (sub-)carrier or the like, or a combination of those including a wavelength; the same applies in the following examples) including input and output of the TRxs 11 of a variable wavelength to a different corewire (in examples to be described later, this may be a different mode, core or the like, or a combination of those including a core wire; the same applies in the following examples) or a multiplexer/demultiplexer or the like connected to those, may switch input and output of TRxs 11 of a plurality of wavelengths (in examples to be described later, these may be a plurality of frequencies, modes, cores, codes, frequencies, (sub-)carriers or the like, or a combination of those including a wavelength; the same applies in the following examples) including a variable wavelength or a bundle of those bundled by a multiplexer/demultiplexer or the like to a different core wire, or bundle input and output of TRxs 11 of a wavelength (in examples to be described later, this may be a frequency, a mode, a core, a code, a frequency, a (sub-)carrier or the like, or a combination of those including a wavelength; the same applies in the following examples) including a variable wavelength and switch to a different core wire or a multiplexer/demultiplexer or the like connected to those.

The optical SW 10 performs autonomous control, is controlled by another constituent element included in the apparatus such as the TRx 11, the SW 12, the SW 13, the control unit 14, the proxy unit 15, or the external server 16, the external apparatus or the like, or is controlled by a command transferred via another constituent element included in the apparatus such as the TRx 11, the SW 12, the SW 13, the control unit 14, the proxy unit 15, or the external server 16, the external apparatus or the like.

The TRxs 11 that send and receive optical signals of different wavelengths (λA to λN) are connected to the SWs 12.

The TRx 11 performs autonomous control, is controlled by another constituent element included in the apparatus such as the optical SW 10, the SW 12, the SW 13, the control unit 14, the proxy unit 15, or the external server 16, the external apparatus or the like, or is controlled by a command transferred via another constituent element included in the apparatus such as the optical SW 10, the SW 12, the SW 13, the control unit 14, the proxy unit 15, or the external server 16, the external apparatus or the like. The TRx 11 adds, deletes, or replaces a tag of at least a part or a combination of a virtual local area network (VLAN), priority, discard priority, or a destination and the like regarding a part or all of traffic of the optical SW 10 or the SW 12 according to a predetermined procedure, or performs processing of at least one or a combination of aggregation, allocation, distribution, duplication, returning, and transmission without changing tags.

Note that aggregation is not necessarily performed regarding uplink traffic as well. In the configuration of communication system configuration (1-1), the SW 12 mainly performs distribution for each wavelength, but may perform aggregation, allocation, duplication, returning, transmission, and tag attachment or tag replacement of a tag or the like that represents a virtual LAN identifier (VID) or priority discard. In the configuration of communication system configuration (1-2) to be described later, uplink traffic mainly performs aggregation, but may perform allocation, distribution, duplication, returning, transmission, tag attachment, or tag replacement.

Downlink traffic may also perform any of aggregation, allocation, distribution, duplication, returning, transmission, tag attachment, and tag replacement, or may perform a combination of at least a part thereof. Which of those is performed is determined according to a service policy. The same applies for the following configurations of the communication system.

The SWs 12 are connected to the SW 13. The SW 12 performs autonomous control, is controlled by another constituent element included in the apparatus such as the optical SW 10, the TRx 11, the SW 13, the control unit 14, the proxy unit 15, or the external server 16, the external apparatus or the like, or is controlled by a command transferred via another constituent element included in the apparatus such as the optical SW 10, the TRx 11, the SW 13, the control unit 14, the proxy unit 15, or the external server 16, the external apparatus or the like. The SW 12 adds, deletes, or replaces a tag of at least a part or a combination of a VLAN, priority, discard priority, or a destination and the like regarding a part or all of traffic of the TRx 11 or the SW 13 according to a predetermined procedure, or performs processing of at least a part or a combination of aggregation, allocation, distribution, duplication, returning, transmission, tag attachment, and tag replacement without changing tags. The same applies for the following configurations of the communication system.

Note that the SWs 12 are not necessarily controlled. At least one from the TRxs 11 to the proxy unit 15 may be controlled, or control information may be transferred to at least one from the TRxs 11 to the proxy unit 15 without being controlled. Examples of a transfer source include the proxy unit 15 and the external server 16. The TRxs 11 to the proxy unit 15 may autonomously operate. The same applies for the following configurations of the communication system.

The SW 13 is connected to the proxy unit 15 directly or via a line concentration SW or the like. The line concentration SW performs at least a part of aggregation, allocation, distribution, duplication, returning, and transmission in traffic from a plurality of OLTs or to OLTs. The SW 13 performs autonomous control, is controlled by another constituent element included in the apparatus such as the optical SW 10, the TRx 11, the SW 12, the control unit 14, the proxy unit 15, or the external server 16, the external apparatus or the like, or is controlled by a command transferred via another constituent element included in the apparatus such as the optical SW 10, the TRx 11, the SW 12, the control unit 14, the proxy unit 15, or the external server 16, the external apparatus or the like. The SW 13 adds, deletes, or replaces a tag of at least a part or a combination of a VLAN, priority, discard priority, or a destination and the like regarding a part or all of traffic of the SW 12 or the proxy unit 15 according to a predetermined procedure, or performs processing of at least a part or a combination of aggregation, allocation, distribution, duplication, returning, and transmission without changing tags.

The control unit 14 is connected to another constituent element included in the apparatus such as the optical SW 10, the TRx 11, the SW 12, the SW 13, the proxy unit 15, or the external server 16, the external apparatus or the like. The control unit 14 controls a constituent element included in the apparatus such as the optical SW 10, the TRx 11, the SW 12, the SW 13, the proxy unit 15, or the external server 16, the external apparatus or the like, or transfers a command via the constituent element included in the apparatus such as the optical SW 10, the TRx 11, the SW 12, the SW 13, the proxy unit 15, or the external server 16, the external apparatus or the like.

The proxy unit 15 illustrated in FIG. 15 may be deployed on a data path from the OLTs or to the OLTs. Note that, because another apparatus (for example, a line concentration SW or the like aggregated/allocated in traffic from a plurality of OLTs or to OLTs) may be interposed, directly connection is not necessarily be employed. As a flow of control, the proxy unit 15 may be present in any of the optical SW 10, the TRx 11, the SW 12, the SW 13, the control unit 14, and the external server 16.

The proxy unit 15 is connected to a higher-layer apparatus (not illustrated) directly or via a line concentration SW or the like. The proxy unit 15 performs autonomous control, is controlled by another constituent element included in the apparatus such as the optical SW 10, the TRx 11, the SW 12, the SW 13, the control unit 14, or the external server 16, the external apparatus or the like, or is controlled by a command transferred via another constituent element included in the apparatus such as the optical SW 10, the TRx 11, the SW 12, the SW 13, the control unit 14, or the external server 16, the external apparatus or the like. The proxy unit 15 adds, deletes, or replaces a tag of at least a part or a combination of a VLAN, priority, discard priority, or a destination and the like regarding a part or all of traffic of the SW 13 or the higher-layer apparatus (not illustrated) according to a predetermined procedure, or performs processing of at least a part or a combination of aggregation, allocation, distribution, duplication, returning, and transmission without changing tags.

The external server 16 is connected to the TRx 11, the SW 12, the SW 13, the control unit 14, the proxy unit 15, the external OpS or the like (not illustrated), the controller (not illustrated), or the external apparatus (not illustrated). The external server 16 controls another constituent element included in the apparatus such as the optical SW 10, the TRx 11, the SW 12, the SW 13, the control unit 14, or the proxy unit 15, the external apparatus or the like, or transfers a command via another constituent element included in the apparatus such as the optical SW 10, the TRx 11, the SW 12, the SW 13, the control unit 14, or the proxy unit 15, the external apparatus or the like.

The optical SW 10, the TRx 11, the SW 12, the SW 13, the control unit 14, the proxy unit 15, or the external server 16 and a constituent element included in the apparatus such as the optical SW 10, the TRx 11, the SW 12, the SW 13, the proxy unit 15, or the external server 16 may send at least a part of traffic of another constituent element included in the apparatus, at least a part of copies thereof, at least a part of traffic in which at least a part of those is rewritten, or at least a part of responses to those to another constituent element included in the apparatus such as the optical SW 10, the TRx 11, the SW 12, the SW 13, the proxy unit 15, or the external server 16, the external apparatus or the like.

Note that the element(s) need not be included as appropriate, and communication of such an omitted element is, for example, skipped and communication with a further element is performed. Communication may be performed between entities without elements.

In the communication system of communication system configuration (1-2), in comparison with the configuration of communication system configuration (1-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (2-1) includes an optical SW 10, TRxs 11, SWs 12, an SW 13, a control unit 14, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs processing to a part or all of traffic of the optical SW 10 or the SW 12 in a similar manner to communication system configuration (1-1). The TRx 11 performs autonomous control, is controlled by another constituent element included in the apparatus, the external apparatus or the like, or is controlled by a command transferred via another constituent element included in the apparatus, the external apparatus or the like.

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 or the proxy unit 15 in a similar manner to communication system configuration (1-1).

The control unit 14 is connected to the optical SW 10, the TRx 11, the SW 12, the SW 13, the proxy unit 15, the external apparatus or the like. The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The constituent element included in the apparatus may send at least apart of traffic of another constituent element included in the apparatus, at least a part of copies thereof, at least a part of traffic in which at least a part of those is rewritten, or at least a part of responses to those to another constituent element included in the apparatus, the external apparatus or the like.

In the communication system of communication system configuration (2-2), in comparison with the configuration of communication system configuration (2-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configurations are similar to the above.

The communication system of communication system configuration (3-1) includes an optical SW 10, TRxs 11, SWs 12, an SW 13, a control unit 14, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 in a similar manner to communication system configuration (1-1).

The control unit 14 is connected to the optical SW 10, the TRx 11, the SW 12, the SW 13, the external server 16, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The external server 16 is connected to the optical SW 10, the TRx 11, the SW 12, the SW 13, the control unit 14, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may send at least apart of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (3-2), in comparison with the configuration of communication system configuration (3-1). TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (4-1) includes an optical SW 10, TRxs 11, SWs 12, an SW 13, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the optical SW 10, the SW 12, or the proxy unit 15 in a similar manner to communication system configuration (1-1).

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The external server 16 is connected to the optical SW 10, the TRx 11, the SW 12, the SW 13, the proxy unit 15, the external apparatus or the like. The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (4-2), in comparison with the configuration of communication system configuration (4-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (5-1) includes an optical SW 10, TRxs 11, SWs 12, a control unit 14, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing similar to 1-1 to a part or all of traffic of the optical SW 10 or the SW 12.

The SW 12 is connected to the proxy unit 15 directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the proxy unit 15 in a similar manner to communication system configuration (1-1).

The control unit 14 is connected to the optical SW 10, the TRx 11, the SW 12, the proxy unit 15, the external server 16, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 12 or the higher-layer apparatus (not illustrated) in a similar manner to communication system configuration (1-1).

The external server 16 is connected to the optical SW 10, the TRx 11, the SW 12, the control unit 14, the proxy unit 15, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (5-2), in comparison with the configuration of communication system configuration (5-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (6-1) includes an optical SW 10, TRxs 11, an SW 13, a control unit 14, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The sending and receiving unit 11 (TRx) performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the proxy unit 15 in a similar manner to communication system configuration (1-1).

The control unit 14 is connected to the optical SW 10, the TRx 11, the SW 13, the proxy unit 15, the external server 16, or the external apparatus or the like. The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The external server 16 is connected to the optical SW 10, the TRx 11, the SW 13, the control unit 14, the proxy unit 15, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (6-2), in comparison with the configuration of communication system configuration (6-1), TRxs 11 that send and receive optical signals of the same wavelength instead of different wavelengths (λA to λA). TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (7-1) includes an optical SW 10, TRxs 11, SWs 12, an SW 13, and a control unit 14 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 or the higher-layer apparatus (not illustrated) in a similar manner to communication system configuration (1-1).

The control unit 14 is connected to the optical SW 10, the TRx 11, the SW 12, the SW 13, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (7-2), in comparison with the configuration of communication system configuration (7-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (8-1) includes an optical SW 10, TRxs 11, SWs 12, an SW 13, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 or the proxy unit 15 in a similar manner to communication system configuration (1-1).

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (8-2), in comparison with the configuration of communication system configuration (8-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (9-1) includes an optical SW 10, TRxs 11, SWs 12, a control unit 14, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to the proxy unit 15 directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the proxy unit 15 in a similar manner to communication system configuration (1-1).

The control unit 14 is connected to the optical SW 10, the TRx 11, the SW 12, the proxy unit 15, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 12 or the higher-layer apparatus (not illustrated) in a similar manner to communication system configuration (1-1).

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (9-2), in comparison with the configuration of communication system configuration (9-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (10-1) includes an optical SW 10, TRxs 11, an SW 13, a control unit 14, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the proxy unit 15 in a similar manner to communication system configuration (1-1).

The control unit 14 is connected to the optical SW 10, the TRx 11, the SW 13, the proxy unit 15, the external apparatus or the like. The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (10-2), in comparison with the configuration of communication system configuration (10-1), TRxs 11 that send and receive optical signals of the same wavelength instead of different wavelengths (λA to λA), TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (11-1) includes an optical SW 10, TRxs 11, SWs 12, an SW 13, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 or the higher-layer apparatus (not illustrated) in a similar manner to communication system configuration (1-1).

The external server 16 is connected to the optical SW 10, the TRx 11, the SW 12, the SW 13, the external OpS or the like (not illustrated), the controller (not illustrated), or the external apparatus (not illustrated). The external server 16 controls a constituent element included in the apparatus, the external apparatus or the like, or transfers a command via the constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (11-2), in comparison with the configuration of communication system configuration (11-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (12-1) includes an optical SW 10, TRxs 11, SWs 12, a control unit 14, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to a higher-layer apparatus (not illustrated) directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the higher-layer apparatus (not illustrated) in a similar manner to communication system configuration (1-1).

The control unit 14 is connected to the optical SW 10, the TRx 11, the SW 12, the external server 16, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The external server 16 is connected to the optical SW 10, the TRx 11, the SW 12, the control unit 14, the external apparatus or the like. The external server 16 controls another constituent element included in the apparatus, or transfers a command via another constituent element included in the apparatus.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (12-2), in comparison with the configuration of communication system configuration (12-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (13-1) includes an optical SW 10, TRxs 11, an SW 13, a control unit 14, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).
The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the higher-layer apparatus (not illustrated) in a similar manner to communication system configuration (1-1).

The control unit 14 is connected to the optical SW 10, the TRx 11, the SW 13, the external server 16, the external apparatus or the like. The control unit 14 controls a constituent element included in the apparatus, the external apparatus or the like, or transfers a command via the constituent element included in the apparatus, the external apparatus or the like.

The external server 16 is connected to the optical SW 10, the TRx 11, the SW 13, the control unit 14, the external apparatus or the like. The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (13-2), in comparison with the configuration of communication system configuration (13-1), TRxs 11 that send and receive optical signals of the same wavelength instead of different wavelengths (λA to λA), TRxs 11 (λB to λB) . . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (14-1) includes an optical SW 10, TRxs 11, SWs 12, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to the proxy unit 15 directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the proxy unit 15 in a similar manner to communication system configuration (1-1).

The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 12 or the higher-layer apparatus (not illustrated) in a similar manner to communication system configuration (1-1).

The external server 16 is connected to the optical SW 10, the TRx 11, the SW 12, the proxy unit 15, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (14-2), in comparison with the configuration of communication system configuration (14-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (15-1) includes an optical SW 10, TRxs 11, an SW 13, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the proxy unit 15 in a similar manner to communication system configuration (1-1).

The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The external server 16 is connected to the optical SW 10, the TRx 11, the SW 13, the proxy unit 15, the external apparatus or the like. The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (15-2), in comparison with the configuration of communication system configuration (15-1), TRxs 11 that send and receive optical signals of the same wavelength instead of different wavelengths (λA to λA), TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (16-1) includes an optical SW 10, TRxs 11, a control unit 14, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the proxy unit 15 directly or via a line concentration SW or the like. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the proxy unit 15 in a similar manner to communication system configuration (1-1).

The control unit 14 is connected to the optical SW 10, the TRx 11, the proxy unit 15, the external server 16, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the TRx 11 or the higher-layer apparatus (not illustrated) in a similar manner to communication system configuration (1-1).

The external server 16 is connected to the optical SW 10, the TRx 11, the control unit 14, the proxy unit 15, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (16-2), in comparison with the configuration of communication system configuration (16-1), TRxs 11 that send and receive optical signals of the same wavelength instead of different wavelengths (λA to λA), TRxs 11 (λB to λB), . . . , TRxs 11 (λN to λN) are each further connected to the proxy unit 15 directly or via a line concentration SW or the like. Further, a plurality of TRxs 11 of at least a part of wavelengths of the TRxs 11 of different wavelengths may be connected to the proxy unit 15 directly or via a line concentration SW or the like. Other configuration is similar to the above.

The communication system of communication system configuration (17-1) includes an optical SW 10, TRxs 11, SWs 12, and an SW 13 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SWs 12 are connected to the SW 13. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the SW 12 or the higher-layer apparatus (not illustrated) in a similar manner to communication system configuration (1-1).

The constituent element included in the apparatus may send at least a part of traffic of another constituent element included in the apparatus, the external apparatus or the like, at least a part of copies thereof, at least a part of traffic in which at least a part of those is rewritten, or at least a part of responses to those to another constituent element included in the apparatus, the external apparatus or the like.

In the communication system of communication system configuration (17-2), in comparison with the configuration of communication system configuration (17-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (18-1) includes an optical SW 10, TRxs 11, SWs 12, and a control unit 14 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to a higher-layer apparatus (not illustrated) directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the higher-layer apparatus (not illustrated) in a similar manner to communication system configuration (1-1).

The control unit 14 is connected to the optical SW 10, the TRx 11, the SW 12, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (18-2), in comparison with the configuration of communication system configuration (18-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (19-1) includes an optical SW 10, TRxs 11, an SW 13, and a control unit 14 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

8 The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the higher-layer apparatus (not illustrated) in a similar manner to communication system configuration (1-1).

The control unit 14 is connected to the optical SW 10, the TRx 11, the SW 13, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (19-2), in comparison with the configuration of communication system configuration (19-1), TRxs 11 that send and receive optical signals of the same wavelength instead of different wavelengths (λA to λA), TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (20-1) includes an optical SW 10, TRxs 11, SWs 12, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to the proxy unit 15 directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the proxy unit 15 in a similar manner to communication system configuration (1-1).

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 12 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (20-2), in comparison with the configuration of communication system configuration (20-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (21-1) includes an optical SW 10, TRxs 11, an SW 13, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to the proxy unit 15 directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the proxy unit 15 in a similar manner to communication system configuration (1-1).

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the SW 13 or the higher-layer apparatus (not illustrated) in a similar manner to communication system configuration (1-1).

The constituent element included in the apparatus may receive apart, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (21-2), in comparison with the configuration of communication system configuration (21-1), TRxs 11 that send and receive optical signals of the same wavelength instead of different wavelengths (λA to λA), TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (22-1) includes an optical SW 10, TRxs 11, a control unit 14, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the proxy unit 15 directly or via a line concentration SW or the like.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the proxy unit 15 in a similar manner to communication system configuration (1-1).

The control unit 14 is connected to the optical SW 10, the TRx 11, the proxy unit 15, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The proxy unit 15 is connected to a higher-layer apparatus (not illustrated) directly or via a line concentration SW or the like. The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the TRx 11 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (22-2), in comparison with the configuration of communication system configuration (22-1), TRxs 11 that send and receive optical signals of the same wavelength instead of different wavelengths (λA to λA), TRxs 11 (λB to λB), . . . , TRxs 11 (λN to λN) are each further connected to the proxy unit 15 directly or via a line concentration SW or the like. Further, a plurality of TRxs 11 of at least a part of wavelengths of the TRxs 11 of different wavelengths may be connected to the proxy unit 15 directly or via a line concentration SW or the like. Other configuration is similar to the above.

The communication system of communication system configuration (23-1) includes an optical SW 10, TRxs 11, SWs 12, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to a higher-layer apparatus (not illustrated) directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the higher-layer apparatus (not illustrated) in a similar manner to communication system configuration (1-1).

The external server 16 is connected to the optical SW 10, the TRx 11, the SW 12, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (23-2), in comparison with the configuration of communication system configuration (23-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (24-1) includes an optical SW 10, TRxs 11, an SW 13, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the higher-layer apparatus (not illustrated) in a similar manner to communication system configuration (1-1).

The external server 16 is connected to the optical SW 10, the TRx 11, the SW 13, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (24-2), in comparison with the configuration of communication system configuration (24-1), TRxs 11 that send and receive optical signals of the same wavelength instead of different wavelengths (λA to λA), TRxs 11 (λB to λB), . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (25-1) includes an optical SW 10, TRxs 11, a control unit 14, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to a higher-layer apparatus (not illustrated) directly or via a line concentration SW or the like. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the higher-layer apparatus (not illustrated) in a similar manner to communication system configuration (1-1).

The control unit 14 is connected to the optical SW 10, the TRx 11, the external server 16, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The external server 16 is connected to the optical SW 10, the TRx 11, the control unit 14, the external OpS or the like (not illustrated), the controller (not illustrated), or the external apparatus (not illustrated). The external server 16 controls a constituent element included in the apparatus, the external apparatus or the like, or transfers a command via the constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (25-2), in comparison with the configuration of communication system configuration (25-1), TRxs 11 that send and receive optical signals of the same wavelength instead of different wavelengths (λA to λA), TRxs 11 (λB to λB), . . . , TRxs 11 (λN to λN) are each further connected to a higher-layer apparatus (not illustrated) directly or via a line concentration SW or the like. Further, a plurality of TRxs 11 of at least a part of wavelengths of the TRxs 11 of different wavelengths may be connected to a higher-layer apparatus (not illustrated) directly or via a line concentration SW or the like. Other configuration is similar to the above.

The communication system of communication system configuration (26-1) includes an optical SW 10, TRxs 11, a proxy unit 15, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the proxy unit 15 directly or via a line concentration SW or the like. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the proxy unit 15 in a similar manner to communication system configuration (1-1).

The proxy unit 15 performs autonomous control, is controlled by another constituent element included in the apparatus, the external apparatus or the like, or is controlled by a command transferred via another constituent element included in the apparatus, the external apparatus or the like. The proxy unit 15 performs processing to a part or all of traffic of the TRx 11 or the higher-layer apparatus (not illustrated) in a similar manner to communication system configuration (1-1).

The external server 16 is connected to the optical SW 10, the TRx 11, the proxy unit 15, the external OpS or the like (not illustrated), the controller (not illustrated), or the external apparatus (not illustrated). The external server 16 controls another constituent element included in the apparatus, the external apparatus or the like, and transfers a command via another constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (26-2), in comparison with the configuration of communication system configuration (26-1), TRxs 11 that send and receive optical signals of the same wavelength instead of different wavelengths (λA to λA), TRxs 11 (λB to λB), . . . , TRxs 11 (λN to λN) are each further connected to the proxy unit 15 directly or via a line concentration SW or the like. Further, a plurality of TRxs 11 of at least a part of wavelengths of the TRxs 11 of different wavelengths may be connected to the proxy unit 15 directly or via a line concentration SW or the like. Other configuration is similar to the above.

The communication system of communication system configuration (27-1) includes an optical SW 10, TRxs 11, and SWs 12 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SWs 12.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 12 in a similar manner to communication system configuration (1-1).

The SW 12 is connected to a higher-layer apparatus (not illustrated) directly or via a line concentration SW or the like. The SW 12 performs autonomous control, is controlled by another constituent element included in the apparatus, the external apparatus or the like, or is controlled by a command transferred via another constituent element included in the apparatus, the external apparatus or the like. The SW 12 performs processing to a part or all of traffic of the TRx 11 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (27-2), in comparison with the configuration of communication system configuration (27-1), TRxs 11 that send and receive optical signals of the same wavelength instead of different wavelengths (λA to λA), TRxs 11 (λB to λB), . . . , TRxs 11 (λN to λN) are further connected to respective SWs 12. Further, a plurality of TRxs 11 of at least a part of wavelengths of the TRxs 11 of different wavelengths may be connected to the SWs 12. Other configuration is similar to the above.

The communication system of communication system configuration (28-1) includes an optical SW 10, TRxs 11, and an SW 13 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the SW 13.

The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the SW 13 in a similar manner to communication system configuration (1-1).

The SW 13 is connected to a higher-layer apparatus (not illustrated) directly or via a line concentration SW or the like. The SW 13 performs autonomous control, is controlled by another constituent element included in the apparatus, the external apparatus or the like, or is controlled by a command transferred via another constituent element included in the apparatus, the external apparatus or the like. The SW 13 performs processing to a part or all of traffic of the TRx 11 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (28-2), in comparison with the configuration of communication system configuration (28-1), TRxs 11 that send and receive optical signals of the same wavelength instead of different wavelengths (λA to λA), TRxs 11 (λB to λB) . . . . , TRxs 11 (λN to λN) are each further connected to the SW 13. Further, a plurality of TRxs 11 of at least a part of wavelengths of the TRxs 11 of different wavelengths may be connected to the SW 13. Other configuration is similar to the above.

The communication system of communication system configuration (29-1) includes an optical SW 10, TRxs 11, and a control unit 14 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to a higher-layer apparatus (not illustrated) directly or via a line concentration SW or the like. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the higher-layer apparatus (not illustrated) in a similar manner to communication system configuration (1-1).

The control unit 14 is connected to the optical SW 10, the TRx 11, the external OpS or the like (not illustrated), the controller (not illustrated), or the external apparatus (not illustrated). The control unit 14 controls a constituent element included in the apparatus, the external apparatus or the like, or transfers a command via the constituent element included in the apparatus, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (29-2), in comparison with the configuration of communication system configuration (29-1), TRxs 11 that send and receive optical signals of the same wavelength instead of different wavelengths (λA to λA), TRxs 11 (λB to λB), . . . , TRxs 11 (λN to λN) are each further connected to a higher-layer apparatus (not illustrated) directly or via a line concentration SW or the like. Further, a plurality of TRxs 11 of at least a part of wavelengths of the TRxs 11 of different wavelengths may be connected to a higher-layer apparatus (not illustrated) directly or via a line concentration SW or the like. Other configuration is similar to the above.

The communication system of communication system configuration (30-1) includes an optical SW 10, TRxs 11, and a proxy unit 15 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to the proxy unit 15 directly or via a line concentration SW or the like. The TRx 11 performs autonomous control, is controlled by a constituent element included in the apparatus, the external apparatus or the like, or is controlled by a command transferred via another constituent element included in the apparatus, the external apparatus or the like. The TRx 11 performs processing to a part or all of traffic of the optical SW 10 or the proxy unit 15 in a similar manner to communication system configuration (1-1).

The proxy unit 15 performs autonomous control, is controlled by another constituent element included in the apparatus, the external apparatus or the like, or is controlled by a command transferred via another constituent element included in the apparatus, the external apparatus or the like, e proxy unit 15 performs processing to a part or all of traffic of the TRx 11 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (30-2), in comparison with the configuration of communication system configuration (30-1), TRxs 11 that send and receive optical signals of the same wavelength instead of different wavelengths (λA to λA), TRxs 11 (λB to λB), . . . , TRxs 11 (λN to λN) are each further connected to the proxy unit 15 directly or via a line concentration SW or the like. Further, a plurality of TRxs 11 of at least a part of wavelengths of the TRxs 11 of different wavelengths may be connected to the proxy unit 15 directly or via a line concentration SW or the like. Other configuration is similar to the above.

The communication system of communication system configuration (31-1) includes an optical SW 10, TRxs 11, and an external server 16 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to a higher-layer apparatus (not illustrated) directly or via a line concentration SW or the like. The TRx 11 performs autonomous control, is controlled by another constituent element included in the apparatus, the external apparatus or the like, or is controlled by a command transferred via another constituent element included in the apparatus, the external apparatus or the like. The TRx 11 performs processing to a part or all of traffic of the optical SW 10 or the higher-layer apparatus (not illustrated) in a similar manner to communication system configuration (1-1).

The external server 16 is connected to the optical SW 10, the TRx 11, the external OpS or the like (not illustrated), the controller (not illustrated), or the external apparatus (not illustrated). The external server 16 controls another constituent element included in the apparatus, the external apparatus or the like, or transfers a command via another constituent element of the TRx 11, the external apparatus or the like.

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (31-2), in comparison with the configuration of communication system configuration (31-1), TRxs 11 that send and receive optical signals of the same wavelength instead of different wavelengths (λA to λA), TRxs 11 (λB to λB), . . . , TRxs 11 (λN to λN) are each further connected to a higher-layer apparatus (not illustrated) directly or via a line concentration SW or the like. Further, a plurality of TRxs 11 of at least a part of wavelengths of the TRxs 11 of different wavelengths may be connected to a higher-layer apparatus (not illustrated) directly or via a line concentration SW or the like. Other configuration is similar to the above.

The communication system of communication system configuration (32-1) includes an optical SW 10 and TRx 11 (FIG. 15).

The optical SW 10 is connected to an ODN and TRxs 11. The optical SW 10 performs autonomous control, is controlled by another constituent element included in the apparatus, the external apparatus or the like, or is controlled by a command transferred via another constituent element included in the apparatus, the external apparatus or the like.

The TRxs 11 that send and receive optical signals of different wavelengths (λA to λN) are connected to a higher-layer apparatus (not illustrated) directly or via a line concentration SW or the like. The TRx 11 performs autonomous control, is controlled by a constituent element included in the apparatus, the external apparatus or the like, or is controlled by a command transferred via another constituent element included in the apparatus, the external apparatus or the like. The TRx 11 performs processing to a part or all of traffic of the optical SW 10 or the higher-layer apparatus (not illustrated) in a similar manner to communication system configuration (1-1).

The constituent element included in the apparatus may receive a part, the whole, or copies of traffic of another constituent element included in the apparatus, the external apparatus or the like, and send a part of the received traffic, the whole thereof, or a response to the part of the received traffic, traffic all of which is overwritten, or the received traffic to another constituent element included in the apparatus, the external apparatus or the like.

In the communication system of communication system configuration (32-2), in comparison with the configuration of communication system configuration (32-1), TRxs 11 that send and receive optical signals of the same wavelength instead of different wavelengths (λA to λA), TRxs 11 (λB to λB), . . . , TRxs 11 (λN to λN) are each further connected to a higher-layer apparatus (not illustrated) directly or via a line concentration SW or the like. Further, a plurality of TRxs 11 of at least a part of wavelengths of the TRxs 11 of different wavelengths may be connected to a higher-layer apparatus (not illustrated) directly or via a line concentration SW or the like. Other configuration is similar to the above.

The description above illustrates configurations in which the communication systems illustrated in communication system configurations (1-1) to (32-2) each include the optical SW 10. However, a configuration in which the communication systems illustrated in communication system configurations (1-1) to (32-2) do not include the optical SW 10 may be adopted. In the communication system illustrated in FIG. 15, configurations in which the optical SW 10 corresponding to communication system configurations (1-1) to (32-2) is not included are referred to as communication system configurations (33-1) to (64-2), respectively. In other words, the communication apparatus includes at least a part of TRxs 11, SWs 12, an SW 13, a control unit 14, and a proxy unit 15. Note that the communication apparatus may include an external server 16. In communication system configurations (33-1) to (64-2), an ODN and TRxs 11 are connected without using the optical SW 10. Input and output of the TRxs 11 of the same wavelength including input and output of the TRxs 11 of a variable wavelength may be connected to a different core wire of the ODN or a multiplexer/demultiplexer or the like connected to those, or input and output of TRxs 11 of a plurality of wavelengths including a variable wavelength or a bundle of those bundled by a multiplexer/demultiplexer or the like may be connected to a different core wire of the ODN, or input and output of TRxs 11 of a wavelength including a variable wavelength may be bundled and connected to a different core wire of the ODN or a multiplexer/demultiplexer or the like connected to those. Other configuration is similar to the above.

In the following, the control unit 14 may be interpreted as an instruction unit, and at least one of the TRx 11, the SW 12, and the SW 13 as an execution unit, or a part of the control unit 14 may be interpreted as an instruction unit, and the rest as an execution unit.

### 1st Configuration Example

An example in which the OLT includes TRxs 11, and functions are deployed by separating an execution unit and an instruction unit will be described. In this case, the OLT includes an execution unit in the TRx 11. The OLT includes an instruction unit in a part of the TRx 11 capable of arithmetic processing, such as an information processing unit or a central processing unit (CPU). In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. In the 1st configuration example, the OLT includes the optical SW 10 that mainly switches input and output of the TRxs 11 of the same wavelength (*1) including input and output of the TRxs 11 of a variable wavelength to a different core wire (*2) or a multiplexer/demultiplexer or the like connected to those, or switches input and output of TRxs 11 of a plurality of wavelengths (*3) including a variable wavelength or a bundle of those bundled by a multiplexer/demultiplexer or the like to a different core wire (*2), or bundles input and output of TRxs 11 of a wavelength (*4) including a variable wavelength and switches to a core wire (*2) or a multiplexer/demultiplexer or the like connected to those. (*1)(In examples to be described later, this may be the same frequency, mode, core, code, frequency (sub-)carrier or the like, or a combination of those including a wavelength) (*2) (In examples to be described later, this may be a different mode, core or the like, or a combination of those including a core wire)(*3)(In examples to be described later, these may be a plurality of frequencies, modes, cores, codes, frequencies, (sub-)carriers or the like, or a combination of those including a wavelength)(*4)(In examples to be described later, this may be a frequency, a mode, a core, a code, a frequency, a (sub-)carrier or the like, or a combination of those including a wavelength) Note that, in the 2nd configuration example to the 64th configuration example described below as well, the OLT may include the optical SW 10, or may not include the optical SW 10 in configuration examples in which the execution unit and the instruction unit are not deployed in the optical SW 10.

Input and output of the execution unit and the instruction unit may be performed via any path of internal wiring, aback board, the OAM unit 114, a main signal line, dedicated wiring, an OpS or the like, a controller, and a Cont, for example. If communication is directly terminated by the instruction unit to input the communication, encapsulation in the OAM unit 114 or a main signal may be adopted. Communication may be terminated at any point, and input may be performed via a path such as internal wiring, a back board, the OAM unit 114, a main signal line, dedicated wiring, an OpS or the like, a controller, or a control board. When the OAM unit 114 or the main signal line is used, it is desirable to adopt encapsulation in the OAM unit 114 or the main signal. When the main signal line is used as a medium, it is desirable to carry out distribution to the instruction unit at the OSU or the SW at another point.

Note that the 1st configuration example can be applied to any configuration including the TRx 11 and the part capable of arithmetic processing in the TRx 11 according to communication system configurations (1-1) to (64-2).

### 2nd Configuration Example

In the 2nd configuration example, the execution unit is included in the TRx 11, and the instruction unit is included in a part of the SW 12 capable of arithmetic processing, for example, an information processing unit, a CPU, or the like. Other configuration is similar to that of the 1st configuration example. Note that the 2nd configuration example can be applied to any configuration including the TRx 11 and the part capable of arithmetic processing in the SW 12 according to communication system configurations (1-1) to (64-2). Note that the execution unit and the instruction unit may be included in both of the TRx 11 and the part of the SW 12 capable of arithmetic processing.

### 3rd Configuration Example

In the 3rd configuration example, the execution unit is included in the TRx 11, and the instruction unit is included in a part of the OSU capable of arithmetic processing, for example, an information processing unit, a CPU, or the like. Other configuration is similar to that of the 1st configuration example. Note that the 3rd configuration example can be applied to any configuration including the TRx 11 and the part capable of arithmetic processing in the OSU according to communication system configurations (1-1) to (64-2). Note that the execution unit and the instruction unit may be included in both of the TRx 11 and the part of the OSU capable of arithmetic processing.

### 4th Configuration Example

In the 4th configuration example, the execution unit is included in the TRx 11, and the instruction unit is included in a part of the SW 13 capable of arithmetic processing, for example, an information processing unit, a CPU, or the like. Other configuration is similar to that of the 1st configuration example. Note that the 4th configuration example can be applied to any configuration including the TRx 11 and the part capable of arithmetic processing in the SW 13 according to communication system configurations (1-1) to (64-2). Note that the execution unit and the instruction unit may be included in both of the TRx 11 and the part of the SW 13 capable of arithmetic processing.

### 5th Configuration Example

In the 5th configuration example, the execution unit is included in the TRx 11, and the instruction unit is included in a part of the OLT capable of arithmetic processing, for example, the control unit 14, an information processing unit, a control board, a CPU board, or the like. Other configuration is similar to that of the 1st configuration example. Note that the 5th configuration example can be applied to any configuration including the TRx 11 and the part capable of arithmetic processing in the OLT according to communication system configurations (1-1) to (64-2). Note that the execution unit and the instruction unit may be included in both of the TRx 11 and the part of the OLT capable of arithmetic processing.

### 6th Configuration Example

In the 6th configuration example, the execution unit is included in the TRx 11, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 6th configuration example can be applied to any configuration including the TRx 11 and the part capable of arithmetic processing outside the OLT according to communication system configurations (1-1) to (64-2). Note that the execution unit and the instruction unit may be included in both of the TRx 11 and the part outside the OLT capable of arithmetic processing.

### 7th Configuration Example

In the 7th configuration example, the execution unit is included in the TRx 11, and the instruction unit is included in a part of a main signal network outside the OLT capable of arithmetic processing, for example, the proxy unit 15 or the like. Other configuration is similar to that of the 1st configuration example. Note that the 7th configuration example can be applied to any configuration including the TRx 11 and the part capable of arithmetic processing in the main signal network outside the OLT according to communication system configurations (1-1) to (64-2). Note that the execution unit and the instruction unit may be included in both of the TRx 11 and the part of the main signal network outside the OLT capable of arithmetic processing.

### 8th Configuration Example

In the 8th configuration example, the execution unit is included in the SW 12, and the instruction unit is included in a part of the TRx 11 capable of arithmetic processing, for example, an information processing unit, a CPU, or the like. Other configuration is similar to that of the 1st configuration example. Note that the 8th configuration example can be applied to any configuration including the SW 12 and the part capable of arithmetic processing in the TRx 11 according to communication system configurations (1-1) to (64-2). Note that the execution unit and the instruction unit may be included in both of the SW 12 and the part of the TRx 11 capable of arithmetic processing.

### 9th Configuration Example

In the 9th configuration example, the execution unit is included in the SW 12, and the instruction unit is included in a part of the SW 12 capable of arithmetic processing, for example, an information processing unit, a CPU, or the like. In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. Other configuration is similar to that of the 1st configuration example. Note that the 9th configuration example can be applied to any configuration including the SW 12 and the part capable of arithmetic processing in the SW 12 according to communication system configurations (1-1) to (64-2).

### 10th Configuration Example

In the 10th configuration example, the execution unit is included in the SW 12, and the instruction unit is included in a part of the OSU capable of arithmetic processing, for example, an information processing unit, a CPU, or the like. Other configuration is similar to that of the 1st configuration example. Note that the 10th configuration example can be applied to any configuration including the SW 12 and the part capable of arithmetic processing in the OSU according to communication system configurations (1-1) to (64-2). Note that the execution unit and the instruction unit may be included in both of the SW 12 and the part of the OSU capable of arithmetic processing.

### 11th Configuration Example

In the 11th configuration example, the execution unit is included in the SW 12, and the instruction unit is included in, for example, an information processing unit, a CPU, or the like of SW 13. Other configuration is similar to that of the 1st configuration example. Note that the 11th configuration example can be applied to any configuration including the SW 12 and a part capable of arithmetic processing in the SW 13 according to communication system configurations (1-1) to (64-2). Note that the execution unit and the instruction unit may be included in both of the SW 12 and the part of the SW 13 capable of arithmetic processing.

### 12th Configuration Example

In the 12th configuration example, the execution unit is included in the SW 12, and the instruction unit is included in a part of the OLT capable of arithmetic processing, for example, the control unit 14, an information processing unit, a control board, a CPU board, or the like. Other configuration is similar to that of the 1st configuration example. Note that the 12th configuration example can be applied to any configuration including the SW 12 and the part capable of arithmetic processing in the OLT according to communication system configurations (1-1) to (64-2). Note that the execution unit and the instruction unit may be included in both of the SW 12 and the part of the OLT capable of arithmetic processing.

### 13th Configuration Example

In the 13th configuration example, the execution unit is included in the SW 12, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 13th configuration example can be applied to any configuration including the SW 12 and the part capable of arithmetic processing outside the OLT according to communication system configurations (1-1) to ((4-2). Note that the execution unit and the instruction unit may be included in both of the SW 12 and the part outside the OLT capable of arithmetic processing.

### 14th Configuration Example

In the 14th configuration example, the execution unit is included in the SW 12, and the instruction unit is included in a part of a main signal network outside the OLT capable of arithmetic processing, for example, the proxy unit 15 or the like. Other configuration is similar to that of the 1st configuration example. Note that the 14th configuration example can be applied to any configuration including the SW 12 and the part capable of arithmetic processing in the main signal network outside the OLT according to communication system configurations (1-1) to (64-2). Note that the execution unit and the instruction unit may be included in both of the SW 12 and the part of the main signal network outside the OLT capable of arithmetic processing.

### 15th Configuration Example

In the 15th configuration example, the execution unit is included in the OSU, and the instruction unit is included in a part of the TRx 11 capable of arithmetic processing, for example, an information processing unit, a CPU, or the like. Other configuration is similar to that of the 1st configuration example. Note that the 15th configuration example can be applied to a configuration including the OSU and the part capable of arithmetic processing in the TRx 11 according to communication system configurations (1-1) to (64-2). Note that the execution unit and the instruction unit may be included in both of the OSU and the part of the TRx 11 capable of arithmetic processing.

### 16th Configuration Example

In the 16th configuration example, the execution unit is included in the OSU, and the instruction unit is included in a part of the SW 12 capable of arithmetic processing, for example, an information processing unit, a CPU, or the like. Other configuration is similar to that of the 1st configuration example. Note that the 16th configuration example can be applied to any configuration including the OSU and the part capable of arithmetic processing in the SW 12 according to communication system configurations (1-1) to (64-2). Note that the execution unit and the instruction unit may be included in both of the OSU and the part of the SW 12 capable of arithmetic processing.

### 17th Configuration Example

In the 17th configuration example, the execution unit is included in the OSU, and the instruction unit is included in a part of the OSU capable of arithmetic processing, for example, an information processing unit, a CPU, or the like. In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. Other configuration is similar to that of the 1st configuration example. Note that the 17th configuration example can be applied to any configuration including the OSU and the part capable of arithmetic processing in the OSU according to communication system configurations (1-1) to (64-2).

### 18th Configuration Example

In the 18th configuration example, the execution unit is included in the OSU, and the instruction unit is included in a part of the SW 13 capable of arithmetic processing, for example, an information processing unit, a CPU, or the like. Other configuration is similar to that of the 1st configuration example. Note that the 18th configuration example can be applied to any configuration including the OSU and the part capable of arithmetic processing in the SW 13 according to communication system configurations (1-1) to (64-2). Note that the execution unit and the instruction unit may be included in both of the OSU and the part of the SW 13 capable of arithmetic processing.

### 19th Configuration Example

In the 19th configuration example, the execution unit is included in the OSU, and the instruction unit is included in a part of the OLT capable of arithmetic processing, for example, the control unit 14, an information processing unit, a control board, a CPU board, or the like. Other configuration is similar to that of the 1st configuration example. Note that the 19th configuration example can be applied to any configuration including the OSU and the part capable of arithmetic processing in the OLT according to communication system configurations (1-1) to (64-2). Note that the execution unit and the instruction unit may be included in both of the OSU and the part of the OLT capable of arithmetic processing.

### 20th Configuration Example

In the 20th configuration example, the execution unit is included in the OSU, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 20th configuration example can be applied to any configuration including the OSU and the part capable of arithmetic processing outside the OLT according to communication system configurations (1-1) to (64-2). Note that the execution unit and the instruction unit may be included in both of the OSU and the part outside the OLT capable of arithmetic processing.

### 21st Configuration Example

In the 21st configuration example, the execution unit is included in the OSU, and the instruction unit is included in a part of a main signal network outside the OLT capable of arithmetic processing, for example, the proxy unit 15 or the like. Other configuration is similar to that of the 1st configuration example. Note that the 21st configuration example can be applied to any configuration including the OSU and the part capable of arithmetic processing in the main signal network outside the OLT according to communication system configurations (1-1) to (64-2). Note that the execution unit and the instruction unit may be included in both of the OSU and the part of the main signal network outside the OLT capable of arithmetic processing.

### 22nd Configuration Example

In the 22nd configuration example, the execution unit is included in the SW 13, and the instruction unit is included in a part of the TRx 11 capable of arithmetic processing, for example, an information processing unit, a CPU, or the like. Other configuration is similar to that of the 1st configuration example. Note that the 22nd configuration example can be applied to any configuration including the SW 13 and the part capable of arithmetic processing in the TRx 11 according to communication system configurations (1-1) to (64-2). Note that the execution unit and the instruction unit may be included in both of the SW 13 and the part of the TRx 11 capable of arithmetic processing.

### 23rd Configuration Example

In the 23rd configuration example, the execution unit is included in the SW 13, and the instruction unit is included in the SW 12. Other configuration is similar to that of the 1st configuration example. Note that the 23rd configuration example can be applied to any configuration including the SW 13 and the SW 12 according to communication system configurations (1-1) to (64-2). Note that the execution unit and the instruction unit may be included in both of the SW 13 and a part of the SW 12 capable of arithmetic processing.

### 24th Configuration Example

In the 24th configuration example, the execution unit is included in the SW 13, and the instruction unit is included in a part of the OSU capable of arithmetic processing. The part of the OSU capable of arithmetic processing is, for example, an information processing unit or a CPU. Other configuration is similar to that of the 1st configuration example. Note that the 24th configuration example can be applied to any configuration including the SW 13 and the part capable of arithmetic processing in the OSU according to communication system configurations (1-1) to (64-2). Note that the execution unit and the instruction unit may be included in both of the SW 13 and the part of the OSU capable of arithmetic processing.

### 25th Configuration Example

In the 25th configuration example, the execution unit is included in the SW 13, and the instruction unit is included in a part of the SW 13 capable of arithmetic processing, for example, an information processing unit, a CPU, or the like. Other configuration is similar to that of the 1st configuration example. In terms of response speed, it is preferable that the execution unit be deployed closer to the PON than the instruction unit. However, the opposite deployment may be adopted, deployment in another apparatus at the same position may be adopted, or deployment in another virtual machine (VM) in the same apparatus may be adopted. Note that the 25th configuration example can be applied to any configuration including the part capable of arithmetic processing in the SW 13 according to communication system configurations (1-1) to (64-2).

### 26th Configuration Example

In the 26th configuration example, the execution unit is included in the SW 13, and the instruction unit is included in a part of the OLT capable of arithmetic processing, for example, the control unit 14, an information processing unit, a control board, a CPU board, or the like. Other configuration is similar to that of the 1st configuration example. Note that the 26th configuration example can be applied to any configuration including the SW 13 and the part capable of arithmetic processing in the OLT according to communication system configurations (1-1) to (64-2). Note that the execution unit and the instruction unit may be included in both of the SW 13 and the part of the OLT capable of arithmetic processing.

### 27th Configuration Example

In the 27th configuration example, the execution unit is included in the SW 13, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 27th configuration example can be applied to any configuration including the SW 13 and the part capable of arithmetic processing outside the OLT according to communication system configurations (1-1) to (64-2). Note that the execution unit and the instruction unit may be included in both of the SW 13 and the part outside the OLT capable of arithmetic processing.

### 28th Configuration Example

In the 28th configuration example, the execution unit is included in the SW 13, and the instruction unit is included in a part of a main signal network outside the OLT capable of arithmetic processing, for example, the proxy unit 15 or the like. Other configuration is similar to that of the 1st configuration example. Note that the 28th configuration example can be applied to any configuration including the SW 13 and the part capable of arithmetic processing in the main signal network outside the OLT according to communication system configurations (1-1) to (64-2). Note that the execution unit and the instruction unit may be included in both of the SW 13 and the part of the main signal network outside the OLT capable of arithmetic processing.

### 29th Configuration Example

In the 29th configuration example, the execution unit is included in, for example, the control unit 14, an information processing unit, a control board, a CPU board, or the like of the OLT, and the instruction unit is included in a part of the TRx 11 capable of arithmetic processing, such as an information processing unit or a CPU. Other configuration is similar to that of the 1st configuration example. Note that the 29th configuration example can be applied to any configuration including, for example, the control unit 14, the information processing unit, the control board, the CPU board, or the like of the OLT and the part capable of arithmetic processing in the TRx 11 according to communication system configurations (1-1) to (64-2). Note that the execution unit and the instruction unit may be included in both of, for example, the control unit 14, the information processing unit, the control board, the CPU board, or the like of the OLT and the part of the TRx 11 capable of arithmetic processing.

### 30th Configuration Example

In the 30th configuration example, the execution unit is included in, for example, the control unit 14, an information processing unit, a control board, a CPU board, or the like of the OLT, and the instruction unit is included in a part of the SW 12 capable of arithmetic processing, for example, an information processing unit, a CPU, or the like. Other configuration is similar to that of the 1st configuration example. Note that the 30th configuration example can be applied to any configuration including, for example, the control unit 14, the information processing unit, the control board, the CPU board, or the like of the OLT and the part capable of arithmetic processing in the SW 12 according to communication system configurations (1-1) to (64-2). Note that the execution unit and the instruction unit may be included in both of, for example, the control unit 14, the information processing unit, the control board, the CPU board, or the like of the OLT and the part of the SW 12 capable of arithmetic processing.

### 31st Configuration Example

In the 31st configuration example, the execution unit is included in, for example, the control unit 14, an information processing unit, a control board, a CPU board, or the like of the OLT, and the instruction unit is included in a part of the OSU capable of arithmetic processing, for example, an information processing unit, a CPU, or the like. Other configuration is similar to that of the 1st configuration example. Note that the 31st configuration example can be applied to any configuration including, for example, the control unit 14, the information processing unit, the control board, the CPU board, or the like of the OLT and the part capable of arithmetic processing in the OSU according to communication system configurations (1-1) to (64-2). Note that the execution unit and the instruction unit may be included in both of, for example, the control unit 14, the information processing unit, the control board, the CPU board, or the like of the OLT and the part of the OSU capable of arithmetic processing.

### 32nd Configuration Example

In the 32nd configuration example, the execution unit is included in, for example, the control unit 14, an information processing unit, a control board, a CPU board, or the like of the OLT, and the instruction unit is included in a part of the SW 13 capable of arithmetic processing, for example, an information processing unit, a CPU, or the like. Other configuration is similar to that of the 1st configuration example. Note that the 32nd configuration example can be applied to any configuration including, for example, the control unit 14, the information processing unit, the control board, the CPU board, or the like of the OLT and the part capable of arithmetic processing in the SW 13 according to communication system configurations (1-1) to (64-2). Note that the execution unit and the instruction unit may be included in both of, for example, the control unit 14, the information processing unit, the control board, the CPU board, or the like of the OLT and the part of the SW 13 capable of arithmetic processing.

### 33rd Configuration Example

In the 33rd configuration example, the execution unit is included in, for example, the control unit 14, an information processing unit, a control board, a CPU board, or the like of the OLT, and the instruction unit is included in a part of the OLT capable of arithmetic processing, for example, the control unit 14, an information processing unit, a control board, a CPU board, or the like. In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. Other configuration is similar to that of the 1st configuration example. Note that the 33rd configuration example can be applied to a configuration including, for example, the control unit 14, the information processing unit, the control board, or the CPU board of the OLT and the part capable of arithmetic processing in the OLT according to communication system configurations (1-1) to (64-2).

### 34th Configuration Example

In the 34th configuration example, the execution unit is included in, for example, the control unit 14, an information processing unit, a control board, a CPU board, or the like of the OLT, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 34th configuration example can be applied to any configuration including, for example, the control unit 14, the information processing unit, the control board, the CPU board, or the like of the OLT and the part capable of arithmetic processing outside the OLT according to communication system configurations (1-1) to (64-2). Note that the execution unit and the instruction unit may be included in both of for example, the control unit 14, the information processing unit, the control board, the CPU board, or the like of the OLT and the part outside the OLT capable of arithmetic processing.

### 35th Configuration Example

In the 35th configuration example, the execution unit is included in, for example, the control unit 14, an information processing unit, a control board, a CPU board, or the like of the OLT, and the instruction unit is included in a part of a main signal network outside the OLT capable of arithmetic processing, for example, the proxy unit 15 or the like. Other configuration is similar to that of the 1st configuration example. Note that the 35th configuration example can be applied to any configuration including, for example, the control unit 14, the information processing unit, the control board, the CPU board, or the like of the OLT and the part capable of arithmetic processing in the main signal network outside the OLT according to communication system configurations (1-1) to (64-2). Note that the execution unit and the instruction unit may be included in both of, for example, the control unit 14, the information processing unit, the control board, the CPU board, or the like of the OLT and the part of the main signal network outside the OLT capable of arithmetic processing.

### 36th Configuration Example

In the 36th configuration example, the execution unit is included in, for example, a center cloud, a local cloud, an edge cloud, an independent external server 16, an information processing unit, an OpS or the like outside the OLT, and the instruction unit is included in a part of the TRx 11 capable of arithmetic processing, for example, an information processing unit, a CPU, or the like. Other configuration is similar to that of the 1st configuration example. Note that the 36th configuration example can be applied to any configuration including, for example, the center cloud, the local cloud, the edge cloud, the independent external server 16, the information processing unit, the OpS or the like outside the OLT and the part capable of arithmetic processing in the TRx 11 according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the TRx 11 capable of arithmetic processing.

### 37th Configuration Example

In the 37th configuration example, the execution unit is included in, for example, a center cloud, a local cloud, an edge cloud, an independent external server 16, an information processing unit, an OpS or the like outside the OLT, and the instruction unit is included in a part of the SW 12 capable of arithmetic processing, for example, an information processing unit, a CPU, or the like. Other configuration is similar to that of the 1st configuration example. Note that the 37th configuration example can be applied to any configuration including, for example, the center cloud, the local cloud, the edge cloud, the independent external server 16, the information processing unit, the OpS or the like outside the OLT and the part capable of arithmetic processing in the SW 12 according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the SW 12 capable of arithmetic processing.

### 38th Configuration Example

In the 38th configuration example, the execution unit is included in, for example, a center cloud, a local cloud, an edge cloud, an independent external server 16, an information processing unit, an OpS or the like outside the OLT, and the instruction unit is included in a part of the OSU capable of arithmetic processing, for example, an information processing unit, a CPU, or the like. Other configuration is similar to that of the 1st configuration example. Note that the 38th configuration example can be applied to any configuration including, for example, the center cloud, the local cloud, the edge cloud, the independent external server 16, the information processing unit, the OpS or the like outside the OLT and the part capable of arithmetic processing in the OSU according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the OSU capable of arithmetic processing.

### 39th Configuration Example

In the 39th configuration example, the execution unit is included in, for example, a center cloud, a local cloud, an edge cloud, an independent external server 16, an information processing unit, an OpS or the like outside the OLT, and the instruction unit is included in a part of the SW 13 capable of arithmetic processing, for example, an information processing unit, a CPU, or the like. Other configuration is similar to that of the 1st configuration example. Note that the 39th configuration example can be applied to any configuration including, for example, the center cloud, the local cloud, the edge cloud, the independent external server 16, the information processing unit, the OpS or the like outside the OLT and the part capable of arithmetic processing in the SW 13 according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the SW 13 capable of arithmetic processing.

### 40th Configuration Example

In the 40th configuration example, the execution unit is included in, for example, a center cloud, a local cloud, an edge cloud, an independent external server 16, an information processing unit, an OpS or the like outside the OLT, and the instruction unit is included in a part of the OLT capable of arithmetic processing, for example, the control unit 14, an information processing unit, a control board, a CPU board, or the like. Other configuration is similar to that of the 1st configuration example. Note that the 40th configuration example can be applied to any configuration including, for example, the center cloud, the local cloud, the edge cloud, the independent external server 16, the information processing unit, the OpS or the like outside the OLT and the part capable of arithmetic processing in the OLT according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the OLT capable of arithmetic processing.

### 41st Configuration Example

In the 41st configuration example, the execution unit is included in, for example, a center cloud, a local cloud, an edge cloud, an independent external server 16, an information processing unit, an OpS or the like outside the OLT, and the instruction unit is included in a part outside the OLT capable of arithmetic processing, for example, a center cloud, a local cloud, an edge cloud, an independent external server 16, an information processing unit, an OpS or the like. In terms of response speed, it is preferable that the execution unit be deployed closer to the PON than the instruction unit. However, the opposite deployment may be adopted, deployment in another server at the same position may be adopted, or deployment in another VM in the same server may be adopted. Other configuration is similar to that of the 1st configuration example. Note that the 41st configuration example can be applied to any configuration including, for example, the center cloud, the local cloud, the edge cloud, the independent external server 16, the information processing unit, the OpS or the like outside the OLT and the part capable of arithmetic processing outside the OLT according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part outside the OLT capable of arithmetic processing.

### 42nd Configuration Example

In the 42nd configuration example, the execution unit is included in, for example, a center cloud, a local cloud, an edge cloud, an independent external server 16, an information processing unit, an OpS or the like outside the OLT, and the instruction unit is included in a part of a main signal network outside the OLT capable of arithmetic processing, for example, the proxy unit 15 or the like. Other configuration is similar to that of the 1st configuration example. Note that the 42nd configuration example can be applied to any configuration including, for example, the center cloud, the local cloud, the edge cloud, the independent external server 16, the information processing unit, the OpS or the like outside the OLT and the part capable of arithmetic processing in the main signal network outside the OLT according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the main signal network outside the OLT capable of arithmetic processing.

### 43rd Configuration Example

In the 43rd configuration example, the execution unit is included in, for example, the proxy unit 15 or the like of a main signal network outside the OLT, and the instruction unit is included in a part of the TRx 11 capable of arithmetic processing, for example, an information processing unit, a CPU, or the like. Other configuration is similar to that of the 1st configuration example. Note that the 43rd configuration example can be applied to any configuration including, for example, the proxy unit 15 or the like of the main signal network outside the OLT and the part capable of arithmetic processing in the TRx 11 according to communication system configurations (1-1) to (64-2). Note that the execution unit and the instruction unit may be included in both of, for example, the proxy unit 15 or the like of the main signal network outside the OLT and the part of the TRx 11 capable of arithmetic processing.

### 44th Configuration Example

In the 44th configuration example, the execution unit is included in, for example, the proxy unit 15 or the like of a main signal network outside the OLT, and the instruction unit is included in a part of the SW 12 capable of arithmetic processing, for example, an information processing unit, a CPU, or the like. Other configuration is similar to that of the 1st configuration example. Note that the 44th configuration example can be applied to any configuration including, for example, the proxy unit 15 or the like of the main signal network outside the OLT and the part capable of arithmetic processing in the SW 12 according to communication system configurations (1-1) to (64-2). Note that the execution unit and the instruction unit may be included in both of, for example, the proxy unit 15 or the like of the main signal network outside the OLT and the part of the SW 12 capable of arithmetic processing.

### 45th Configuration Example

In the 45th configuration example, the execution unit is included in, for example, the proxy unit 15 or the like of a main signal network outside the OLT, and the instruction unit is included in a part of the OSU capable of arithmetic processing, for example, an information processing unit, a CPU, or the like. Other configuration is similar to that of the 1st configuration example. Note that the 45th configuration example can be applied to any configuration including, for example, the proxy unit 15 or the like of the main signal network outside the OLT and the part capable of arithmetic processing in the OSU according to communication system configurations (1-1) to (64-2). Note that the execution unit and the instruction unit may be included in both of, for example, the proxy unit 15 or the like of the main signal network outside the OLT and the part of the OSU capable of arithmetic processing.

### 46th Configuration Example

In the 46th configuration example, the execution unit is included in, for example, the proxy unit 15 or the like of a main signal network outside the OLT, and the instruction unit is included in a part of the SW 13 capable of arithmetic processing, for example, an information processing unit, a CPU, or the like. Other configuration is similar to that of the 1st configuration example. Note that the 46th configuration example can be applied to any configuration including, for example, the proxy unit 15 or the like of the main signal network outside the OLT and the part capable of arithmetic processing in the SW 13 according to communication system configurations (1-1) to (64-2). Note that the execution unit and the instruction unit may be included in both of, for example, the proxy unit 15 or the like of the main signal network outside the OLT and the part of the SW 13 capable of arithmetic processing.

### 47th Configuration Example

In the 47th configuration example, the execution unit is included in, for example, the proxy unit 15 or the like of a main signal network outside the OLT, and the instruction unit is included in a part of the OLT capable of arithmetic processing, for example, the control unit 14, an information processing unit, a control board, a CPU board, or the like. Other configuration is similar to that of the 1st configuration example. Note that the 47th configuration example can be applied to a configuration including, for example, the proxy unit 15 or the like of the main signal network outside the OLT and the part capable of arithmetic processing in the OLT according to communication system configurations (1-1) to (64-2). Note that the execution unit and the instruction unit may be included in both of, for example, the proxy unit 15 or the like of the main signal network outside the OLT and the part of the OLT capable of arithmetic processing.

### 48th Configuration Example

In the 48th configuration example, the execution unit is included in, for example, the proxy unit 15 or the like of a main signal network outside the OLT, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 48th configuration example can be applied to any configuration including, for example, the proxy unit 15 of the main signal network outside the OLT and the part capable of arithmetic processing outside the OLT according to communication system configurations (1-1) to (64-2). Note that the execution unit and the instruction unit may be included in both of, for example, the proxy unit 15 or the like of the main signal network outside the OLT and the part outside the OLT capable of arithmetic processing.

### 49th Configuration Example

In the 49th configuration example, the execution unit is included in, for example, the proxy unit 15 or the like of a main signal network outside the OLT, and the instruction unit is included in a part of a main signal network outside the OLT capable of arithmetic processing, for example, the proxy unit 15 or the like. In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. Other configuration is similar to that of the 1st configuration example. Note that the 49th configuration example can be applied to any configuration including the part capable of arithmetic processing in, for example, the proxy unit 15 or the like of the main signal network outside the OLT according to communication system configurations (1-1) to (64-2).

### 50th Configuration Example

In the 50th configuration example, the execution unit is included in the optical SW 10, and the instruction unit is included in a part of the optical SW 10 capable of arithmetic processing, for example, an information processing unit, a CPU, or the like. In terms of response speed, it is preferable that the execution unit be deployed closer to the PON than the instruction unit. However, the opposite deployment may be adopted, deployment in another apparatus at the same position may be adopted, or deployment in another VM in the same apparatus may be adopted. Other configuration is similar to that of the 1st configuration example. Note that the 50th configuration example can be applied to any configuration including the part capable of arithmetic processing in the optical SW 10 according to communication system configurations (1-1) to (64-2). Note that the execution unit and the instruction unit may be included in both of the parts of the optical SW 10 capable of arithmetic processing.

### 51st Configuration Example

In the 51st configuration example, the execution unit is included in the optical SW 10, and the instruction unit is included in a part of the TRx 11 capable of arithmetic processing, for example, an information processing unit, a CPU, or the like. Other configuration is similar to that of the 1st configuration example.

Note that the 51st configuration example can be applied to any configuration including the optical SW 10 and the part capable of arithmetic processing in the TRx 11 according to communication system configurations (1-1) to (64-2). Note that the execution unit and the instruction unit may be included in both of the optical SW 10 and the part of the TRx 11 capable of arithmetic processing.

### 52nd Configuration Example

In the 52nd configuration example, the execution unit is included in the optical SW 10, and the instruction unit is included in a part of the SW 12 capable of arithmetic processing, for example, an information processing unit, a CPU, or the like. Other configuration is similar to that of the 1st configuration example. Note that the 52nd configuration example can be applied to any configuration including the optical SW 10 and the part capable of arithmetic processing in the SW 12 according to communication system configurations (1-1) to ((4-2). Note that the execution unit and the instruction unit may be included in both of the optical SW 10 and the part of the SW 12 capable of arithmetic processing.

### 53rd Configuration Example

In the 53rd configuration example, the execution unit is included in the optical SW 10, and the instruction unit is included in a part of the OSU capable of arithmetic processing, for example, an information processing unit, a CPU, or the like. Other configuration is similar to that of the 1st configuration example. Note that the 53rd configuration example can be applied to any configuration including the optical SW 10 and the part capable of arithmetic processing in the OSU according to communication system configurations (1-1) to (64-2). Note that the execution unit and the instruction unit may be included in both of the optical SW 10 and the part of the OSU capable of arithmetic processing.

### 54th Configuration Example

In the 54th configuration example, the execution unit is included in the optical SW 10, and the instruction unit is included in, for example, an information processing unit, a CPU, or the like of SW 13. Other configuration is similar to that of the 1st configuration example. Note that the 54th configuration example can be applied to any configuration including the optical SW 10 and a part capable of arithmetic processing in the SW 13 according to communication system configurations (1-1) to (64-2). Note that the execution unit and the instruction unit may be included in both of the optical SW 10 and the part of the SW 13 capable of arithmetic processing.

### 55th Configuration Example

In the 55th configuration example, the execution unit is included in the optical SW 10, and the instruction unit is included in a part of the OLT capable of arithmetic processing, for example, the control unit 14, an information processing unit, a control board, a CPU board, or the like. Other configuration is similar to that of the 1st configuration example. Note that the 55th configuration example can be applied to any configuration including the optical SW 10 and the part capable of arithmetic processing in the OLT according to communication system configurations (1-1) to (64-2). Note that the execution unit and the instruction unit may be included in both of the optical SW 10 and the part of the OLT capable of arithmetic processing.

### 56th Configuration Example

In the 56th configuration example, the execution unit is included in the optical SW 10, and the instruction unit is included in a part outside the OLT capable of arithmetic processing, for example, a center cloud, a local cloud, an edge cloud, an independent external server 16, an information processing unit, an OpS or the like. Other configuration is similar to that of the 1st configuration example. Note that the 56th configuration example can be applied to any configuration including the optical SW 10 and the part capable of arithmetic processing outside the OLT according to communication system configurations (1-1) to (64-2). Note that the execution unit and the instruction unit may be included in both of the optical SW 10 and the part outside the OLT capable of arithmetic processing.

### 57th Configuration Example

In the 57th configuration example, the execution unit is included in the optical SW 10, and the instruction unit is included in a part of a main signal network outside the OLT capable of arithmetic processing, for example, the proxy unit 15 or the like. Other configuration is similar to that of the 1st configuration example. Note that the 57th configuration example can be applied to any configuration including the optical SW 10 and the part capable of arithmetic processing in the main signal network outside the OLT according to communication system configurations (1-1) to (64-2). Note that the execution unit and the instruction unit may be included in both of the optical SW 10 and the part of the main signal network outside the OLT capable of arithmetic processing.

### 58th Configuration Example

In the 58th configuration example, the execution unit is included in the TRx 11, and the instruction unit is included in a part of the optical SW 10 capable of arithmetic processing, for example, an information processing unit, a CPU, or the like. Other configuration is similar to that of the 1st configuration example.

Note that the 58th configuration example can be applied to any configuration including the TRx 11 and the part capable of arithmetic processing in the optical SW 10 according to communication system configurations (1-1) to (64-2). Note that the execution unit and the instruction unit may be included in both of the TRx 11 and the part of the optical SW 10 capable of arithmetic processing.

### 59th Configuration Example

In the 59th configuration example, the execution unit is included in the SW 12, and the instruction unit is included in a part of the optical SW 10 capable of arithmetic processing, for example, an information processing unit, a CPU, or the like. Other configuration is similar to that of the 1st configuration example. Note that the 59th configuration example can be applied to any configuration including the SW 12 and the part capable of arithmetic processing in the optical SW 10 according to communication system configurations (1-1) to (64-2). Note that the execution unit and the instruction unit may be included in both of the SW 12 and the part of the optical SW 10 capable of arithmetic processing.

### 60th Configuration Example

In the 60th configuration example, the execution unit is included in the OSU, and the instruction unit is included in a part of the optical SW 10 capable of arithmetic processing, for example, an information processing unit, a CPU, or the like. Other configuration is similar to that of the 1st configuration example. Note that the 60th configuration example can be applied to a configuration including the OSU and the part capable of arithmetic processing in the optical SW 10 according to communication system configurations (1-1) to (64-2). Note that the execution unit and the instruction unit may be included in both of the OSU and the part of the optical SW 10 capable of arithmetic processing.

### 61st Configuration Example

In the 61st configuration example, the execution unit is included in the SW 13, and the instruction unit is included in a part of the optical SW 10 capable of arithmetic processing, for example, an information processing unit, a CPU, or the like. Other configuration is similar to that of the 1st configuration example. Note that the 61st configuration example can be applied to any configuration including the SW 13 and the part capable of arithmetic processing in the optical SW 10 according to communication system configurations (1-1) to (64-2). Note that the execution unit and the instruction unit may be included in both of the SW 13 and the part of the optical SW 10 capable of arithmetic processing.

### 62nd Configuration Example

In the 62nd configuration example, the execution unit is included in, for example, the control unit 14, an information processing unit, a control board, a CPU board, or the like of the OLT, and the instruction unit is included in a part of the optical SW 10 capable of arithmetic processing such as an information processing unit or a CPU. Other configuration is similar to that of the 1st configuration example. Note that the 62nd configuration example can be applied to any configuration including, for example, the control unit 14, the information processing unit, the control board, the CPU board, or the like of the OLT and the part capable of arithmetic processing in the optical SW 10 according to communication system configurations (1-1) to (64-2). Note that the execution unit and the instruction unit may be included in both of, for example, the control unit 14, the information processing unit, the control board, the CPU board, or the like of the OLT and the part of the optical SW 10 capable of arithmetic processing.

### 63rd Configuration Example

In the 63rd configuration example, the execution unit is included in, for example, a center cloud, a local cloud, an edge cloud, an independent external server 16, an information processing unit, an OpS or the like outside the OLT, and the instruction unit is included in a part of the optical SW 10 capable of arithmetic processing, for example, an information processing unit, a CPU, or the like. Other configuration is similar to that of the 1st configuration example. Note that the 63rd configuration example can be applied to any configuration including, for example, the center cloud, the local cloud, the edge cloud, the independent external server 16, the information processing unit, the OpS or the like outside the OLT and the part capable of arithmetic processing in the optical SW 10 according to communication system configurations (1-1) to (64-2). Note that the execution unit and the instruction unit may be included in both of, for example, the center cloud, the local cloud, the edge cloud, the independent external server 16, the information processing unit, the OpS or the like outside the OLT and the part of the optical SW 10 capable of arithmetic processing.

### 64th Configuration Example

In the 64th configuration example, the execution unit is included in, for example, the proxy unit 15 or the like of a main signal network outside the OLT, and the instruction unit is included in a part of the optical SW 10 capable of arithmetic processing, for example, an information processing unit, a CPU, or the like. Other configuration is similar to that of the 1st configuration example. Note that the 64th configuration example can be applied to any configuration including, for example, the proxy unit 15 or the like of the main signal network outside the OLT and the part of the optical SW 10 capable of arithmetic processing according to communication system configurations (1-1) to (64-2). Note that the execution unit and the instruction unit may be included in both of, for example, the proxy unit 15 or the like of the main signal network outside the OLT and the part of the optical SW 10 capable of arithmetic processing.

Note that, in the 1st configuration example to the 64th configuration example, an IF for changing a configuration or an algorithm of the instruction unit may be included, so that software of the instruction unit may be changeable. In the 1st configuration example to the 64th configuration example, the instruction unit is deployed in a constituent element capable of arithmetic processing located at one position being a constituent element of the apparatus. However, the instruction unit may be implemented in a plurality of constituent element apparatuses capable of arithmetic processing, for example, with processing in a plurality of information processing units.

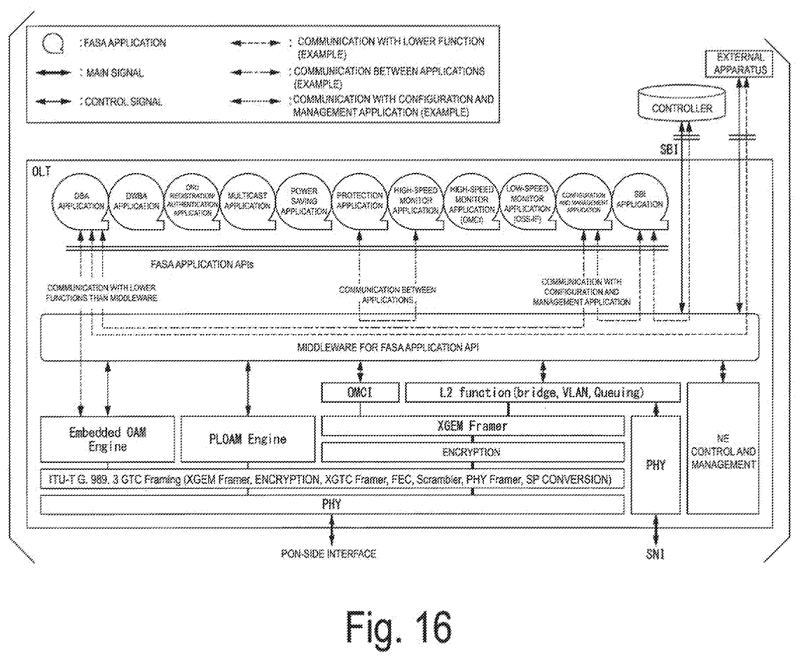

FIG. 16 is a diagram illustrating an example of a configuration of an optical access system. The OLT illustrated in the figure is an example of an OLT of the communication apparatus 1. The optical access system according to FIG. 16 conforms to ITU-T G.989 series. Although a controller and an external apparatus are not included in an OLT, those are illustrated in FIG. 16 for the sake of illustrating an example of communication with FASA application APIs.

A logical model includes FASA applications, and a FASA platform that provides FASA application APIs to the FASA applications. The FASA platform includes middleware for a FASA application API. The middleware for a FASA application API reconciles a difference of a vendor and a scheme of hardware and software that constitute the FASA platform. A FASA application API set that is not dependent on a vendor or a scheme is set in the middleware for a FASA application API, and a necessary function depending on a service or a communication carrier is implemented by replacing FASA applications. Communication between FASA applications and configuration management by a controller or the like are performed via the middleware for a FASA application API. Note that the middleware for a FASA application API may not be used. The FASA application API set is a common API group used in FASA applications, and is used by selecting a necessary API depending on a FASA application from the API set.

Connection relations described below are merely examples, and indirect connection via an intermediate may be direct connection, only a part of a plurality of connection relations may be connected, or other connection may be adopted. This also applies to other description.

In the OLT, applications are deployed so that the EMS is connected to a configuration management application (for example, a low-speed monitor application (EMS-IF) and a configuration and management application) via an IF conversion application that is connected via the middleware for a FASA application API The IF conversion application and the configuration management application are also connected via the middleware for a FASA application API. The IF conversion application corresponds to a south band interface (SBI) application that converts commands of the SBI, which is a control IF for the NE from the OpS or the like to the OLT or the like. Here, the IF conversion application performs IF conversion. However, if the low-speed monitor application (EMS-IF) and the configuration and management application include an API that performs IF conversion or that does not require IF conversion, the IF conversion application need not be included. The low-speed monitor application (EMS-IF) and the configuration and management application are connected to the EMS or NE control and management that performs NE management or the like, via the middleware for a FASA application API The low-speed monitor application (OMCI), the MLD proxy application (multicast application), and the power saving application are each connected to the L2 function via the middleware for a FASA application API.

The protection application is connected to the PLOAM engine and the embedded OAM engine via the middleware for a FASA application API. The power saving application is connected to the OMCI, the PLOAM engine, and the L2 function via the middleware for a FASA application API The ONU registration authentication application and the DWBA application are connected to the PLOAM engine via the middleware for a FASA application API, and the DBA application is connected to the embedded OAM engine via the middleware for a FASA application API. The power saving application may be activated between the protection application, the ONU registration authentication application, the DWBA application, and the DBA application via the middleware for a FASA application API. A high-speed monitor application is connected to the PLOAM engine via the middleware for a FASA application API. The low-speed monitor application is connected to the OMCI via the middleware for a FASA application API. Input from the external apparatus is connected to the DBA application via the middleware for a FASA application API. Note that these connections are merely examples, and input from the external apparatus may be connected to applications other than the DBA application, for example, the protection application or the DWBA application. Further, input from the external apparatus may be subjected to IF conversion via the IF conversion application through the middleware for a FASA application API, or may be connected to the DBA application or the like via the configuration and management application through the middleware for a FASA application API.

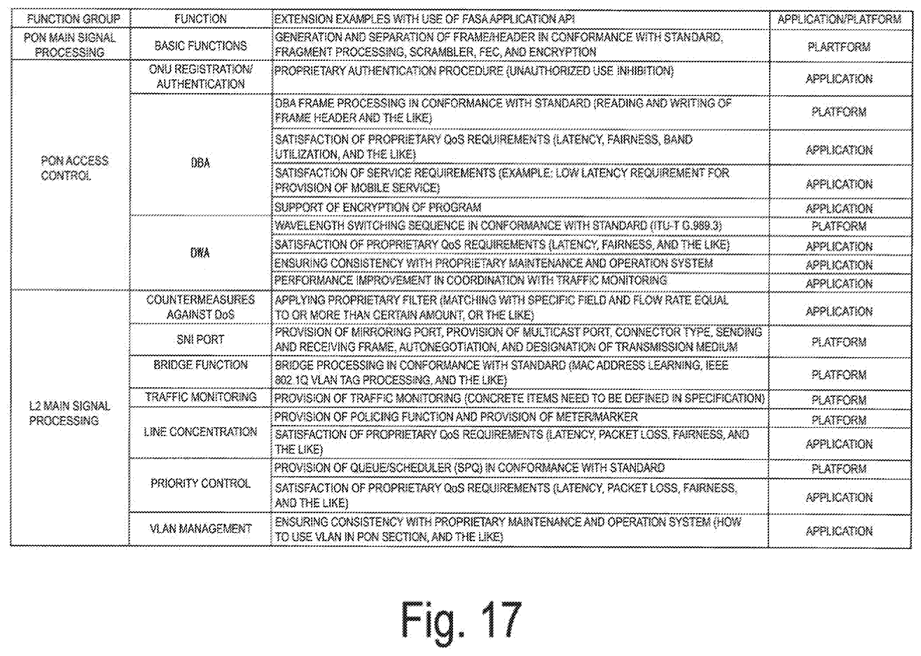

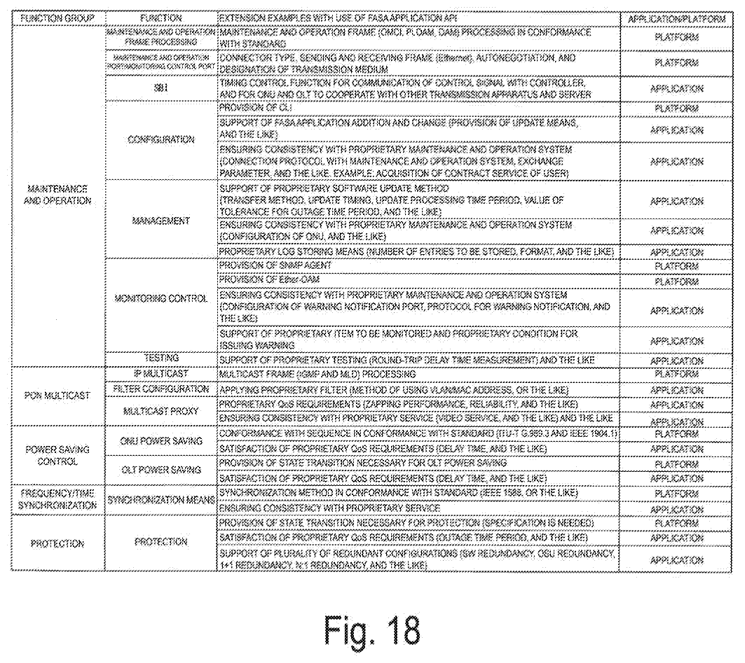

Major functions of the access system and targets to be converted into FASA applications are shown in FIG. 17 and FIG. 18. The following description takes an example of a case where the TWDM-PON mainly includes a PON multicast function, a power saving control function, a frequency and time synchronization function, a protection function, a maintenance and operation function, an L2 main signal processing function, a PON access control function, and a PON main signal processing function. The PON multicast function, the power saving control function, the frequency and time synchronization function, the protection function, the maintenance and operation function, the L2 main signal processing function, the PON access control function, and the PON main signal processing function are hereinafter referred to as “eight major functions”.

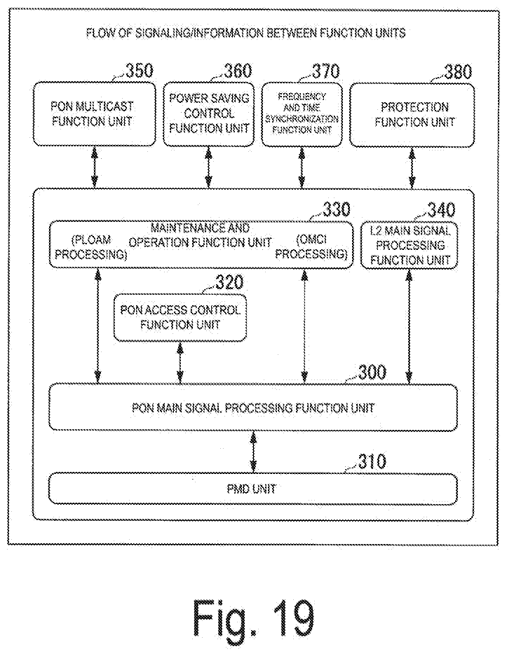

FIG. 19 is a diagram illustrating a flow of signaling/information between function units corresponding to the functions shown in FIG. 17 and FIG. 18 in the communication apparatus. The communication apparatus includes a PON main signal processing function unit 300, a PMD unit 310, a PON access control function unit 320, a maintenance and operation function unit 330 (PLOAM processing, OMCI processing), an L2 main signal processing function unit 340, a PON multicast function unit 350, a power saving control function unit 360, a frequency and time synchronization function unit 370, and a protection function unit 380.

The PON main signal processing function unit 300 may be connected to the PMD unit 310, the PON access control function unit 320, the maintenance and operation function unit 330 (PLOAM processing, OMCI processing), and the L2 main signal processing function unit 340. The PON multicast function unit 350 may be connected to a group including the PON main signal processing function unit 300, the PMD unit 310, the PON access control function unit 320, the maintenance and operation function unit 330, and the L2 main signal processing function unit 340. The power saving control function unit 360 may be connected to the group including the PON main signal processing function unit 300, the PMD unit 310, the PON access control function unit 320, the maintenance and operation function unit 330, and the L2 main signal processing function unit 340. The frequency and time synchronization function unit 370 may be connected to the group including the PON main signal processing function unit 300, the PMD unit 310, the PON access control function unit 320, the maintenance and operation function unit 330, and the L2 main signal processing function unit 340. The protection function unit 380 may be connected to the group including the PON main signal processing function unit 300, the PMD unit 310, the PON access control function unit 320, the maintenance and operation function unit 330, and the L2 main signal processing function unit 340.

The PON main signal processing function unit 300 includes a PON main signal processing function. The PON main signal processing function is a function group for processing main signals sent and received to and from the ONU, and may include PHY adaptation, framing, and service adaptation in order of processing of uplink signals (reverse order for processing of downlink signals) as its processings that constitute the PON main signal processing function. These processings may include basic processings. The basic processings are synchronized block generation/extraction, scrambling/descrambling, FEC decoding/encoding, frame generation/separation, G-PON encapsulation method (GEM) encapsulation, fragment processing, and encryption.

PHY adaptation may include synchronized block extraction, descrambling, and FEC decoding in order of processing of uplink signals. PHY adaptation may include FEC encoding, scrambling, and synchronized block generation in order of processing of downlink signals.

The PON main signal processing function unit 300 may implement equivalent processing with a combination of the basic processings, without including processings of PHY adaptation, framing, or service adaptation. The order of the processings of PHY adaptation, framing, or service adaptation may be interchanged. PHY adaptation may, for example, include FEC processing other than PHY adaptation. It is difficult to convert the PON main signal processing function into software.

The PON access control function included in the PON access control function unit 320 is the above-described control function group for sending and receiving main signals, and includes ONU registration or authentication, DBA, and k configuration switching (DWA) as its constituent processings. These processings may include basic processings. For example, ONU registration or authentication may include ranging, authentication deletion, registration, and start-up suspension constituting initial processing, DBA may include a part or all of bandwidth request reception, traffic measurement, history storage, allocation calculation, allocation processing, configuration switching calculation, configuration switching processing, and configuration switching state comprehension, and k configuration switching may include a part or all of bandwidth request reception, traffic measurement, history storage, allocation calculation, allocation processing, configuration switching calculation, configuration switching processing, and configuration switching state comprehension. Equivalent processing may be implemented with a combination of the basic processings, without including ONU registration or authentication, DBA, and X configuration switching (DWA). The order may be interchanged.

In the major function of the PON access control function unit 320, ONU high-speed start-up, BWMap in a DBA cycle, hitless λ configuration switching, or the like is required as necessary. In one example of function allotment, as registration or authentication, time-critical ranging processing may be allotted to the device dependent unit 110, and its subsequent authentication and key exchange may be allotted to an application. In DBA and k configuration switching, simple repetition processing may be allotted to the device dependent unit 110, and reflection to an ideal state may be allotted to an application. Conversion into software is desirable so that the application of ONU registration authentication have concealment of an authentication method, the application of DBA have flexible QoS, and the application of DWA (including wavelength protection and wavelength sleep) have flexible QoS.

The L2 main signal processing function unit 340 is a function group for transferring and processing main signals between a PON-side port and an SNI-side port, and includes MAC learning, VLAN control, path control, bandwidth control, priority control, and latency control as its constituent processings. These processings may include basic processings of address management, a classifier, a modifier, a policer/shaper, cross connect (XC), queuing, scheduler, copy, and traffic monitoring. Equivalent processing may be implemented with a combination of the basic processings, without including MAC learning, VLAN control, path control, bandwidth control, priority control, latency control, and copy. The order may be interchanged. It is difficult to convert the L2 main signal processing function into software.

The maintenance and operation function included in the maintenance and operation function unit 330 (PLOAM processing, OMCI processing) is a function group for smoothly maintaining and operating services with an access apparatus, and includes configuration (manual, inclusive, automatic, operation-based) and management of an apparatus or a service of the ONU, the OSU, the OLT, or the SW, configuration backup, software update such as FW, apparatus control (reset), monitoring of normal operation of a function, warning issuance in the event of an emergency, testing for investigating an abnormal range and its cause, and redundant configuration support as the first constituent processings. These processings may include basic processings of a CLI-IF, an apparatus management IF, an operation IF, a general-purpose config-IF (Netconf, SNMP, or the like), and table management.

As the second processings that constitute the maintenance and operation function unit 330, apparatus state monitoring (CPU/memory/power/switching), traffic monitoring, warning monitoring (ONU anomaly, OLT anomaly), and testing (loopback). These processings may include basic processings of warning notification, logging, L3 packet generation/processing, and table management.

As the third processings that constitute the maintenance and operation function unit 330, input and output (sleep command/response, k configuration switching command/response, and the like) of monitoring and control that require high speed are included. As a means of this processing, a physical layer OAM (PLOAM) message and bit representation in a header (Embedded OAM) are used. These processings may include basic processings of PLOAM processing, Embedded OAM processing, communication with the power saving control function unit 360, communication with the protection function unit 380, and communication with the PON access control function unit 320.

Equivalent processing may be implemented with a combination of the basic processings. The order may be interchanged.

In one example of function allotment of the first processing, processing other than hardware Config may be allotted as processing of an application, and software and configuration data may be allotted as processing of an application of the external server 16 of FIG. 15 instead of being allotted to the ONU and the OLT. Standardization of commands and definition of sequences may enable implementation.

In one example of function allotment of the second processing, only an IF for notification/display may be allotted to an application, items that need to be monitored (a CPU load, memory usage, a power state, power consumption, a link state of Ethernet (trade name), and the like) may be allotted to the device dependent unit 110, or may be allotted as processing of an application that separates IFs such as retrieval of notifications from the device dependent unit 110, sending of notifications on a network (NW), and writing to files.

The maintenance and operation function is connected to a maintenance and operation system that manages a large number of access apparatuses, and implements smooth maintenance and operation even at a remote distance. Regarding the maintenance and operation function, the configuration and management application, the low-speed monitor (OMCI) application, and the high-speed monitor application can be converted into software, and the low-speed monitor application (ONU/OLT monitoring) depends on a situation. As extensibility effects of each function (differentiation elements), the configuration and management application has an effect of reducing fundamental Opex by cooperating with the controller, and the low-speed monitor application (ONU/OLT monitoring: EMS) has an effect of reducing fundamental Opex by cooperating with the EMS.

The PON multicast function included in the PON multicast function unit 350 is a function group for transferring multicast streams received from the SNI to appropriate users, and includes identification and distribution of multicast streams, MLD/IGMP proxy/snooping, ONU filter configuration, multicast (frame processing), and inter-wavelength configuration migration as its constituent processings. These processings may include basic processings of L2 identification and distribution, L3 packet processing (desirably including IPv6 Parse), L3 packet generation, table management, and communication with the OMCI function. Regarding identification or distribution of multicast streams, MLD proxy/snooping, ONU filter configuration, and inter-wavelength configuration migration, equivalent processing may be implemented with a combination of the basic processings. The order may be interchanged. An application of the MLD/IGMP proxy can be converted into software.

In one example of function allotment, identification and distribution of multicast (MC) streams can be allotted as software processing provided that a CPU or the like having high-speed processing capacity is used, but is desirably allotted as hardware+config. In addition, an application system and ONU configuration for the uplink have loose frequency and latency restriction, and is thus allotted as processing of an application.

The function (access control) included in the power saving control function unit 360 is a function group for reducing power consumption of the ONU and the OLT, and may include a function for producing a maximum effect while minimizing influence over services by cooperating with traffic monitoring as well as a standardized power saving function. As its constituent processings, sleep proxy/traffic monitoring, ONU wavelength configuration, and inter-wavelength configuration migration are included. These processings may include basic processings of L3 packet processing (desirably including IPv6 Parse), L3 packet generation, table management, OSU power saving state diagram (SD), and communication with the OMCI function. Regarding sleep proxy/traffic monitoring, ONU wavelength configuration, and inter-wavelength configuration migration, equivalent processing may be implemented with a combination of the basic processings. The order may be interchanged.

In one example of function allotment, a power save (PS) application and proxy processing, depending on a signal, may be allotted as processing of an application. Although power saving control state transition management (driver unit) requires speed, this may be allotted as processing of an application. Regarding traffic monitoring, only config may be allotted as processing of an application. The power saving application can be converted into software. As extensibility effects of each function (differentiation elements), the power saving application has an effect of flexible QoS.

The frequency and time synchronization function included in the frequency and time synchronization function unit 370 is a function group for providing accurate frequency synchronization and time synchronization to apparatuses under the ONU. Further, a function of making a higher-layer apparatus subordinately synchronized with its own real-time clock (RTC) by means of Synchronous Ethernet (SyncE (trade name)) (for frequency synchronization) and IEEE 1588v2 (time synchronization), or a function of notifying the ONU of time information by using a PON frame by notifying the ONU of correspondence between a super frame counter (SFC) of the PON and absolute time (time of day (ToD)) information by using the OMCI may be included. These processings may include basic processings of real-time clock storage and the like. Equivalent processing may be implemented with a combination of the basic processings. The order may be interchanged.

In one example of function allotment, the real-time clock itself may be allotted to the device dependent unit 110, time adjustment calculation with a higher-layer apparatus may be allotted as processing of an application (may be allotted to the device dependent unit 110 depending on accuracy). It is difficult to convert the frequency/time synchronization function into software.

The protection function included in the protection function unit 380 is a function group for maintaining services by switching or handing over from the active system to the reserve system in the event of a failure detection in a redundant configuration with a plurality of hardware components such as between SWs and between OSUs, and includes switching trigger detection and redundant switching (CT, SW, NNI, Cont, and PON (Type A, B, and C)) as its constituent processings. These processings may include basic processings of redundant path configuration, switching trigger detection, sending and receiving of switching notification, switching processing, and the like. Equivalent processing may be implemented with a combination of the basic processings. The order may be interchanged. A protection algorithm can be converted into software. The protection algorithm has an extensibility effect.

Note that it is only required that the eight major functions be included as necessary, for example, only the PON main signal processing function, the PON access control function, the L2 main signal processing function, and the maintenance and operation function may be included, and other functions may be included. Evaluation as to whether each function can be converted into software is an example in which processing capacity of the OLT expected in 2018 and application of software SWs are not taken into consideration. Appropriate changes may be made in consideration of expectable processing capacity and application of software SWs. Even if a function can be converted into software, the function need not be converted into software. Internal configuration of each function may be another configuration as long as similar function can be implemented.

The idea of whether each function is implemented as a FASA application or implemented on the FASA platform as exemplified above and its examples will be described. Among functions, a function that requires function changes depending on a service and a function to be extended in order to satisfy requirements specific to a communication carrier are implemented as FASA applications. In contrast, a function defined according to a standard or the like and thus having little room for extension is implemented on the FASA platform. For example, implementation of the PON main signal processing function as the FASA platform is illustrated. To implement an access apparatus that conforms to ITU-T G.989 series, basic PON main signal processing functions such as a frame format, encryption of frames, and the FEC function need to be implemented according to the standard. Such basic functions are common irrespective of a service, and are thus implemented on the FASA platform.

In another example, FIG. 17 and FIG. 18 show implementation of “satisfaction of service requirement” of the DBA function included in the PON access control function as a FASA application. For example, depending on a service to be provided, low latency may be provided, or the bandwidth may be efficiently assigned for a large number of users. To satisfy requirements that differ from one service to another, it is desirable that a procedure and a policy of bandwidth assignment be implemented as a FASA application and separated from standard processing (conversion to a BWmap format defined in the standard, for example). It may be assumed that even if a target to be provided with a service is directed to one mass, there may be different policies of fairness, such as in a case where there are different policies of dealing with heavy users depending on a communication carrier. For example, it is assumed that respective QoS requirements are satisfied as follows: a communication carrier that requires fair control of small granularity per PON, for example, performs fair control even inside applications of DBA, and a communication carrier that performs fair control only in large granularity per access apparatus, for example, uses a line concentration function.

In this manner, in FASA, different requirements are implemented by replacement of FASA applications, and thus a means of FASA application replacement is required. What is adopted as such a replacement means depends on a communication carrier or operation. For example, Trivial File Transfer Protocol (TFTP) is included if an existing maintenance and operation system used by a communication carrier uses TFTP for software update, whereas SSH FTP (SFTP) is included if update is performed outside of the maintenance and operation system by using SFTP. It is assumed that discussion on standardization as to interfaces between an apparatus and a controller will develop in the future, and addition and changes of interfaces as a consequence of development of standardization also need to be considered. Thus, other systems connected by the access apparatus and a function that needs to be customized according to its operation may also be implemented as FASA applications.

FASA also assumes protection performed by only a part of the FASA platform, as well as protection performed by complete redundancy of the whole FASA platform. For example, a plurality of redundant configurations are assumed if the FASA platform includes the optical SW and supports PON protection, the FASA platform includes a plurality of wavelengths for one PON and supports wavelength protection, only the SW is duplicated, a combination of these is adopted, or the like. Implementation of the protection function as a FASA application allows an expected redundant configuration to be supported, and reusing the part easily allows a variety of redundant configurations to be supported as well.

A function to be converted into a FASA application, i.e., an extended function, may be an extended function depending on update frequency and a degree of importance of implementation or the like of a proprietary specification or the like of a function among functions that can be converted into software. It is preferable that one that has low update frequency or has a low requirement of implementation of a proprietary specification or the like be allotted to the basic function, the middleware for a FASA application API other than the device non-dependent application, the device dependent software, or the hardware. It is particularly preferable that a function subject to a restriction that derives from processing capacity of the software remain as the hardware. For example, a function that has high update frequency or that contributes to service differentiation such as DBA that enhances priority processing of main signals and use efficiency of a line, and a management control function that is closely involved in an operation flow of an operator and requires a proprietary specification for each operator are preferentially allotted to the extended function.

Thus, algorithms included in the eight major functions are allotted to a main software-converted area. The functions allotted to the software-converted area are allotted to the device non-dependent application unit 130 on the device non-dependent APIs 21 and 22. For example, algorithms in the ONU registration or authentication function contributing to a differentiation service, the DWBA function, the configuration, management, and monitoring control function, and the power saving control function are dealt with as the extended function unit 131 of the device non-dependent application unit 130. The MLD proxy application includes the multicast function.

The extended function unit 131 is an extended function unit 131 depending on update frequency and a degree of importance of implementation or the like of a proprietary specification or the like of a function among applications. It is preferable that one that has low update frequency or has a low requirement of a proprietary specification be allotted to the basic function unit 132, the middleware unit 120 other than the device non-dependent application unit 130, the device dependent software, or the hardware unit 111 (PHY) and the hardware unit 112 (MAC). It is particularly preferable that a function subject to a restriction that derives from processing capacity of the software remain as the hardware unit 111 (PHY) and the hardware unit 112 (MAC). For example, a function that has high update frequency or that contributes to service differentiation such as DBA that enhances priority processing of main signals and use efficiency of a line, and a management control function that is closely involved in an operation flow of an operator and requires a proprietary specification for each operator are preferentially allotted to the extended function unit 131.

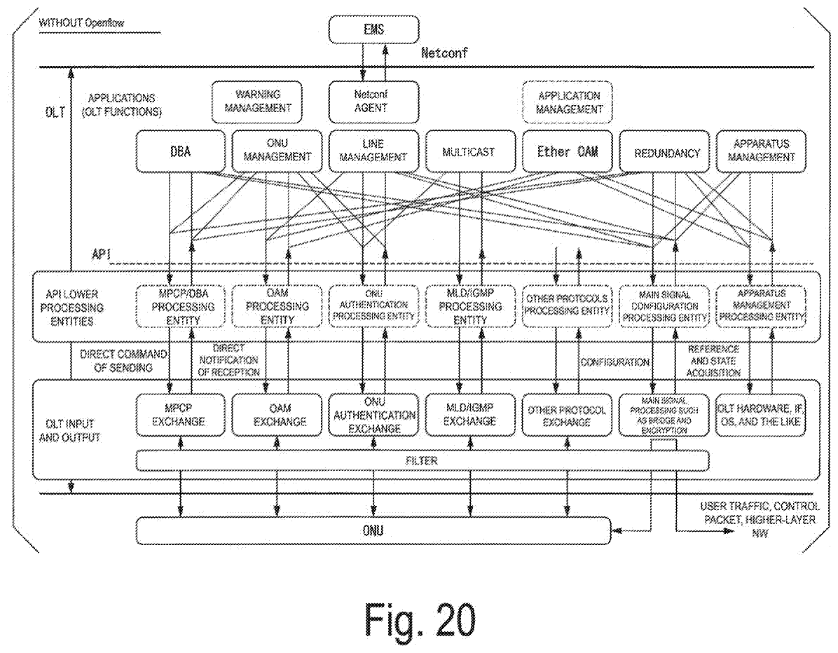

FIG. 20 is a diagram illustrating a flow of signaling/information between function units in the communication apparatus. The figure illustrates a flow of signaling/information between function units in the communication apparatus with a focus on In/Out of the OLT. As illustrated in the figure, the OLT as the communication apparatus includes API lower processing entities (FASA platform) and applications (FASA applications).

The API lower processing entities are exemplified as the following seven processing entities. The seven processing entities are an MPCP/DBA processing entity whose target of OLT input/output is a command of sending and a reception notification for MPCP exchange, an OAM processing entity whose target of OLT input/output is OAM exchange, an ONU authentication processing entity whose target of OLT input/output is ONU authentication exchange, an MLD/IGMP processing entity whose target of OLT input/output is MLD/IGMP exchange, another protocol processing entity whose target of OLT input/output is other protocol exchange, a main signal configuration processing entity whose OLT input/output is configuration and reference and state acquisition for main signal processing such as bridge and encryption, and an apparatus management processing entity whose target of OLT input/output is OLT hardware, an IF, an OS, and the like. Here, assuming direct operation of driver, it is desirable that the command of sending and the reception notification for MPCP exchange each is similar to send_frame (*raw_frame). From the perspective of an application on the API upper side, it is desirable that there is a processing entity that performs processing (a) easily (opportunely), (b) in common (between a plurality of types), (c) conveniently with respect to an API lower processing unit, in comparison with processing such as driver direct hitting.

In the figure, as the applications, DBA, ONU management, line management, multicast, Ether OAM, redundancy, apparatus management, warning management, Netconf agent, and application management are exemplified.

Examples of function allotment of the API lower processing entities are illustrated below. Each application has its corresponding processing. The API lower processing entities and function allotment of the applications may be any of or other than the following, or may vary from one processing entity to another.

(0) Message disregard: An API upper side and an ONU/higher-layer NW disregard a message.

(1) Framing: A message is provided to the API upper side by decomposing it into elements or subjecting it to processing as necessary with its frame removed. The API upper side delivers information to the API lower side. The API lower processing entities perform framing. This makes the API significantly dependent on each protocol, and the API may thus be included in the device dependent application unit. It is desirable that fixed parameters (type value and the like) be configured at the time of initialization or the like by the API upper side and be stored. Regarding a configuration parameter, a response is made to a reference made from the API upper side.

(2) Automatic response: The processing entity takes on message sending and receiving that does not require judgment, such as regular sending and a fixed response. It is desirable that the API upper side perform configuration of operation in advance. Examples thereof include a response cycle and the like. A result is notified only when a notification to the API upper side is required.

(3) Autonomous judgment: The processing entity also takes on processing involving judgment. The API upper side performs configuration of a policy in advance.

Although the figure is illustrated according to the 10G EPON conforming to IEEE, the same applies for an apparatus conforming to ITU-T or others if a corresponding function and processing are interpreted differently. Further, the functions and the processing entities are merely examples, and may be added, deleted, replaced, or changed as appropriate depending on a condition. Description will be added for each API according to FIG. 17 and FIG. 18.

For example, on the premise of processing basically without a time restriction or being moderate, In/Out (FASA application API and the like) of the OLT can be roughly classified into three: configuration and control/information notification and acquisition for the OLT itself (configuration and control API), input and output to and from the ONU (message sending and receiving API to and from the ONU), and input and output to and from others such as the EMS (other APIs).

When the application performs configuration and management, for example, the configuration and control API receives a configuration command and a control message from the controller/EMS by means of Netconf/YANG or the like, deploys the message basically based on the YANG model or the like, and the application gives a command to an API lower processing entity according to its content or transfers information notification/acquisition of the OLT to the controller/EMS. When the application performs configuration and control or some command, information acquisition, and notification to the ONU, for example, the message sending and receiving API to and from the ONU composes a message addressed to the ONU, delivers it to an API lower processing entity, and retrieves a command of sending or a message from the API lower processing entity. There are a plurality of protocols such as an extended OAM and an OMCI for message exchange with the ONU, and the interfaces can be grouped into a command of sending a message and retrieval of a message.

When other APIs cooperate with a device other than an OLT, for example, an interface therefor is necessary.

Examples of an API (API subject to a time restriction) for processing subject to a time restriction when the application performs the processing, for example, DBA, sleep, or the like that requires frequent messaging with the ONU, will be described below.

For example, in a case of DBA, an API subject to a time restriction involves (1) notification of information (for example, all information) related to a grant for uplink sending from the application to the API lower processing entity and (2) notification of information (for example, all information) related to an uplink sending request from the API lower processing entity to the application. It is desirable that the information delivered through the API have a value that does not require re-calculation in a delivered destination. This is because reduction of dependency of the application and the API lower processing entity and enhancement of independency thereof can make the application allotted only algorithm processing and the API lower processing entity allotted only processing of message implementation.

Examples are illustrated below.
Amount of grant for sending configuration API
   Format: fasa_api_set_grant_config (UINT64 sfc, UINT8 ch, int n_of_configs, grant_config_t grant_config[ ];

### Arguments:

UINT64 sfc; /* Superframe counter value, ignored in IEEE 802.3 */
UINT8 ch; /* Downlink wavelength channel ID in TWDM. Ignored if not supported */
int n_of_configs; /* Number of grants for sending notified in this API */
grant_config_t grant_config[ ]; /* Grant for sending (as many allocation structures as number
n_of_configs) */

| | | |
|---|---|---|
| typedef struct{ | /* IEEE 802.3 | ITU-T G.989 */ |
| UINT16 id; | /* LLID | Alloc-ID */ |
| UINT8 flags; | /* Flags | Flags/FWI/Burst Profile */ |
| UINT32 grant_start_time; | /* Grant Start Time | Start Time */ |
| UINT16 grant_length; | /* Grant Length | GrantSize */ |

}grant_config_t;

Through this API, the application of DBA directly notifies the API lower processing entity of DBA of an amount of grant for sending, for example. The API lower processing entity composes a transmission grant message for the ONU, based on the notified amount of grant for sending, and sends the message of grant for sending to the ONU. Examples of operation conforming to each of IEEE 802.3 and ITU-T G.989 will be illustrated.

In the Ethernet PON conforming to IEEE 802.3, control of uplink sending is performed by transmitting a GATE message to the ONU. The ONU as a destination is identified by LLID stored in a preamble. Start time for sending is indicated by grantstarttime, and an amount of grant for sending is indicated by grantlength. A type of grant for sending is indicated by DiscoveryGATE and a flag field of forcereport. One GATE message can store up to four grants for sending.

The API lower processing entity that has received the API parses the arguments, and operates as follows.
Ignore values of sfc and ch.
Let one grant_config corresponds to one Grant/grant for sending (a set of grantstarttime and grantlength), and n_of_configs represent the number of grant_configs.
Use the lower 15 bits of id as LLID provided for GATE, for example.
Use the lowermost bit of flags as discoveryflag, for example, and use the second bit as a value of force_report.
Regarding grant_start_time, use 32 bits as a value of Grant Start Time.
Use grant_length as a value of GrantLength, for example.
If there are a plurality of grant_configs for one id (LLID), make one GATE message carry as many grant_configs as possible. The GATE message can carry up to four grants. A value of numberofgrants in the GATE message is calculated based on the GATE message composed by the API lower processing entity, and the value is stored. The API lower processing entity calculates a value of force_report based on the number of the grant, and the value is stored.
Let values of fields of the GATE frame other than the above are not specified from the application.
After reception of the API and completion of parsing the arguments, for example, immediately perform downlink sending from a completely constructed GATE frame.

Note that, regarding processing of the application, it is presupposed that notification of a current MPCP local time value, identification of the ONU, an LLID number, an RTT value, acquisition of a link state, a QoS parameter (a configuration value of a maximum bandwidth or the like) of each ONU/LLID, or the like is executed in another process.

In the TWDM-PON conforming to ITU-T G.989.3, control of uplink sending is performed by notifying the ONU of BWmap. The BWmap includes a plurality of allocationstructures, and one allocationstructure includes one grant for sending. The grant for sending includes StartTime and GrantSize.

The API lower processing entity that has received the API parses, and operates as follows.
Install in the BWmap of the downlink frame of super framecounter equal to the value of received super_frame_counter.
Perform downlink sending of the BWmap on the downlink wavelength channel of a DWLCHID indicated by the value of ch.
   If TWDM is not supported, ignore this value.
Let one grant_config correspond to one Allocationstructure, and n_of_configs represent the number of Allocationstructures.
Use the lower 14 bits of id as an Alloc-ID provided for Allocationstructure, for example.
Use the lowermost bit, the second bit, the third bit, and the fourth and fifth bits of flags as values of PLOAMu, DBRu, FWI, and BurstProfile of Flags in Allocationstructure, respectively, for example.
Use the lower 32 bits of grant_start_time as a value of StartTime, for example.
Use grant_length as a value of GrantSize, for example.
Let one grant_config correspond to one Allocationstructure, for example, HEC in AllocationStructure is calculated and stored in the API lower processing entity.
Assume that one BWmap is constructed for one API, for example.
After reception of the API and construction of the BWmap, include the BWmap in the FS header in accordance with the downlink frame of the superframecounter value specified through this API to perform downlink sending of the BWmap. Note that regarding the application, it is presupposed that a current superframecounter value, identification of the ONU, association of an Alloc-ID number, acquisition of an RTT value, acquisition of a link state, or the like is executed in another process, and a QoS parameter (maximum bandwidth and the like) of each Alloc-ID is also notified to the application in another process.
Amount of Request of Sending Acquisition API
   Format: fasa_api_get_onu_request (UINT64 sfc, UINT8 ch, int n_of_configs, request_config_t request_config[ ]);

### Arguments:

UINT64 sfc; /* Superframe counter value, ignored in IEEE 802.3 */
UINT8 ch; /* Uplink wavelength channel ID in TWDM. Ignored if not supported */
int n_of_requests; /* Number of requests of sending notified in this API */
request_config_t request_config[ ]; /* Request of sending (as many allocation structures as
number n_of_configs) */

| | | |
|---|---|---|
| typedef struct{ | /* IEEE 802.3 | ITU-T G.989 */ |
| UINT16 id; | /* LLID | ONU-ID */ |
| UINT8 flags; | /* QSet/Qreport number | Ind */ |
| UINT32 request; | /* queue report value | BufOcc value*/ |
| }request_config_t; | | |

Through this API, the application of DBA directly acquires information related to the request of sending received and stored in the API lower processing entity. Although this API adopts a polling format, callback may be adopted. Examples of operation conforming to each of IEEE 802.3 and ITU-T G.989 will be illustrated.

In the Ethernet PON conforming to IEEE 802.3, request of uplink sending is performed by the ONU transmitting a REPORT message to the OLT. The ONU as a source for sending is identified by LLID stored in a preamble. A REPORT frame includes at least one set of Reportbitmap and QueueReport, which is referred to as QueueSet. The number of QueueSets is represented by numberofqueuesets. A value of the amount of request of sending is stored in QueueReport. One QueueSet can store up to eight types of QueueReports, and only QueueReport(s) having a value can be notified. Reportbitmap indicates which QueueReport of the eight types is notified.

The API lower processing entity that has received the API returns information related to the request of sending as return values of the arguments, and performs the following operation for returning.
Store information of request of sending included in the received REPORT frame. Specifically, store LLID, a QueueSet number, a QueueReport number, and queuereport values indicated by these numbers.
Return these three to the application as a return value of the argument request_config of the API.
Store the value of LLID in the argument id.
Store Queue report numbers 0 to 7 in the three least significant bits of the argument flags, and store the Queue Set number in the five most significant bits of the argument flags.
Store values of queuereport corresponding to these numbers in the argument request.
Deliver the stored information of request of sending to the application according to retrieval through this API, and erase the delivered information or overwrite with new information.
Store, in the argument sfc, MPCP local time obtained when the REPORT frame is most recently received among the stored information of request of sending.
   Note that, for the application, it is presupposed that a current MPCP local time value, identification of the ONU, acquisition of an LLID number and an RTT value, acquisition of a link state, or the like is executed in another process, and a QoS parameter (maximum bandwidth and the like) of each ONU/LLID is also notified to the application of DBA in another process. In the TWDM-PON conforming to ITU-T G.989.3, request of uplink sending is performed by the ONU transmitting BufOcc in DBRu to the OLT. The ONU as a source for sending is identified by ONU-ID stored in the FS header. The ONU notifies the OLT of presence/absence of a pending uplink PLOAM message to be sent by PLOAMqueuestatus bits in an Ind field of the FS header.

The API lower processing entity that has received the API returns information related to the request of sending as return values of the arguments, and performs the following operation for returning.
Store received information of request of sending. Specifically, store ONU-ID, the BufOcc value, and the PLOAMqueuestatus bit value.
Return these three to the application as a return value of the argument request_config of the API.
Store the value of ONU-ID in the argument id.
Store the PLOAM queuestatus bit value in the lowermost bit of the argument flags.
Store the BufOcc value in the argument request.
If one burst includes a plurality of Allocations, store the BufOcc values in order of reception. In this case, the ONU-ID value and the PLOAMqueuestatus have the same value for respective BufOcc values, and simpleness and unity of the API arguments are prioritized, although information itself may be redundant.
Deliver the stored information of request of sending to the application according to retrieval through this API, and erase the delivered information or overwrite with new information.
Store, in the argument sfc, a Superframecounter value obtained when BufOcc is most recently received among the stored information of request of sending.

Note that, for the application, it is presupposed that a current superframecounter value, identification of the ONU, association of an Alloc-ID number, acquisition of an RTT value, acquisition of a link state, or the like is executed in another process, and a QoS parameter (maximum bandwidth and the like) of each Alloc-ID is also notified to the application of DBA in another process.

The L2 main signal processing of the OLT is performed to appropriately transfer user data to respective uplink and downlink routes. Thus, the role of the application is to receive a command from the EMS/higher-layer OpS by means of Netconf/YANG or Openflow, and in accordance with the command, to send to the API lower processing entity (1) transfer configuration for respective uplink and downlink routes, (2) acquisition of statistical information, and (3) transfer configuration for the ONU. (1) and (2) are processing of sending configuration to the API lower processing entity based on the YANG model, and (3) is processing of configuring configuration details for the ONU and sending to the API lower processing entity a command of sending a message for the ONU.

Although there may be many functions of the maintenance and operation functions of the OLT, those functions may be roughly classified into two: (1) configuration and operation command for the OLT and (2) state notification of the OLT and the ONU.

(1) In configuration and operation command, the application receives a command from the EMS/higher OpS by means of Netconf, and sends the content to the API lower processing entity based on the YANG model.

(2) In state notification, the application receives a notification from the API lower processing entity based on the YANG model or the OAM/OMCI message, and notifies the EMS/higher OpS of its content by means of Netconf.

The PON multicast function of the OLT is mainly used for video streaming or the like, and there are several implementation methods. The overview of those methods will be described, and the function allotment in the applications and the API lower processing entities and the concept of a message flow will be illustrated.

With multicast, the same information is broadcast to a plurality of freely-selected transfer destinations (or one transfer destination). In general, a transfer destination of multicast streams is dynamically controlled according to a join request and a leave request sent from a terminal to a multicast group. IGMPv3 of IPv4 and MLDv2 of IPV6 are often used as protocols for messages such as the join request and the leave request and multicast transfer control. Here, in a TDM-PON, in general, the downlink route from the OLT to the ONU is logically unicast and physically broadcast. Thus, to implement multicast, some technique is required. Mainly, three methods are used: (1) multicast by a higher node, (2) ONU snooping, and (3) OLT proxy. The function allotment and the concept of a message flow of each of such methods will be illustrated.

In the method of implementing multicast transfer by a higher node, the ONU and the OLT are each configured to transparently transfer an IGMP/MLD message. Further, a higher node than the OLT that has received the join request message transfers a multicast stream to a terminal that issued the join request. In this case, if there are join requests for the same multicast group from terminals under a plurality of ONUs connected to the same OLT, the higher node transfers a multicast stream to each of the terminals, and thus a plurality of streams having the same content are sent to the OLT. The OLT transparently transfers such a plurality of streams to respective ONUs as their individual unicast streams.

If there are join requests for the same multicast group from a plurality of terminals under the same ONU, a mechanism depends on a function configuration of the ONU and a lower node. If the ONU or the lower node has a multicast routing function, the ONU or the lower node broadcasts a multicast stream to the second terminal in response to a join request sent from the second terminal without transferring a join request message to the OLT and the higher entity. In a case of a configuration not including a multicast routing function, multicast streams for respective terminals are broadcast from a higher node than the OLT.

Another method to implement PON multicast is one using ONU snooping of snooping an IGMP/MLD message that passes through the ONU. In this method, to implement PON multicast, the ONU snoops an IGMP/MLD message that is sent from a terminal under the ONU to a higher node (multicast router) than the OLT. First, the OLT transfers multicast streams received from a higher node so that all the ONUs can receive them. The ONU opens or closes its own downlink transfer filter depending on the IGMP/MLD message that the ONU snooped. Specifically, the ONU configures the transfer filter so that traffic of the multicast group to be joined is transferred in the downlink if the message that the ONU snooped is a join request, and that the traffic is shut off if the message is a leave request. The transfer and shut off filter configuration is performed according to a predetermined method using various domains such as an IP address, a MAC address, a VLAN tag, and other identifiers. This allows multicast streams transferred from the OLT to be transferred to the ONU lower side if the filter of the ONU is open, and multicast streams received from the OLT by the ONU to be discarded without being transferred to the ONU lower side if the filter is closed. In this manner, multicast transfer is implemented. In this case, regarding function allotment of the application and the API lower processing entity, the application receives an indication of activation or deactivation of the IGMP/MLD snoop function of the ONU through an initial configuration or a service order from the EMS/higher OpS by means of Netconf or the like. The application that has received this command commands the API lower processing entity to send an extended OAM or an OMCI message via a communication API with the ONU. The API lower processing entity sends a commanded message to the ONU, and indicates activation or deactivation of the snoop function. In this manner, PON multicast is controlled by means of ONU snooping.

There is another method, which is generally referred to as OLT proxy. In this method, the OLT aggregates IGMP/MLD messages that are transferred from the ONU to a higher node via the OLT, the OLT responds by proxy, and indicates open or close of the downlink transfer filter for the ONU. Also in this method, the OLT transfers multicast streams sent from a higher node so that all the ONUs can receive them. The OLT once receives IGMP/MLD messages sent from terminals on the ONU lower side, and transfers them to the higher node depending on the content of the messages. If the message is a join request, the OLT commands a corresponding ONU to open a downlink transfer filter of a corresponding multicast group of the ONU by means of an extended OAM or an OMCI message, and if the message is a leave request, the OLT commands a corresponding ONU to close the downlink transfer filter. This allows multicast streams to be transferred only to a terminal that has sent a join request. In this manner, multicast transfer is implemented. In this case, in consideration of a case where there are a plurality of terminals under the ONU, states of terminals under an ONU different from the ONU that has transferred IGMP/MLD messages, or the like, it is also possible to employ such a filter operation of the ONU and message transfer to a higher node as to achieve efficient multicast transfer. In this case, regarding function allotment of the application and the API lower processing entity, the application performs route configuration of a main signal in advance so that IGMP/MLD messages that are sent in uplink from the ONU are transferred to the application API upper side after being received by the OLT. The route configuration is part of main signal configuration for the OLT from the application to the API lower processing entity, and it is assumed that the route configuration is configured as Netconf/YANG or as Openflow or the like. A trigger of the route configuration itself is configuration from the EMS/higher OpS. The multicast stream downlink transfer method is also implemented by the application receiving a configuration command from the EMS/higher OpS by means of Netconf/YANG or Openflow and sending the content to the API lower processing entity. The OLT proxy function is implemented by giving a command of sending of an extended OAM or an OMCI message that indicates open or close of the downlink filter of the ONU to the API lower processing entity, based on the content of the IGMP/MLD message transferred to the application.

The power saving control function is a function in which the ONU suspends power supply to some functions as necessary to reduce power consumption in the ONU. The role of the application is to receive configuration related to the power saving mode of the ONU and a service order from the EMS/higher OpS, compose an extended OAM/OMCI message based on the content, and give a notification to the API lower processing entity so that the API lower processing entity sends the message to the ONU. The application receives notification of a change of a state due to the PLOAM or the like from the API lower processing entity.

Note that, if a state of the power saving mode of the ONU is to be directly controlled from the application in a similar manner to the DBA as described above, the application performs composition of a message to be sent to the ONU and retrieval of a message received from the ONU in real time, and gives a command of sending message and receiving message to the API lower processing entity, respectively.

The frequency/time synchronization function is a function of causing reference signals and time information that are input to the OLT to be accurately output from the ONU via a PON section. The role of the application is to compose a message to be sent in order to notify the ONU of configuration necessary for the synchronization function, parameters related to signal propagation from the OLT to the ONU, or the like, and give a command of sending message to the API lower processing entity.

The external cooperation function is, for example, used when a function is executed in cooperation with an external device such as low latency DBA with a mobile base station. In the external cooperation function, for example, the application receives a message from an external device. The message reception function from an external device is significantly dependent on implementation, connection configuration with an external device, and a message format, and thus it is desirable that the role of the application be to receive and parse a message without decomposing it. General functions of an installed OS or the like may be used, or a proprietary API may be defined.

The above examples illustrate a case in which the application is allotted processing of algorithms such as DBA and the API lower processing entity is allotted messaging. This function allotment is appropriate when only algorithms are to be changed, with messaging being fixed. Note that the less an interface is dependent on algorithms, the more the interface is desirable because it is more versatile.

The configurations according to Embodiment 1-1 illustrated above also apply to the embodiments described below, and those may be combined as appropriate. For example, although FIG. 15 illustrates an example of a case in which execution units of the system constitute only the TRx 11, the SW 12, and the SW 13. However, a part other than the TRx 11, the SW 12, and the SW 13, a part other than the part, a part where the PON terminates, or the control unit 14 may each be implemented an execution unit.

### Embodiment 1-2

Embodiment 1-1 exemplifies a configuration used in the TWDM-PON. However, the present invention may be applied to the TDM-PON. Embodiment 1-2 is the same as Embodiment 1-1 except that the TDM-PON need not include a function of performing wavelength-division multiplexing on wavelength resources of an ONU-OLT PON section between ONUs, such as X configuration switching (DWA).

### Embodiment 1-3

Embodiment 1-1 exemplifies a configuration used in the TWDM-PON. However, the present invention may be applied to the WDM-PON. Embodiment 1-3 is the same as Embodiment 1-1 except that the WDM-PON need not include a function of performing time-division multiplexing on bandwidth resources of an ONU-OLT PON section between ONUs, such as DBA.

### Embodiment 1-4

The present embodiment is a combination including an orthogonal frequency division multiplexing (OFDM)-PON, a code division multiplexing (CDM)-PON, a subcarrier multiplexing (SCM)-PON, and core wire-division multiplexing.

Embodiment 1-1 exemplifies a configuration used in the TWDM-PON. However, the present invention may be applied to a PON that shares resources other than the wavelength and time. For example, the present invention may be applied to an OFDM-PON in which division multiplexing is performed on electric frequency resources of one wavelength, an SCM-PON in which division multiplexing is performed on electric frequency resources of one wavelength, or a CDM-PON in which division multiplexing is performed with a code, core wire-division multiplexing may be combined, spatial division multiplexing using multi-core fibers or the like may be combined, or wavelength-division multiplexing need not be used. The same applies if the function of performing wavelength-division multiplexing on wavelength resources of the TWDM-PON is interpreted as a function corresponding to a function that is required for performing division multiplexing on respective resources to be multiplexed.

### Embodiment 2

In Embodiment 2, a configuration used in the TWDM-PON performs GEM encapsulation. In this case, an adapter that generates GEM frames is included in the SW, and the GEM frames have continuity between the SW and another part. By transferring functions including GEM encapsulation to be allotted to the SW, the L2 function unit can be removed from a protocol stack of another part, and superimposition of the L2 function unit can be thereby avoided in the SW and another part.

Note that although the above description takes an example of the TWDM-PON, similar effects can be achieved even with other PONs if the frame for identification in a PON section is handled in a similar manner as in Embodiment 1-2 to Embodiment 1-4. For example, if a GE-PON, a 10G E-PON, or the like conforming to the IEEE standards is used, it is only required that an LLID be provided instead of the GEM frame, and the frame provided with the LLID be caused to have continuity between the SW and another part.

### Embodiment 3

In Embodiment 3, control information used in the TWDM-PON passes through the SW. In this case, instead of transferring a function related to the bridge function to be allotted to the SW, any of the PLOAM, the Embedded OAM, the OMCI storing control information is framed as necessary and processed via the SW. Input and output of control information via the SW produces an effect of reducing the amount of processing of entities other than the SW. Note that the function allotment transfer of the bridge function to the SW of Embodiment 1 and Embodiment 2 may be performed in addition to the function allotment transfer of Embodiment 3.

Note that although the above description takes an example of the TWDM-PON, similar effects can be achieved even with other PONs if the control information is handled in a similar manner and processed via the SW as in Embodiment 1-2 to Embodiment 1-4.

As described above, the communication apparatus 1 is an apparatus that executes optical communication, and includes an execution unit (the ONU, the OSU, the WBS, or the optical switch) that executes at least one of switching of a path of a signal or transmission of the signal on the path and an instruction unit (the controller or the substitute apparatus).

The instruction unit includes a first interface configured to send a command to the execution unit. The execution unit includes a second interface configured to receive the command. The execution unit executes at least one of the switching of the path, start of the transmission of the signal, or suspension of the transmission of the signal according to the command at least one of after a configured time period or a predetermined time period has elapsed or immediately. As described above, a transmission entity and a switching entity (the component or the like) include, for example, an interface configured to output a response to a control entity (the controller or the like). The control entity includes, for example, an interface configured to output time specification information to the transmission entity and the switching entity.
Consequently, communication state switching processing and signal transmission processing are synchronized between the components to be executed.
Thus, the communication apparatus 1 can include components that each require different processing time periods (each have different actual values) depending on replacement, addition, or deletion of functions. In other words, technology allowing for replacement, addition, and deletion, or switching/configuration for implementing such procedures to handle a variety of time lengths or the like required for replacement, addition, and deletion, or switching/configuration for implementing such procedures can be provided.

At least a part of the communication apparatus in the embodiments described above may be implemented with a computer. In such a case, the part may be implemented by recording a program for implementing their functions in a computer-readable recording medium, and causing a computer system to read and execute the program recorded in the recording medium. Note that the “computer system” as used herein includes an OS and hardware such as a peripheral device. The “computer-readable recording medium” refers to a storage apparatus, examples of which include a portable medium (e.g., a flexible disk, a magneto-optical disk, a ROM, and a CD-ROM), and a hard disk installed in a computer system. Further, the “computer-readable recording medium” may also include such a computer-readable recording medium that stores programs dynamically for a short period of time, one example of which is a communication line used when a program is sent via a communication channel such as a network (e.g., the Internet) and a telephone line, and may also include such a computer-readable recording medium that stores programs for a certain period of time, one example of which is volatile memory inside a computer system that functions as a server or a client in the above-described case. Further, the above program may be a program for implementing a part of the above-mentioned functions. Alternatively, the above program may be a program capable of implementing the above-mentioned functions in combination with another program already recorded in a computer system. Alternatively, the above program may be a program to be implemented with the use of a programmable logic device such as a field programmable gate array (FPGA).

The embodiments of the present invention have been described above in detail with reference to the drawings. Specific configurations, however, are not limited to those embodiments. The embodiments described above are merely examples. The present invention can be carried out with various modifications and improvements being made thereto based on knowledge of a person skilled in the art, and include designs and the like within the scope not departing from the gist of the present invention.

### INDUSTRIAL APPLICABILITY

The present invention can be applied to an optical communication apparatus.

### REFERENCE SIGNS LIST

1 Communication apparatus
2 ONU
3 Optical distribution network
4 Optical switch
5 OLT
6 WBS
7 Controller
8 Substitute apparatus
10 Optical switch unit
11 Sending and receiving unit
12 Switching unit
13 Switching unit
14 Control unit
15 Proxy unit
16 External server
21 Device non-dependent API
22 Device non-dependent API
23 Device dependent API
24 Device dependent API
25 Device dependent API
26 API
27 Device non-dependent API
50 OSU
110 Device dependent unit
111 Hardware unit
112 Hardware unit
113 Software unit
114 OAM unit
114a Embedded OAM engine
114b PLOAM engine
115 NE management and control unit
115a NE management unit
115b NE control
120 Middleware unit
121 Middleware unit
130 Device non-dependent application unit
131 Extended function unit
131-1 Extended function unit
131-2 Extended function unit
131-3 Extended function unit
132 Basic function unit
133 Management and control agent unit
140 EMS
150 Device dependent application unit
160 External apparatus
300 PON main signal processing function unit
310 PMD unit
320 PON access control function unit
330 Maintenance and operation function unit
340 L2 main signal processing function unit
350 PON multicast function unit
360 Power saving control function unit
370 Frequency and time synchronization function unit
380 Protection function unit

1. A communication apparatus comprising:
an execution unit configured to execute at least either switching of a path of a signal or transmission of the signal on the path; and
an instruction unit,
wherein the instruction unit includes a first interface configured to send a command to the execution unit, and
the execution unit includes a second interface configured to receive the command, and executes at least one of the switching of the path, start of the transmission of the signal, or suspension of the transmission of the signal according to the command at least either immediately, or after a configured time period or a predetermined time period elapses.

2. The communication apparatus according to claim 1,
wherein the execution unit sends to the instruction unit a response to the command when the execution unit receives the command or performs execution according to the command, and
the instruction unit sends to the execution unit a next instance of the command after receiving the response to the command.

3. The communication apparatus according to claim 1,
wherein the instruction unit sends time information as the command to the execution unit, and
when the execution unit receives the time information, the execution unit executes at least one of the switching of the path, the start of the transmission of the signal, or the suspension of the transmission of the signal after a configured time period or a predetermined time period elapses.

4. The communication apparatus according to claim 1,
wherein the instruction unit sends the command to the execution unit if the signal has not been transmitted for a predetermined period in a downstream part of the path.

5. The communication apparatus according to claim 1,
wherein the instruction unit sends a command for the suspension of the transmission to the execution unit after a configured time period or a predetermined time period elapses from a suspension time being a time at which the transmission is suspended, and sends a command for the start of the transmission to the execution unit after a configured time period or a predetermined time period elapses from a start time being a time at which the transmission is started,
the execution unit executes the switching of the path when the execution unit receives the command for the switching, and
the execution unit suspends the transmission of the signal when the execution unit receives the command for the suspension, and starts the transmission of the signal when the execution unit receives the command for the start.

6. The communication apparatus according to claim 1, further comprising a substitute apparatus configured to perform an operation of the instruction unit instead of the instruction unit.

7. A communication method executed by a communication apparatus including an execution unit configured to execute at least either switching of a path of a signal or transmission of the signal on the path and an instruction unit, the communication method comprising:
sending, by the instruction unit, a command to the execution unit; and
receiving, by the execution unit, the command, and executing at least one of the switching of the path, start of the transmission of the signal, or suspension of the transmission of the signal according to the command at least either immediately, or after a configured time period or a predetermined time period elapses.

8. A non-transitory computer readable medium including instructions executable by one or more processors to:
sending, by an instruction unit, a command to an execution unit, where the execution unit resides in a communication device and is configured to execute at least either switching of a path of a signal or transmission of the signal on the path; and
receiving, by the execution unit, the command, and executing at least one of the switching of the path, start of the transmission of the signal, or suspension of the transmission of the signal according to the command at least either immediately, or after a configured time period or a predetermined time period elapses.
